(19) United States
(12) Patent Application Publication
(10) Pub. No.: US 2012/0103909 A1
(43) Pub. Date: May 3, 2012

(54) PARTICULATE CERIUM DIOXIDE AND AN IN SITU METHOD FOR MAKING AND USING THE SAME

(75) Inventors: John Burba, Parker, CO (US); Carl Hassler, Gig Harbor, WA (US); Robert Cable, Las Vegas, NV (US)

(73) Assignee: MOLYCORP MINERALS, LLC, Greenwood Village, CO (US)

(21) Appl. No.: 13/244,117

(22) Filed: Sep. 23, 2011

Related U.S. Application Data
(60) Provisional application No. 61/385,880, filed on Sep. 23, 2010.
(60) Provisional application No. 61/386,407, filed on Sep. 24, 2010.
(60) Provisional application No. 61/392,804, filed on Oct. 13, 2010.
(60) Provisional application No. 61/412,272, filed on Nov. 10, 2010.
(60) Provisional application No. 61/419,630, filed on Dec. 3, 2010.
(60) Provisional application No. 61/435,060, filed on Jan. 21, 2011.
(60) Provisional application No. 61/435,663, filed on Jan. 24, 2011.
(60) Provisional application No. 61/436,127, filed on Jan. 25, 2011.
(60) Provisional application No. 61/439,741, filed on Feb. 4, 2011.
(60) Provisional application No. 61/445,915, filed on Feb. 23, 2011.
(60) Provisional application No. 61/448,021, filed on Mar. 1, 2011.
(60) Provisional application No. 61/453,446, filed on Mar. 16, 2011.
(60) Provisional application No. 61/474,902, filed on Apr. 13, 2011.
(60) Provisional application No. 61/475,155, filed on Apr. 13, 2011.

(51) Int. Cl. C02F 1/42; C09K 3/00; B82Y 99/00

(52) U.S. Cl. 210/665; 252/184; 210/668; 977/773; 977/902

(57) ABSTRACT

This disclosure relates generally to methods and compositions for removing contaminants from streams and is particularly concerned with methods and compositions for removing contaminants from municipal wastewaters, municipal drinking waters and recreational waters. The present disclosure is to particulate cerium, more particularly to particulate cerium (IV) formed by an in situ oxidative process and to a method for removing target materials from a target material-containing stream using particulate cerium formed in situ.

### CROSS REFERENCE TO RELATED APPLICATIONS

The present application claims the benefits of U.S. Provisional Application Ser. Nos. 61/385,880 with a filing date of Sep. 23, 2010, 61/386,407 with a filing date of Sep. 24, 2010, 61/392,804 with a filing date of Oct. 13, 2010, 61/412,272 with a filing date of Nov. 10, 2010, 61/419,630 with a filing date of Dec. 3, 2010, all entitled “Process for Treating Waters and Water Handling Systems Using Rare Earth Metals”, each of which is incorporated in its entirety herein by this reference.

Cross reference is made to U.S. patent application Ser. No. ______, filed Sep. 23, 2011, entitled “PROCESS FOR TREATING WATERS AND WATER HANDLING SYSTEMS TO REMOVE SCALES AND REDUCE THE SCALING TENDENCY” having attorney docket no. 6062-89-3, which is incorporated herein by this reference in its entirety.

### FIELD OF INVENTION

The present disclosure is to particulate cerium, more particularly to particulate cerium (IV) formed by an in situ oxidative process and to a method for removing target materials from a target material-containing stream using particulate cerium formed in situ.

### BACKGROUND OF THE INVENTION

This disclosure relates generally to methods and compositions for removing contaminants from streams and is particularly concerned with methods and compositions for removing contaminants from municipal wastewaters, municipal drinking waters and recreational waters.

Various technologies have been used to remove contaminants from municipal and recreational waters. Examples of such techniques include adsorption on high surface area materials, such as alumina and activated carbon, ion exchange with anion exchange resins, co-precipitation and electrodialysis. However, most technologies for contaminant removal are hindered by the difficulty of removing the contaminant.

### SUMMARY OF THE INVENTION

These and other needs are addressed by the various embodiments and configurations of this disclosure. This disclosure relates generally to particulate cerium formed in suit by an oxidative process, more particularly to particulate cerium (IV) formed by oxidizing a dissolved form of cerium (III). Preferably, the particulate cerium (IV) comprises cerium dioxide (CeO₂). More preferably, the particulate cerium (IV) is nano-particulate cerium (IV).

Furthermore, the particulate cerium is formed in situ in a first fluid stream. The first fluid stream is in fluid communication with a target material-containing stream. It can be appreciated that the first fluid and target material-containing streams can be separate and distinct fluid streams or can be the same fluid stream. The particulate cerium may be formed in the first fluid stream prior to contacting the first fluid stream with the target material-containing stream and/or may be formed in the target material-containing stream.

Moreover, one or more of the target materials contained in the target material-containing stream may be removed by the particulate cerium.

Some embodiments include an aqueous composition. More specifically, the aqueous composition includes an aqueous solution having a particulate comprising a rare earth having a +4 oxidation state and a reduced form of an oxidizing agent. The aqueous composition is in the form of a colloid, suspension, or slurry. Preferably, the rare earth having the +4 oxidation state is cerium. In some configurations, the aqueous composition further includes one or more earths other the rare earth having the +4 oxidation state. The one or more rare earths comprise water-soluble rare earths having an oxidation state of +3.

Some embodiments include an aqueous solution having a particulate comprising a rare earth having a +4 oxidation state, a reduced form of an oxidizing agent, and a target material sorbed on the particulate material. The particulate material contains the rare earth having the +4 oxidation state. The aqueous solution is in the form of a colloid, suspension, or slurry. The aqueous solution is the form of a chemical composition.

Some embodiments include a method. The method includes contacting, in a fluid, a rare earth-containing additive containing at least some water-soluble cerium (III) with an oxidizing agent to oxidize at least some of the cerium (III) to cerium (IV). Preferably, the cerium (IV) is in the form of a particulate, more preferably the cerium (IV) particulates are suspended and/or dispersed in the fluid. The method preferably further includes contacting the cerium (IV) particulates with a target material contained within a target material-containing stream to remove at least some, if not most, of the target material from the target material-containing stream and to form a target material-laden rare earth composition and a barren stream having a target material content less than the target material-containing stream.

Preferably, the method further includes, pre-treating the target material-containing stream before contacting the cerium (IV) particulates with a target material contained within a target material-containing stream. The pre-treating includes one or more of clarifying, disinfecting, coagulating, aerating, filtering, heating, cooling, separating solids and liquids, digesting and polishing of the target material-containing stream. The pre-treating includes preforming the one or more of clarifying, disinfecting, coagulating, aerating, filtering, heating, cooling, separating solids and liquids, digesting and polishing of the target material-containing stream in any order.

In some configurations, the method includes separating the target material-laden rare earth composition from the barren stream to form a separated target material-laden rare earth composition and a separated barren stream.

In some configurations, the method includes treating the barren stream before separating the target material-laden rare earth composition from the barren stream. The treating preferably includes one or more of clarifying, disinfecting, coagulating, aerating, filtering, heating, cooling, separating solids and liquids, digesting and polishing of the barren stream. The treating includes preforming the one or more of clarifying, disinfecting, coagulating, aerating, filtering, heating, cooling, separating solids and liquids, digesting and polishing of the target material-containing stream in any order.

In some configurations, the method includes post-treating the separated barren stream to form a purified stream. The post-treating comprises one or more of clarifying, disinfecting, coagulating, aerating, filtering, heating, cooling, separating solids and liquids, digesting and polishing of the separated barren stream. The post-treating includes preforming the one or more of clarifying, disinfecting, coagulating, aerating, filtering, heating, cooling, separating solids and liquids, digesting and polishing of the target material-containing stream in any order.

The rare earth having the +4 oxidation state is one or more of cerium (IV) oxide, cerium (IV) hydroxide, cerium (IV) oxyhydroxy, cerium (IV) hydrous oxide, cerium (IV) hydrous oxyhydroxy, CeO₂, Ce(IV)(O)_{w}(OH)ₓ(OH)_{y}.zH₂O, where w, x, y and z can be zero or a positive, real number, or mixture thereof.

Preferably, the reduced form of the oxidizing agent is present in the aqueous composition in an amount no less than the molar amount of the rare earth having the +4 oxidation state.

Preferably, the target material comprises a deposit material, oxyanion, colorant, dye, dye carrier, ink, pigment, biological contaminant, chemical contaminant, physiological active contaminant or a mixture thereof.

The target material-laden rare earth composition has one of a deposit material, oxyanion, colorant, dye, dye carrier, ink, pigment, biological contaminant, chemical contaminant, physiological active contaminant or a mixture thereof sorbed on the cerium (IV) particulate.

Preferably, the aqueous solution and/or target material-containing stream are one of a recreational water, municipal water, wastewater, well water, septic water, drinking water, naturally occurring water, or mixture thereof. More preferably, the aqueous solution and/or target material-containing stream are derived from one a recreational water, municipal water, wastewater, well water, septic water, drinking water, naturally occurring water, or mixture thereof.

The target material is contained in the aqueous solution and/or the target material-containing stream. Preferably, one or more target materials are contained in the aqueous solution and/or the target material-containing fluid.

The particulate and/or cerium (IV) particulate has one of a mean, median or P₉₀ size from about 0.1 to about 1,000 nanometers. Preferably, the particulate and/or cerium (IV) particulate is a nano-particulate.

The rare earth-containing additive is preferably one or more rare earths other the water-soluble cerium (III), wherein the one or more other rare earths are selected from the group consisting essentially of yttrium, scandium, praseodymium, neodymium, samarium, europium, gadolinium, terbium, dysprosium, holmium, erbium, thulium, ytterbium, and lutetium.

Preferably, the oxidizing agent is one or more of chlorine, chloroamines, chlorine dioxide, hypochlorites, trihalomethane, haloacetic acid, ozone, hydrogen peroxide, peroxygen compounds, hypobromous acid, bromoamines, hypobromite, hypochlorous acid, isocyanurates, tricholoro-s-triazinetriones, hydantoins, bromochloro-dimethyldantoins, 1-bromo-3-chloro-5,5-dimethyldantoin, 1,3-dichloro-5,5-dimethyldantoin, sulfur dioxide, bisulfates, bromine, BrCl, permanganates, phenols, alcohols, oxyanions, arsenites, chromates, trichloroisocyanuric acid, surfactants electromagnetic energy, ultra violet light, thermal energy, ultrasonic energy, gamma rays and combinations thereof.

The term “water” refers to any aqueous stream. The water may originate from any aqueous stream may be derived from any natural and/or industrial source. Non-limiting examples of such aqueous streams and/or waters are drinking waters, potable waters, recreational waters, waters derived from manufacturing processes, wastewaters, pool waters, spa waters, cooling waters, boiler waters, process waters, municipal waters, sewage waters, agricultural waters, ground waters, power plant waters, remediation waters, co-mingled water and combinations thereof.

The term “water handling system” refers to any system containing, conveying, manipulating, physically transforming, chemically processing, mechanically processing, purifying, generating and/or forming the aqueous composition, treating, mixing and/or co-mingling the aqueous composition with one or more other waters and any combination thereof.

A “water handling system component” refers to one or more unit operations and/or pieces of equipment that process and/or treat water (such as a holding tank, reactor, purifier, treatment vessel or unit, mixing vessel or element, wash circuit, precipitation vessel, separation vessel or unit, settling tank or vessel, reservoir, pump, aerator, cooling tower, heat exchanger, valve, boiler, filtration device, solid liquid and/or gas liquid separator, nozzle, tender, and such), conduits interconnecting the unit operations and/or equipment (such as piping, hoses, channels, aqua-ducts, ditches, and such) and the water conveyed by the conduits. The water handling system components and conduits are in fluid communication.

The terms “water” and “water handling system” will be used interchangeably. That is, the term “water” may used to refer to “a water handling system” and the term “water handling system” may be used to refer to the term “water”.

A “deposit” and/or “deposit material” refer to a material associated with a water handling system (such as a scale adhered to one or components of the water handling system) and/or contained in water (such as a suspended or dissolved material). The terms “scale” and “deposit” will be used herein interchangeably. Struvite is a non-limiting example of a deposit material. Furthermore, with regards to the non-limiting example of struvite, the terms deposit and deposit material refers to one or more of a scale adhered to a component of the water handling system (such as, a struvite (NH₄MgPO₄) scale), particulates suspended in the water (such as, suspended struvite particulates), and the deposit material in a dissolved state within water (such as, struvite in the dissolved state in the form of dissociated, dissolved ammonium (NH₄⁺), magnesium (Mg²⁺) and phosphate (PO₄³⁻) ions). Furthermore, the deposit material may be an inorganic material, mineral, organic material, biological matter or combination thereof. The deposit materials comprising biological matter include, without limitation, bacteria, algae, funguses, molds, viruses, and other microbes. Non-limiting examples of inorganic, organic and mineral deposit materials typically comprise arsenates, arsenates, sulfates, carbonates, oxalates, silicates, phosphates, barium hydrogen phosphate (BaHPO₄), barium pyrophosphate (Ba₂P₂O₇), bismuth phosphate (BiPO₄), cadmium phosphate (Cd₃(PO₄)₂), mono-calcium phosphate (Ca(H₂PO₄)₂), di-calcium phosphate (CaHPO₄), calcium phosphate (Ca₃(PO₄)₂), lead hydrogen phosphate (PbHPO₄), lithium phosphate (Li₃PO₄), magnesium phosphate (Mg₃(PO₄)₂), nickel phosphate (Ni₂P₂O₇), thallium phosphate (Tl₃PO₄), barium arsenate (Ba₃(ASO₄)₂), bismuth arsenate (BiAsO₄), cadmium arsenate (Cd₃(AsO₄)₂), calcium arsenate (Ca₃(AsO₄)₂), ferric arsenate (FeAsO₄), struvite (NH₄MgPO₄) and combinations thereof.

The term “scaling tendency” refers to the characteristic and/or potential of a water to form a deposit, typically to form a scale and/or particulates suspended in the water. The greater the scaling tendency the more likely a deposit may form.

The terms “alkaline earth” and/or “Group 2” metals refer to one or more of beryllium (Be), magnesium (Mg), calcium (Ca), strontium (Sr), barium (Ba), and radium (Ra).

The terms “pnictogen” and/or “Group 15” refers to one or more of nitrogen (N), phosphorous (P), arsenic (As), antimony (Sb) and bismuth (Bi).

A “halogen” is a nonmetal element from Group 17 IUPAC Style (formerly: VII, VIIA) of the periodic table, comprising fluorine (F), chlorine (Cl), bromine (Br), iodine (I), and astatine (At). The artificially created element 117, provisionally referred to by the systematic name ununseptium, may also be a halogen. A “halide compound” is a compound having as one part of the compound at least one halogen atom and the other part the compound is an element or radical that is less electronegative (or more electropositive) than the halogen. The halide compound is typically a fluoride, chloride, bromide, iodide, or astatide compound. Many salts are halides having a halide anion. A halide anion is a halogen atom bearing a negative charge. The halide anions are fluoride (F⁻), chloride (Cl⁻), bromide (Br⁻), iodide (I⁻) and astatide (At⁻).

“Absorption” refers to the penetration of one substance into the inner structure of another, as distinguished from adsorption.

“Adsorption” refers to the adherence of atoms, ions, molecules, polyatomic ions, or other substances of a gas or liquid to the surface of another substance, called the adsorbent. Typically, the attractive force for adsorption can be ionic forces such as covalent, or electrostatic forces, such as van der Waals and/or London's forces.

The term “sorb” refers to adsorption, absorption or both adsorption and absorption.

The term “composition” refers to one or more chemical units composed of one or more atoms, such as a molecule, polyatomic ion, chemical compound, coordination complex, coordination compound, and the like. As will be appreciated, a composition can be held together by various types of bonds and/or forces, such as covalent bonds, metallic bonds, coordination bonds, ionic bonds, hydrogen bonds, electrostatic forces (e.g., van der Waal's forces and London's forces), and the like.

The term “suspension” refers to a heterogeneous mixture of a solid, typically in the form of particulates dispersed in a liquid. In a suspension, the solid particulates are in the form of a discontinuous phase dispersed in a continuous liquid phase. The term “colloid” refers to a suspension comprising solid particulates that typically do not settle-out from the continuous liquid phase due to gravitational forces. As used hereinafter, the terms “suspension”, “colloid” or “slurry” will be used interchangeably to refer to one or more materials dispersed and/or suspended in a continuous liquid phase.

The terms “agglomerate” and “aggregate” refer to a composition formed by gathering one or more materials into a mass.

A “binder” refers to one or more substances that bind together a material being agglomerated. Binders are typically solids, semi-solids, or liquids. Non-limiting examples of binders are polymeric materials, tar, pitch, asphalt, wax, cement water, solutions, dispersions, powders, silicates, gels, oils, alcohols, clays, starch, silicates, acids, molasses, lime and lignosulphonate oils, hydrocarbons, glycerin, stearate, polymers, wax, or combinations thereof. The binder may or may not chemically react with the material being agglomerated. Non-liming examples of chemical reactions include hydration/dehydration, metal ion reactions, precipitation/gelation reactions, and surface charge modification.

The term “insoluble” refers to materials that are intended to be and/or remain as solids in water and are able to be retained in a device, such as a column, or be readily recovered from a batch reaction using physical means, such as filtration. Insoluble materials should be capable of prolonged exposure to water, over weeks or months, with little loss of mass. Typically, a little loss of mass refers to less than about 5% mass loss of the insoluble material after a prolonged exposure to water.

The term “oxidizing agent” refers to one or both of a chemical substance and physical process that transfers and/or assists in removal of one or more electrons from a substance. The substance having the one or more electrons being removed is oxidized. In regards to the physical process, the physical process may removal and/or may assist in the removal of one or more electrons from the substance being oxidized. For example, the substance to be oxidized can be oxidized by electromagnetic energy when the interaction of the electromagnetic energy with the substance be oxidized is sufficient to substantially remove one or more electrons from the substance. On the other hand, the interaction of the electromagnetic energy with the substance being oxidized may not be sufficient to remove one or more electrons, but may be enough to excite electrons to higher energy state, were the electron in the excited state can be more easily removed by one or more of a chemical substance, thermal energy, or such.

The terms “oxyanion” and/or “oxoanion” are chemical compounds with a generic formula of AₓO_{y}^{z-} (where A represents a chemical element other than oxygen, O represents the element oxygen and x, y and z represent real numbers). In the embodiments having oxyanions as a chemical contaminant, “A” represents metal, metalloid, and/or non-metal elements. Examples for metal-based oxyanions include chromate, tungstate, molybdate, aluminates, zirconate, etc. Examples of metalloid-based oxyanions include arsenate, arsenite, antimonate, germanate, silicate, etc. Examples of non-metal-based oxyanions include phosphate, selemate, sulfate, etc. Preferably, the oxyanion includes oxyanions of elements having an atomic number of 7, 13 to 17, 22 to 25, 31 to 35, 40 to 42, 44, 45, 49 to 53, 72 to 75, 77, 78, 82, 83 85 and 92. These elements include These elements include carbon, nitrogen, aluminum, silicon, phosphorous, sulfur, chlorine, titanium, vanadium, chromium, manganese, arsenic, selenium, bromine, gallium, germanium, zirconium, niobium, molybdenum, ruthenium, rhodium, indium, tin, iodine, antimony, tellurium, hafnium, tantalum, tungsten, rhenium, iridium, platinum, lead, bismuth astatine, and uranium.

“Anthraquinone” refers to a substance based on 9,10-anthraquinone (which is essentially colorless) having an electron-donor group, such as amino or hydroxyl introduced into one or more of the four alpha positions (1, 4, 5, and 8).

An “auxochrome” is a chemical substitute that intensifies the color of a chromophore by withdrawing or donating electrons to the chromophore. Common auxochrome substituents include amine (—NH₃), carboxyl (—C(═O)OH), sulfonate (—SO₃H), and hydroxyl (—OH).

A “chromophore” is a group of atoms responsible for the dye color. Examples of chromophores are azo (—N═N—), carbonyl (>C═O), methine (═(C—H)—), nitro (—NO₂), hydrazo (the bivalent group —HNNH—), anthraquinone, alkyne (HC≡), styryl (C₆H₅—CH═C<), methyl (—CH₃), cyanine, thiazine, and quinone.

A “colorant” is any substance that imparts color, such as a pigment or dye.

“De-toxify” or “de-toxification” includes rendering a target material, such as chemical and/or biological target material non-toxic to a living organism, such as, for example, human or other animal. The target material may be rendered non-toxic by converting the target material into a non-toxic form or species.

A “dye” is a colorant, usually transparent, which is soluble in an application medium. Dyes are classified according to chemical structure, usage, or application method. They are composed of groups of atoms responsible for the dye color, called chromophores, and intensity of the dye color, called auxchromes. The chemical structure classification of dyes, for example, uses terms such as azo dyes (e.g., monoazo, disazo, trisazo, polyazo, hydroxyazo, carboxyazo, carbocyclic azo, heterocyclic azo (e.g., indoles, pyrazolones, and pyridones), azophenol, aminoazo, and metalized (e.g., copper (II), chromium (III), and cobalt (III)) azo dyes, and mixtures thereof), anthraquinone (e.g., tetra-substituted, disubstituted, trisubstituted and momosubstitued, anthroaquinone dyes (e.g., quinolines), premetallized anthraquinone dyes (including polycyclic quinones), and mixtures thereof), benzodifuranone dyes, polycyclic aromatic carbonyl dyes, indigoid dyes, polymethine dyes (e.g., azacarobocyanine, diazacarbocyanine, cyanine, hemicyanine, and diazahemicyanine dyes, triazolium, benothiazolium, and mixtures thereof), styryl dyes, (e.g., dicyanovinyl, tricyanovinyl, tetracyanoctylene dyes) diaryl carbonium dyes, triaryl carbonium dyes, and heterocyclic derivates thereof (e.g., triphenylmethane, diphenylmethane, thiazine, triphendioxazine, pyronine (xanthene) derivatives and mixtures thereof), phthalocyanine dyes (including metalized phthalocyanine dyes), quinophthalone dyes, sulfur dyes, (e.g., phenothiazonethianthrone) nitro and nitroso dyes (e.g., nitrodiphenylamines, metal-complex derivatives of o-nitrosophenols, derivatives of naphthols, and mixtures thereof), stilbene dyes, formazan dyes, hydrazone dyes (e.g., isomeric 2-phenylazo-1-naphthols, 1-phenylazo-2-naphthols, azopyrazolones, azopyridones, and azoacetoacetanilides), azine dyes, xanthene dyes, triarylmethane dyes, azine dyes, acridine dyes, oxazine dyes, pyrazole dyes, pyrazalone dyes, pyrazoline dyes, pyrazalone dyes, coumarin dye, naphthalimide dyes, carotenoid dyes (e.g., aldehydic carotenoid, β-carotene, canthaxanthin, and β-Apo-8′-carotenal), flavonol dyes, flavone dyes, chroman dye, aniline black dye, indeterminate structures, basic dye, quinacridone dye, formazan dye, triphendioxazine dye, thiazine dye, ketone amine dyes, caramel dye, poly(hydroxyethyl methacrylate)-dye copolymers, riboflavin, and copolymers, derivatives, and mixtures thereof. The application method classification of dyes uses the terms reactive dyes, direct dyes, mordant dyes, pigment dyes, anionic dyes, ingrain dyes, vat dyes, sulfur dyes, disperse dyes, basic dyes, cationic dyes, solvent dyes, and acid dyes.

A “dye carrier”, or dyeing accelerant, enables dye penetration into fibers, particularly polyester, cellulose acetate, polyamide, polyacrylic, and cellulose triacetate fibers. The penetration of the dye carrier into the fiber lowers the glass-transition temperature, T_{g}, of the fiber and allows a water-insoluble dye to be taken into the fiber. Most dye carriers are aromatic compounds. Examples of dye carriers include phenolics (e.g., o-phenylphenol, p-phenylphenol, and methyl crestotinate), chlorinated aromatics (e.g., o-dichlorobenzene, and 1,3,5-trichlorobenzene), aromatic hydrocarbons and ethers (e.g., biphenyl, methylbiphenyl, diphenyl oxide, 1-methylnaphthalene, and 2-methylnaphthalene), aromatic esters (e.g., methyl benzoate, butyl benzoate, and benzyl benzoate), and phthalates (e.g., dimethyl phthalate, diethyl phthalate, diallyl phthalate, and dimethyl terephthalate).

A “dye intermediate” refers to a dye precursor or intermediate. A dye intermediate, as used herein, includes both primary intermediates and dye intermediates. Dye intermediates are generally divided into carbocycles, such as benzene, naphthalene, sulfonic acid, diazo-1,2,4-acid, anthraquinone, phenol, aminothiazole nitrate, aryldiazonium salts, arylalkylsulfones, toluene, anisole, aniline, anilide, and chrysazin, and heterocycles, such as pyrazolones, pyridines, indoles, triazoles, aminothiazoles, aminobenzothiazoles, benzoisothiazoles, triazines, and thiopenes.

An “ink” refers to a liquid or paste containing various pigments and/or dyes used for coloring a surface to produce an image, text, or design. Liquid ink is commonly used for drawing and/or writing with a pen, brush or quill. Paste inks are generally thicker than liquid inks. Paste inks are used extensively in letterpress and lithographic printing.

A “pigment” is a synthetic or natural (biological or mineral) material that changes the color of reflected or transmitted light as the result of wavelength-selective absorption. This physical process differs from fluorescence, phosphorescence, and other forms of luminescence, in which a material emits light. The pigment may comprise inorganic and/or organic materials. Inorganic pigments include elements, their oxides, mixed oxides, sulfides, chromates, silicates, phosphates, and carbonates. Examples of inorganic pigments, include cadmium pigments, carbon pigments (e.g., carbon black), chromium pigments (e.g., chromium hydroxide green and chromium oxide green), cobalt pigments, copper pigments (e.g., chlorophyllin and potassium sodium copper chlorophyllin), pyrogallol, pyrophyllite, silver, iron oxide pigments, clay earth pigments, lead pigments (e.g., lead acetate), mercury pigments, titanium pigments (e.g., titanium dioxide), ultramarine pigments, aluminum pigments (e.g., alumina, aluminum oxide, and aluminum powder), bismuth pigments (e.g., bismuth vanadate, bismuth citrate and bismuth oxychloride), bronze powder, calcium carbonate, chromium-cobalt-aluminum oxide, cyanide iron pigments (e.g., ferric ammonium ferrocyanide, ferric and ferrocyanide), manganese violet, mica, zinc pigments (e.g., zinc oxide, zinc sulfide, and zinc sulfate), spinels, rutiles, zirconium pigments (e.g., zirconium oxide and zircon), tin pigments (e.g., cassiterite), cadmium pigments, lead chromate pigments, luminescent pigments, lithopone (which is a mixture of zinc sulfide and barium sulfate), metal effect pigments, nacreous pigments, transparent pigments, and mixtures thereof. Examples of synthetic organic pigments include ferric ammonium citrate, ferrous gluconate, dihydroxyacetone, guaiazulene, and mixtures thereof. Examples of organic pigments from biological sources include alizarin, alizarin crimson, gamboge, cochineal red, betacyanins, betataxanthins, anthocyanin, logwood extract, pearl essence, paprika, paprika oleoresins, saffron, turmeric, turmeric oleoresin, rose madder, indigo, Indian yellow, tagetes meal and extract, Tyrian purple, dried algae meal, henna, fruit juice, vegetable juice, toasted partially defatted cooked cottonseed flour, quinacridone, magenta, phthalo green, phthalo blue, copper phthalocyanine, indanthone, triarylcarbonium sulfonate, triarylcarbonium PTMA salt, triaryl carbonium Ba salt, triarylcarbonium chloride, polychloro copper phthalocyanine, polybromochlor copper phthalocyanine, monoazo, disazo pyrazolone, monoazo benzimid-azolone, perinone, naphthol AS, beta-naphthol red, naphthol AS, disazo pyrazolone, BONA, beta naphthol, triarylcarbonium PTMA salt, disazo condensation, anthraquinone, perylene, diketopyrrolopyrrole, dioxazine, diarylide, isoindolinone, quinophthalone, isoindoline, monoazo benzimidazolone, monoazo pyrazolone, disazo, benzimidazolones, diarylide yellow dintraniline orange, pyrazolone orange, para red, lithol, azo condensation, lake, diaryl pyrrolopyrrole, thioindigo, aminoanthraquinone, dioxazine, isoindolinone, isoindoline, and quinphthalone pigments, and mixtures thereof. Pigments can contain only one compound, such as single metal oxides, or multiple compounds. Inclusion pigments, encapsulated pigments, and lithopones are examples of multi-compound pigments. Typically, a pigment is a solid insoluble powder or particle having a mean particle size ranging from about 0.1 to about 0.3 μm, which is dispersed in a liquid. The liquid may comprise a liquid resin, a solvent or both. Pigment-containing compositions can include extenders and opacifiers.

A “quinone” refers to any member of a class of cyclic aromatic compounds having a fully configurable cyclic dione structure, derived from aromatic compounds by conversion of an even number of ═CH— group into >C═O groups with any necessary rearrangement of double bonds (including polycyclic and heterocyclic analogues).

The terms “biological contaminant”, “microbe”, “microorganism”, and the like include bacteria, fungi, protozoa, viruses, algae and other biological entities and pathogenic species that can be found in aqueous solutions. Specific non-limiting examples of biological contaminants can include bacteria such as Escherichia coli, Streptococcus faecalis, Shigella spp, Leptospira, Legimella pneumophila, Yersinia enterocolitica, Staphylococcus aureus, Pseudomonas aeruginosa, Klebsiella terrigena, Bacillus anthracis, Vibrio cholerae and Salmonella typhi, viruses such as hepatitis A, notoviruses, rotaviruses, and enteroviruses, protozoa such as Entamoeba histolytica, Giardia, Cryptosporidium parvum and others. Biological contaminants can also include various species such as fungi or algae that are generally non-pathogenic but which are advantageously removed. How such biological contaminants came to be present in the solution or gas, either through natural occurrence or through intentional or unintentional contamination, is non-limiting of the disclosure.

The term “chemical contaminant” or “chemical agent” includes known chemical warfare agents and industrial chemicals and materials such as pesticides, insecticides and fertilizers. In some embodiments, the chemical contaminant can include one or more of an organosulfur agent, an organophosphorous agent or a mixture thereof. Specific non-limiting examples of such agents include o-alkyl phosphonofluoridates, such as sarin and soman, o-alkyl phosphoramidocyanidates, such as tabun, o-alkyl, s-2-dialkyl aminoethyl alkylphosphonothiolates and corresponding alkylated or protonated salts, such as VX, mustard compounds, including 2-chloroethylchloromethylsulfide, humic acid, tannic acid, bis(2-chloroethyl)sulfide, bis(2-chloroethylthio)methane, 1,2-bis(2-chloroethylthio)ethane, 1,3-bis(2-chloroethylthio)-n-propane, 1,4-bis(2-chloroethylthio)-n-butane, 1,5-bis(2-chloroethylthio)-n-pentane, bis(2-chloroethylthiomethyl)ether, and bis(2-chloroethylthioethyl)ether, Lewisites, including 2-chlorovinyldichloroarsine, bis(2-chlorovinyl)chloroarsine, tris(2-chlorovinyl)arsine, bis(2-chloroethyl)ethylamine, and bis(2-chloroethyl)methylamine, saxitoxin, ricin, alkyl phosphonyldifluoride, alkyl phosphonites, chlorosarin, chlorosoman, amiton, 1,1,3,3,3,-pentafluoro-2-(trifluoromethyl)-1-propene, 3-quinuclidinyl benzilate, methylphosphonyl dichloride, dimethyl methylphosphonate, dialkyl phosphoramidic dihalides, alkyl phosphoramidates, diphenyl hydroxyacetic acid, quinuclidin-3-ol, dialkyl aminoethyl-2-chlorides, dialkyl aminoethane-2-ols, dialkyl aminoethane-2-thiols, thiodiglycols, pinacolyl alcohols, phosgene, cyanogen chloride, hydrogen cyanide, chloropicrin, phosphorous oxychloride, phosphorous trichloride, phosphorus pentachloride, alkyl phosphorous oxychloride, alkyl phosphites, phosphorous trichloride, phosphorus pentachloride, alkyl phosphites, sulfur monochloride, sulfur dichloride, and thionyl chloride. Non-limiting examples of industrial chemical and materials include materials that have anionic functional groups such as phosphates, sulfates and nitrates, and electro-negative functional groups, such as chlorides, fluorides, bromides, ethers and carbonyls. Specific non-limiting examples can include acetaldehyde, acetone, acrolein, acrylamide, acrylic acid, acrylonitrile, aldrin/dieldrin, ammonia, aniline, arsenic, atrazine, barium, benzidine, 2,3-benzofuran, beryllium, 1,1′-biphenyl, bis(2-chloroethyl)ether, bis(chloromethyl)ether, bromodichloromethane, bromoform, bromomethane, 1,3-butadiene, 1-butanol, 2-butanone, 2-butoxyethanol, butraldehyde, carbon disulfide, carbon tetrachloride, carbonyl sulfide, chlordane, chlorodecone and mirex, chlorfenvinphos, chlorinated dibenzo-p-dioxins (CDDs), chlorine, chlorobenzene, chlorodibenzofurans (CDFs), chloroethane, chloroform, chloromethane, chlorophenols, chlorpyrifos, cobalt, copper, creosote, cresols, cyanide, cyclohexane, DDT, DDE, DDD, DEHP, di(2-ethylhexyl)phthalate, diazinon, dibromochloropropane, 1,2-dibromoethane, 1,4-dichlorobenzene, 3,3′-dichlorobenzidine, 1,1-dichloroethane, 1,2-dichloroethane, 1,1-dichloroethene, 1,2-dichloroethene, 1,2-dichloropropane, 1,3-dichloropropene, dichlorvos, diethyl phthalate, diisopropyl methylphosphonate, di-n-butylphtalate, dimethoate, 1,3-dinitrobenzene, dinitrocresols, dinitrophenols, 2,4- and 2,6-dinitrotoluene, 1,2-diphenylhydrazine, di-n-octylphthalate (DNOP), 1,4-dioxane, dioxins, disulfoton, endosulfan, endrin, ethion, ethylbenzene, ethylene oxide, ethylene glycol, ethylparathion, fenthions, fluorides, formaldehyde, freon 113, heptachlor and heptachlor epoxide, hexachlorobenzene, hexachlorobutadiene, hexachlorocyclohexane, hexachlorocyclopentadiene, hexachloroethane, hexamethylene diisocyanate, hexane, 2-hexanone, HMX (octogen), hydraulic fluids, hydrazines, hydrogen sulfide, iodine, isophorone, malathion, MBOCA, methamidophos, methanol, methoxychlor, 2-methoxyethanol, methyl ethyl ketone, methyl isobutyl ketone, methyl mercaptan, methylparathion, methyl t-butyl ether, methylchloroform, methylene chloride, methylenedianiline, methyl methacrylate, methyl-tert-butyl ether, mirex and chlordecone, monocrotophos, N-nitrosodimethylamine, N-nitrosodiphenyl amine, N-nitrosodi-n-propylamine, naphthalene, nitrobenzene, nitrophenols, perchloroethylene, pentachlorophenol, phenol, phosphamidon, phosphorus, polybrominated biphenyls (PBBs), polychlorinated biphenyls (PCBs), polycyclic aromatic hydrocarbons (PAHs), propylene glycol, phthalic anhydride, pyrethrins and pyrethroids, pyridine, RDX (cyclonite), selenium, styrene, sulfur dioxide, sulfur trioxide, sulfuric acid, 1,1,2,2-tetrachloroethane, tetrachloroethylene, tetryl, thallium, tetrachloride, trichlorobenzene, 1,1,1-trichloroethane, 1,1,2-trichloroethane, trichloroethylene (TCE), 1,2,3-trichloropropane, 1,2,4-trimethylbenzene, 1,3,5-trinitrobenzene, 2,4,6-trinitrotoluene (TNT), vinyl acetate, and vinyl chloride.

The term “physiologically active material” material refers to a material that is one or more of toxic, harmful and pathogenic to humans and/or animals. The physiologically active material is typically an organic material. Non-limiting examples of physiologically active materials include, without limitation, pharmaceutical and personal care products used by individuals for personal health or cosmetic reasons or used by agribusiness to enhance growth or health of livestock. Physiologically active materials can include prescription and over-the-counter therapeutic drugs, veterinary drugs, fragrances, cosmetics, pesticides, herbicides, insecticides, rodenticides, hormones, stimulants (such as caffeine), fungicides, pheromones, and their metabolic products having physiological activity in animals. Non-limiting examples include prescription, veterinary, and over-the-counter therapeutic drugs, fragrances, cosmetics, sun-screen agents, diagnostic agents, nutraceuticals, biopharmaceutical compounds, growth enhancing chemicals, growth enhancing chemicals used in livestock operations, and primary and secondary metabolites, veterinary drugs, antimicrobials, estrogenic steroids, antidepressants, selective serotonin reuptake inhibitors, calcium-channel blockers, antiepileptic drugs, phenyloins, valproates, carbamazepines, multi-drug transporters, efflux pumps, musk aroma chemicals, triclosans, genotoxic drugs, derivatives of these compounds and mixtures thereof. Furthermore, the physiologically active material can comprise one or more of an antipyretics, analgesics, antimalarial drugs, antiseptics, antacids, reflux suppressants, antiflatulents, antidopaminergics, proton pump inhibitors (PPIs), H2-receptor antagonists, cytoprotectants, prostaglandin analogues, laxatives, antispasmodics, antidiarrhoeals, bile acid sequestrants, opioid, β-receptor blockers, calcium channel blockers, diuretics, cardiac glycosides, antiarrhythmics, nitrate, antianginals, vasoconstrictors, vasodilators, peripheral activators, antihypertensive drugs, ACE inhibitors, angiotensin receptor blockers, a blockers, calcium channel blockers, anticoagulants, heparin, antiplatelet drugs, fibrinolytics, anti-hemophilic factors, haemostatic drugs, atherosclerosis/cholesterol inhibitors, hypolipidaemic agents, statins, hypnotics, anaesthetics, antipsychotics, antidepressants, tricyclic antidepressants, monoamine oxidase inhibitors, lithium salts, selective serotonin reuptake inhibitors (SSRIs), antiemetics, anticonvulsants, antiepileptics, anxiolytics, barbiturates, movement disorder drugs, stimulants, amphetamines, benzodiazepines, cyclopyrrolones, dopamine antagonists, antihistamines, cholinergics, anticholinergics, emetics, cannabinoids, 5-HT (serotonin) antagonists, nonsteroidal anti-inflammatory drugs, opioids and various orphans such as paracetamol, tricyclic antidepressants, anticonvulsants, adrenergic neurone blocker, astringent, ocular lubricant, topical anesthetics, sympathomimetics, parasympatholytics, mydriatics, cycloplegics, antibiotics, topical antibiotics, sulfa drugs, aminoglycosides, fluoroquinolones, antiviral drugs, anti-fungal drugs, imidazoles, polyenes, corticosteroids, anti-allergy, mast cell inhibitors, anti-glaucoma, adrenergic agonists, beta-blockers, carbonic anhydrase inhibitors/hyperosmotics, cholinergics, miotics, parasympathomimetics, prostaglandin agonists/prostaglandin inhibitors, nitroglycerin, sympathomimetics, antihistamines, anticholinergics, steroids, antiseptics, local anesthetics, cerumenolyti, bronchodilators, anti-allergics, antitussives, mucolytics, decongestants, Beta2-adrenergic agonists, anticholinergics, androgens, antiandrogens, gonadotropin, human growth hormone, insulin, antidiabetics, sulfonylureas, biguanides, metformin, thiazolidinediones, insulin, thyroid hormones, antithyroid drugs, calcitonin, diphosphonate, vasopressin analogues, alkalising agents, quinolones, cholinergics, anticholinergics, anticholinesterases, antispasmodics, 5-alpha reductase inhibitor, selective alpha-1 blockers, sildenafils, fertility medications, ormeloxifene, spermicide, anticholinergics, haemostatic drugs, antifibrinolytics, Hormone Replacement Therapy (HRT), bone regulators, beta-receptor agonists, follicle stimulating hormone, luteinising hormone, LHRH, gamolenic acid, gonadotropin release inhibitor, progestogen, dopamine agonists, oestrogen, prostaglandins, gonadorelin, clomiphene, tamoxifen, Diethylstilbestrol, emollients, anti-pruritics, disinfectants, scabicides, pediculicides, tar products, vitamin A derivatives, vitamin D analogues, keratolytics, abrasives, systemic antibiotics, topical antibiotics, hormones, desloughing agents, exudate absorbents, fibrinolytics, proteolytics, sunscreens, antiperspirants, antibiotics, antileprotics, antituberculous drugs, antimalarials, anthelmintics, amoebicides, antiprotozoals, vaccines, immunoglobulins, immunosuppressants, interferons, monoclonal antibodies, anti-allergics, antihistamines, tonics, iron preparations, electrolytes, parenteral nutritional supplements, vitamins, anti-obesity drugs, anabolic drugs, haematopoietic drugs, food product drugs, barbiturates, HMG-CoA reductase inhibitors, caffeine, acetaminophen, ibuprofen, dimethoprim, trimethoprim, sulfonamide, sulfamethoxazole, bis(2-ethylhexyl)phthalate, diethyl phthalate, cotinine, nicotine, lincomycini, sulfadimethoxine, sulfamethazine, sulfathiazole, tylosin, cholesterol, coprostan-3-ol, dihydrocholesterol, ergosterol, stigmastanol, stigmasterol, bezafibrate, clofibric acid, carbamazepine, diclofenac, naproxen, propranolol, ketoprofen, mefenamic acid, androstenedione, estrone, progesterone, estradiol, pentoxifylline, ethynylestradiol, synthetic estrogen EE2, endogenous estrogen 17β-estradiol (E2) and 17α-ethinylstradiol (EE2), estrone, meprobamate, phenyloin, ethinyl estradiol, mestranol, norethindrone, erythromycine, atenolol, triclosan, bisphenol A, nonylphenol, DEET, iopromide, TCEP, roxithromycin, erythromycin-H₂O, gemfibrozil, meprobamate, phenyloin, fluoxetine, diazepam, ethynylestradiol, atorvastatin, norfluoxetine, o-hydroxy atorvastatin, p-hydroxy atorvastatin, risperiodine, testosterone, risperidone, enalapril, simvastatin, simvastatin hydroxyl acid, clofibrate, phthalate esters, primidone, fluoroquinolones, norfloxacin, ofloxacin, ciprofloxacin, tetracycline, doxycycline, estriol, D-norgestrel, clopidogrel, enoxparin, celecoxib, rofecoxib, valdecoxib, omeprazole, esomeprazole, fexofenadine, quetiapine, metoprolol, budesonide, paracetamol, propylphenazone, acetaminophenone, ibuprofen methyl ester, quinolone, macrolide antibiotics, synthetic steroid hormone, loratadine, cetirizine, and mixtures thereof.

The term “phosphate” refers to phosphorous-containing oxyanions typically formed from a PO₄ (phosphate) structural unit alone or linked together by sharing oxygen atoms to form a linear chain or cyclic ring structure. Non-limiting examples of phosphates are: PO₄³⁻ (phosphate); P₃O₁₀⁻ (triphosphate); PₙO₃ₙ⁽ⁿ⁺²⁾⁻ (polyphosphate); P₃O₉³⁻ (cyclic trimethaphosphate); adenosine diphosphoric acid (ADPH); guanosine 5′-diphosphate 3′-dipphosphate (ppGpp); trimetaphosphate; hexametaphosphate; HPO₃²⁻ (phosphate); H₂P₂O₅²⁻ (pyrophosphites); H₂PO₂⁻ (hypophosphite); one or more of their salts, acids, esters, anionic and organophosphorus forms; and mixtures thereof.

“Precipitation” refers not only to the removal of a target material in the form of a target material-laden rare earth composition. The target material-laden rare earth composition can comprise a target-laden cerium (IV) composition, a target-laden rare earth-containing additive composition, a target-laden rare composition comprising a rare earth other than cerium (IV), or a combination thereof. Typically, the target material-laden rare earth composition comprises composition comprises and insoluble target material-laden rare earth composition. For example, “precipitation” includes processes, such as adsorption and absorption of the target material by one or more of the cerium (IV) composition, the rare earth-containing additive, or a rare earth other than cerium (IV). The target-material laden composition can comprise a +3 rare earth, such as cerium (III), lanthanum (III) or other lanthanoid having a +3 oxidation state.

“Rare earth” refers to one or more of yttrium, scandium, lanthanum, cerium, praseodymium, neodymium, samarium, europium, gadolinium, terbium, dysprosium, holmium erbium, thulium, ytterbium, and lutetium. As will be appreciated, lanthanum, cerium, praseodymium, neodymium, samarium, europium, gadolinium, terbium, dysprosium, holmium erbium, thulium, ytterbium, and lutetium are known as lanthanoids.

The terms “rare earth-containing composition”, “rare earth-containing additive” and “rare earth-containing particle” refer to any composition containing a rare earth other than non-compositionally altered rare earth-containing minerals. In other words, as used herein “rare earth-containing composition”, “rare earth-containing additive” and “rare earth-containing particle” exclude comminuted naturally occurring rare earth-containing minerals. However, as used herein “rare earth-containing composition”, “rare earth-containing additive” and “rare earth-containing particles” include a rare earth-containing mineral where one or both of the chemical composition and chemical structure of the rare earth-containing portion of the mineral has been compositionally altered. More specifically, a comminuted naturally occurring bastnasite would not be considered a rare earth-containing composition and/or rare earth-containing additive. However, a synthetically prepared bastnasite or a rare earth-containing composition prepared by a chemical transformation of naturally occurring bastnasite would be considered a rare earth-containing composition and/or rare earth-containing additive. The rare earth and/or rare-containing composition and/or additive are, in one application, not a naturally occurring mineral but synthetically manufactured. Exemplary naturally occurring rare earth-containing minerals include bastnasite (a carbonate-fluoride mineral) and monazite. Other naturally occurring rare earth-containing minerals include aeschynite, allanite, apatite, britholite, brockite, cerite, fluorcerite, fluorite, gadolinite, parisite, stillwellite, synchisite, titanite, xenotime, zircon, and zirconolite. Exemplary uranium minerals include uraninite (UO₂), pitchblende (a mixed oxide, usually U₃O₈), brannerite (a complex oxide of uranium, rare-earths, iron and titanium), coffinite (uranium silicate), carnotite, autunite, davidite, gummite, torbernite and uranophane. In one formulation, the rare earth-containing composition is substantially free of one or more elements in Group 1, 2, 4-15, or 17 of the Periodic Table, a radioactive species, such as uranium, sulfur, selenium, tellurium, and polonium.

“Rare earth” and “rare earth-containing composition” refer both to singular and plural forms of the terms. More specifically, the term “rare earth” refers to a single rare earth and/or combination and/or mixture of rare earths and the term “rare earth-containing composition” refers to a single composition comprising a single rare earth and/or a mixture of differing rare earth-containing compositions containing one or more rare earths and/or a single composition containing one or more rare earths.

“Chemical transformation” refers to process where at least some of a material has had its chemical composition transformed by a chemical reaction. “A chemical transformation” differs from “a physical transformation”. A physical transformation refers to a process where the chemical composition has not been chemically transformed but a physical property, such as physical size or shape, has been transformed.

The term “soluble” refers to a material that readily dissolves in a fluid, such as water or other solvent. For purposes of this disclosure, it is anticipated that the dissolution of a soluble material would necessarily occur on a time scale of minutes rather than days. For the material to be considered to be soluble, it is necessary that the material/composition has a significant solubility in the fluid such that upwards of about 5 g of the material will dissolve in about one liter of the fluid and be stable in the fluid.

The terminology “removal”, “remove” or “removing” includes the sorption, precipitation, conversion and combination thereof a target material contained in a water and/or water handling system.

The term “fluid” refers to a liquid, gas or both.

The term “surface area” refers to surface area of a material and/or substance determined by any suitable surface area measurement method. Preferably, the surface area is determined by any suitable Brunauer-Emmett-Teller (BET) analysis technique for determining the specific area of a material and/or substance.

The terms “pore volume” and “pore size”, respectively, refer to pore volume and pore size determinations made by any suite measure method. Preferably, the pore size and pore volume are determined by any suitable Barret-Joyner-Halenda method for determining pore size and volume. Furthermore, it can be appreciated that as used herein pore size and pore diameter can used interchangeably.

The term “contained within the water” refers to materials suspended and/or dissolved within the water. Suspended materials are substantially insoluble in water and dissolved materials are substantially soluble in water. Water is typically a solvent for dissolved materials and water-soluble material. Furthermore, water is typically not a solvent for insoluble materials and water-insoluble materials. The suspended materials have a particle size.

“Organic carbons” or “organic material” refer to any compound of carbon except such binary compounds as carbon oxides, the carbides, carbon disulfide, etc.; such ternary compounds as the metallic cyanides, metallic carbonyls, phosgene, carbonyl sulfide, etc.; and the metallic carbonates, such as alkali and alkaline earth metal carbonates. Exemplary organic carbons include humic acid, tannins, and tannic acid, polymeric materials, alcohols, carbonyls, carboxylic acids, oxalates, amino acids, hydrocarbons, and mixtures thereof. In some embodiments, the target material is an organic material as defined herein. An alcohol is any organic compound in which a hydroxyl functional group (—OH) is bound to a carbon atom, the carbon atom is usually connected to other carbon or hydrogen atoms. Examples of alcohols include acyclic alcohols, isopropyl alcohol, ethanol, methanol, pentanol, polyhydric alcohols, unsaturated aliphatic alcohols, and alicyclic alcohols, and the like. The carbonyl group is a functional group consisting of a carbonyl (RR′C═O) (in the form without limitation a ketone, aldehyde, carboxylic acid, ester, amide, acyl halide, acid ahydride, or combinations thereof). Examples of organic compounds containing a carbonyl group include aldehydes, ketones, esters, amides, enones, acyl halides, acid anhydrides, urea, and carbamates and derivatives thereof, and the derivatives of acyl chlorides chloroformates and phosgene, carbonate esters, thioesters, lactones, lactams, hydroxamates, and isocyanates. Preferably, the carbonyl group comprises a carboxylic acid group, which has the formula —C(═O)OH, usually written as —COOH or —CO₂H. Examples of organic compounds containing a carboxyl group include carboxylic acid (R—COOH) and salts and esters (or carboxylates) and other derivatives thereof. It can be appreciated that organic compounds include alcohols, carbonyls, and carboxylic acids, where one or more oxygens are, respectively, replaced with sulfur, selenium and/or tellurium.

As used herein, the term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

As used herein, “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The preceding is a simplified summary of the disclosure to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below.

### BRIEF DESCRIPTION OF THE DRAWINGS

The accompanying drawing, which is incorporated in and constitute a part of the specification, illustrates embodiments of the disclosure and together with the general description of the disclosure given above and the detailed description given below, serve to explain the principles of the disclosure.

FIG. 1 depicts various X-ray diffraction patterns as described in more detail in Detailed Description section;

FIG. 2 depicts a water handling system according to an embodiment;

FIG. 3 is a plot of loading capacity (mg/g) (vertical axis) versus arsenic concentration (g/L) (horizontal axis);

FIG. 4 is a plot of final arsenic concentration (mg/L) (vertical axis) versus molar ratio of cerium:arsenic (horizontal axis);

FIG. 5 is a plot of final arsenic concentration (mg/L) (vertical axis) versus molar ratio of cerium to arsenic (horizontal axis);

FIG. 6 is a series of XRD patterns for precipitates formed upon addition of Ce (III) or Ce (IV) solutions to sulfide-arsenite solutions and sulfate-arsenate solutions;

FIG. 7 is a plot of arsenic sequestered (micromoles) (vertical axis) and cerium added (micromoles) (horizontal axis);

FIG. 8 is a series of XRD patterns exhibiting the structural differences between gasparite (CeAsO₄) and the novel trigonal phase CeAsO₄.(H₂O)_{X};

FIG. 9 is a series of XRD patterns exhibiting the structural differences among trigonal CeAsO₄.(H₂O)_{X} (experimental), trigonal CeAsO₄.(H₂O)_{X} (simulated), and trigonal BiPO₄.(H₂O)_{0.67} (simulated);

FIG. 10A is photograph of Direct Blue 15 dye solution prior to addition of ceria;

FIG. 10B is a photograph of a filtrate of the Direct Blue 15 dye solution after the addition of ceria;

FIG. 11A is photograph of Acid Blue 25 dye solution prior to addition of ceria;

FIG. 11B is a photograph of a filtrate of the Acid Blue 25 dye solution after the addition of ceria;

FIG. 12A is photograph of Acid Blue 80 dye solution prior to addition of ceria;

FIG. 12B is a photograph of a filtrate of the Acid Blue 80 dye solution after the addition of ceria;

FIG. 13A is a photograph of ceria-containing Direct Blue 15 solution 2 minutes after adding ceria to the solution;

FIG. 13B is a photograph of ceria-containing Direct Blue 15 solution 10 minutes after adding ceria to the solution;

FIG. 14A is a photograph of ceria-containing Acid Blue 25 solution 2 minutes after adding ceria to the solution;

FIG. 14B is a photograph of ceria-containing Acid Blue 25 solution 10 minutes after adding ceria to the solution;

FIG. 15A is a photograph of ceria-containing Acid Blue 80 solution 2 minutes after adding ceria to the solution; and

FIG. 15B is a photograph of ceria-containing Acid Blue 80 solution 10 minutes after adding ceria to the solution;

FIG. 16 is a plot of arsenic capacity (mg As/g CeO₂) against various solution compositions;

FIG. 17 is a plot of arsenic (V) concentration (ppb) against bed volumes treated;

FIG. 18 depicts contaminate challenge tests for agglomerates prepared according to various embodiments;

FIG. 19 is a plot of loading capacity (As mg/CeO₂ g) against molar ratio cerium (III):arsenic;

FIG. 20 depicts a municipal drinking water handling system according to an embodiment;

FIG. 21 depicts a wastewater water handling system according to an embodiment; and

FIG. 22 depicts a water recirculation system according to an embodiment.

### DETAILED DESCRIPTION

### General Overview

The present disclosure is to particulate cerium, more specifically to particulate cerium formed by an in situ oxidative process. Preferably, particulate cerium (IV) is formed by in situ oxidation of a rare earth additive comprising at least some water-soluble cerium (III). The oxidization of cerium (III) to cerium (IV) preferably occurs without applying an electrochemical potential from an external source, such as applying an electrochemical potential from a battery, galvanostat, potentiostat or such. In some embodiments, the particulate cerium comprises nano-particulate cerium, preferably nano-particulate cerium (IV).

In accordance with some embodiments, the oxidization occurs by contacting cerium (III) with an oxidizing agent. The contacting of the oxidizing agent with the cerium (III) oxidizes at least some, if not most, of the cerium (III) to cerium (IV). Preferably, the cerium (IV) is in the form of particulate cerium (IV), more preferably in the form of nano-particulate cerium (IV). More specifically, the cerium (IV) preferably comprises one or more of cerium (IV) hydroxide, oxyhydroxide, hydrous oxyhydroxide, or cerium (IV) oxide in a nano-particulate form. It is believed that contacting of cerium (III) with the oxidizing agent removes an electron from the cerium (III) to form cerium (IV). Preferably, the cerium (III) comprises dissociated, dissolved cerium (III).

In accordance with some embodiments, the cerium (IV) is contacted with a target material. The target material is contained within a target material-containing stream. In some embodiments, the target material-containing stream may contain one or more target materials. Cerium (IV) is preferred for its ability to remove the target material(s) from the target material-containing stream. The contacting of the cerium (IV) with the one or more target materials removes at least some, if not most, of at least one of the target materials contained in the target material-containing stream. Typically, the target material is one of a deposit material, oxyanion, colorant, dye, dye carrier, ink, pigment, biological contaminant, chemical contaminant, physiologically active contaminant, or mixture thereof.

In some embodiments, the cerium (IV) is formed and contacted with the target material in the target material-containing stream. In other embodiments, the cerium (IV) is formed in first fluid prior to contacting the target material contained in the target material-containing stream.

### Rare Earth-Containing Additive

The rare earth-containing additive comprises a rare earth and/or rare earth-containing composition comprising at least some water-soluble cerium (III). The rare earth and/or rare earth-containing composition in the rare earth-containing additive can be rare earths in elemental, ionic or compounded forms. The rare earth and/or rare earth-containing composition can be contained in a fluid, such as water, or in the form of nanoparticles, particles larger than nanoparticles, agglomerates, or aggregates or combinations and/or mixtures thereof. The rare earth and/or rare earth-containing composition can be supported or unsupported. The rare earth and/or rare earth-containing composition can comprise one or more rare earths. The rare earths may be of the same or different valence and/or oxidation states and/or numbers. The rare earths can be a mixture of different rare earths, such as two or more of yttrium, scandium, cerium, lanthanum, praseodymium, and neodymium. The rare earth and/or rare earth-containing composition comprise at least some water-soluble cerium (III), typically in the form of water-soluble cerium (III) salt. Commonly, the rare earth-containing additive comprises more than about 1 wt. % of a water-soluble cerium (III) composition, more commonly more than about 5 wt. % of a water-soluble cerium (III) composition, even more commonly more than about 10 wt. % of a water-soluble cerium (III) composition, yet even more commonly more than about 20 wt. % of a water-soluble cerium (III) composition, still yet even more commonly more than about 30 wt. % of a water-soluble cerium (III) composition, or still yet even more commonly more than about 40 wt. % of a water-soluble cerium (III) composition.

In some embodiments, the water-soluble cerium (III) composition may comprise in addition to cerium one or more other rare earths. The rare earths other than cerium include yttrium, scandium, lanthanum, praseodymium, neodymium, samarium, europium, gadolinium, terbium, dysprosium, holmium, erbium, thulium, ytterbium, and lutetium. The other rare earths may and may not be water-soluble.

Non-limiting examples of suitable water-soluble rare earth compositions include rare earth chlorides, rare earth bromides, rare earth iodides, rare earth astatides, rare earth nitrates, rare earth sulfates, rare earth oxalates, rare earth perchlorates, rare earth carbonates, and mixtures thereof. In one formulation, the rare earth-containing additive includes water-soluble cerium (III) and lanthanum (III) compositions. In some applications, the water-soluble cerium composition preferably comprises cerium (III) chloride, CeCl₃.

In accordance with some embodiments, the rare earth-containing additive typically comprises more than about 50 wt. % of a water-soluble cerium (III) composition, more typically the rare earth-containing additive comprises more than about 60 wt. % of a water-soluble cerium (III) composition, even more typically the rare earth-containing additive comprises more than about 65 wt. % of a water-soluble cerium (III) composition, yet even more typically the rare earth-containing additive comprises more than about 70 wt. % of a water-soluble cerium (III) composition, still yet even more typically the rare earth-containing additive comprises more than about 75 wt. % of a water-soluble cerium (III) composition, still yet even more typically the rare earth-containing additive comprises more than about 80 wt. % of a water-soluble cerium (III) composition, still yet even more typically the rare earth-containing additive comprises more than about 85 wt. % of a water-soluble cerium (III) composition, still yet even more typically the rare earth-containing additive comprises more than about 90 wt. % of a water-soluble cerium (III) composition, still yet even more typically the rare earth-containing additive comprises more than about 95 wt. % of a water-soluble cerium (III) composition, still yet even more typically the rare earth-containing additive comprises more than about 98 wt. % of a water-soluble cerium (III) composition, still yet even more typically the rare earth-containing additive comprises more than about 99 wt. % of a water-soluble cerium (III) composition, or yet still eve more typically comprises about 100 wt. % of a water-soluble cerium (III) composition.

Commonly, the rare earth-containing composition comprises one or more rare earths. The rare earths comprising the rare earth-containing composition commonly have +3, +4, or a mixture of +3 and +4 oxidation states. More specifically, the rare earth-containing composition can comprise a mixture of rare earths. While not wanting to be limited by example, the rare earth-containing composition can comprise a first rare earth and a second rare earth. The first and second rare earths may have the same or differing atomic numbers. In some formulations, the first rare earth comprises cerium (III) and the second rare earth comprises a rare earth other than cerium (III). The rare earth other than cerium (III) can be one or more trivalent rare earths, cerium (IV), or any other rare other than trivalent cerium. For example, a mixture of rare earth-containing compositions can comprise a first rare earth having a +3 oxidation state and a second rare earth having a +4 oxidation state. In some embodiments, the first and second rare earths are the same and comprise cerium. More specifically, the first rare earth comprises cerium (III) and the second rare earth comprises cerium (IV). Preferably, the cerium is primarily in the form of a water-soluble cerium (III) salt, with the remaining cerium being present as cerium oxide, a substantially water insoluble cerium composition.

In some formulations, the water-soluble cerium-containing additive contains cerium (III) and one or more other trivalent rare earths (such as one or more of lanthanum, neodymium, praseodymium and samarium). The molar ratio of cerium (III) to the other trivalent rare earths is commonly at least about 1:1, more commonly at least about 10:1, more commonly at least about 15:1, more commonly at least about 20:1, more commonly at least about 25:1, more commonly at least about 30:1, more commonly at least about 35:1, more commonly at least about 40:1, more commonly at least about 45:1, and more commonly at least about 50:1.

In some formulations, the water-soluble cerium-containing additive contains cerium (III) and one or more of lanthanum, neodymium, praseodymium and samarium. The water-soluble rare earth-containing additive commonly includes at least about 0.01 wt. % of one or more of lanthanum, neodymium, praseodymium and samarium. The water-soluble rare earth-containing additive commonly has on a dry basis no more than about 10 wt. % La, more commonly no more than about 9 wt. % La, even more commonly no more than about 8 wt. % La, even more commonly no more than about 7 wt. % La, even more commonly no more than about 6 wt. % La, even more commonly no more than about 5 wt. % La, even more commonly no more than about 4 wt. % La, even more commonly no more than about 3 wt. % La, even more commonly no more than about 2 wt. % La, even more commonly no more than about 1 wt. % La, even more commonly no more than about 0.5 wt. % La, and even more commonly no more than about 0.1 wt. % La. The water-soluble rare earth-containing additive commonly has on a dry basis no more than about Nd, more commonly no more than about 7 wt. % Nd, even more commonly no more than about 6 wt. % Nd, even more commonly no more than about 5 wt. % Nd, even more commonly no more than about 4 wt. % Nd, even more commonly no more than about 3 wt. % Nd, even more commonly no more than about 2 wt. % Nd, even more commonly no more than about 1 wt. % Nd, even more commonly no more than about 0.5 wt. % Nd, and even more commonly no more than about 0.1 wt. % Nd. The water-soluble rare earth-containing additive commonly has on a dry basis no more than about 5 wt. % Pr, more commonly no more than about 4 wt. % even more commonly no more than about 3 wt. % Pr, even more commonly no more than about 2.5 wt. % Pr, even more commonly no more than about 2.0 wt. % Pr, even more commonly no more than about 1.5 wt. % Pr, even more commonly no more than about 1.0 wt. % Pr, even more commonly no more than about 0.5 wt. % Pr, even more commonly no more than about 0.4 wt. % Pr, even more commonly no more than about 0.3 wt. % Pr, even more commonly no more than about 0.2 wt. % Pr, and even more commonly no more than about 0.1 wt. % Pr. The water-soluble rare earth-containing additive commonly has on a dry basis no more than about 3 wt. % Sm, more commonly no more than about 2.5 wt. % Sm, even more commonly no more than about 2.0 wt. % Sm, even more commonly no more than about 1.5 wt. % Sm, even more commonly no more than about 1.0 wt. % Sm, even more commonly no more than about 0.5 wt. % Sm, even more commonly no more than about 0.4 wt. % Sm, even more commonly no more than about 0.3 wt. % Sm, even more commonly no more than about 0.2 wt. % Sm, even more commonly no more than about 0.1 wt. % Sm, even more commonly no more than about 0.05 wt. Sm, and even more commonly no more than about 0.01 wt. % Sm.

In some embodiments, the rare earth-containing additive comprises one or more nitrogen-containing materials. The one or more nitrogen-containing materials, commonly, comprise one or more of ammonia, an ammonium-containing composition, a primary amine, a secondary amine, a tertiary amine, an amide, a cyclic amine, a cyclic amide, a polycyclic amine, a polycyclic amide, and combinations thereof. The nitrogen-containing materials are typically less than about 1 ppm, less than about 5 ppm, less than about 10 ppm, less than about 25 ppm, less than about 50 ppm, less about 100 ppm, less than about 200 ppm, less than about 500 ppm, less than about 750 ppm or less than about 1000 ppm of the water-soluble rare earth-containing additive. Commonly, the rare earth-containing additive comprises a water-soluble cerium (III) and/or lanthanum (III) composition. More commonly, the rare earth-containing additive comprises cerium (III) chloride. The rare earth-containing additive is typically dissolved in a liquid. The liquid is the rare earth-containing additive is dissolved in is preferably water.

In one formulation, the rare earth-containing additive consists essentially of a water-soluble cerium (III) salt, such as a cerium (III) chloride, cerium (III) bromide, cerium (III) iodide, cerium (III) astatide, cerium perhalogenates, cerium (III) carbonate, cerium (III) nitrate, cerium (III) sulfate, cerium (III) oxalate and mixtures thereof. The rare earth in this formulation commonly is primarily cerium (III), more commonly at least about 75 mole % of the rare earth content of the rare earth-containing additive is cerium (III), that is no more than about 25 mole % of the rare earth content of the rare earth-containing additive comprises rare earths other than cerium (III). Even more commonly, the rare earth in this formulation commonly is primarily at least about 80 mole % cerium (III), yet even more commonly at least about 85 mole % cerium (III), still yet even more commonly at least about 90 mole % cerium (III), and yet still even more commonly at least about 95 mole % cerium (III).

For rare earth-containing additives having a mixture of +3 and +4 oxidations states commonly at least some of the rare earths have a +3 oxidation state, more commonly at least most of the rare earths have a +3 oxidation state, more commonly at least about 75 wt. % of the rare earths have a +3 oxidation state, even more commonly at least about 90 wt. % of the rare earths have a +3 oxidation state, or yet even more commonly at least about 98 wt. % of the rare earths have a +3 oxidation state. The rare earth-containing additive commonly includes at least about 1 ppm, even more commonly at least about 10 ppm and yet even more commonly at least about 100 ppm cerium (IV) oxide. While in some embodiments, the rare earth-containing additive includes at least about 0.0001 wt. % cerium (IV), commonly at least about 0.001 wt. % cerium (IV) and even more commonly at least about 0.01 wt. % cerium (IV) calculated as cerium oxide. Moreover, in some embodiments, the rare earth-containing additive commonly has at least about 250,000 pm cerium (III), more commonly at least about 100,000 ppm cerium (III) and even more commonly at least about 20,000 ppm cerium (III).

In another formulation, the rare earth-containing additive contains at least some water-soluble cerium (IV) salt, such as cerium (IV) sulfate (e.g., ceric ammonium sulfate and ceric sulfate), cerium (IV) nitrate (e.g., ceric ammonium nitrate), cerium (IV) oxyhydroxide, cerium (IV) hydrous oxide and mixtures thereof. In this formulation, the cerium (IV) content, based on the total rare content of the rare earth-containing additive, is commonly is no more than about 75 mole % cerium (IV), more commonly no more than about 50 mole % cerium (IV), even more commonly no more than about 40 mole % cerium (IV), yet even more commonly no more than about 30 mole % cerium (IV), still yet even more commonly no more than about 25 mole % cerium (IV), still yet even more commonly no more than about 20 mole % cerium (IV), still yet even more commonly no more than about 15 mole % cerium (IV), still yet even more commonly no more than about 10 mole % cerium (IV), still yet even more commonly no more than about 5 mole % cerium (IV), or still yet even more commonly no more than about 2 mole % cerium (IV). It can be appreciated that, a rare earth-containing additive having only cerium (IV) as the rare earth would have 100 mole % cerium (IV) and a rare earth-containing additive lacking cerium (IV) would have 0 mole % cerium (IV).

In some embodiments, the rare earth-containing additive can in the form of one or more of: an aqueous solution containing substantially dissociated, dissolved forms of the rare earths and/or rare earth-containing compositions; free flowing granules, powder, particles, and/or particulates of rare earths and/or rare earth-containing compositions containing at least some water-soluble cerium (III); free flowing aggregated granules, powder, particles, and/or particulates of rare earths and/or rare earth-containing compositions substantially free of a binder and containing at least some water-soluble cerium (III); free flowing agglomerated granules, powder, particles, and/or particulates comprising a binder and rare earths and/or rare earth-containing compositions one or both of in an aggregated and non-aggregated form and containing at least some water-soluble cerium (III); rare earths and/or rare earth-containing compositions containing at least some water-soluble cerium (III) and supported on substrate; and combinations thereof.

Regarding rare earths and/or rare earth-containing compositions supported on a substrate suitable substrates can include porous and fluid permeable solids having a desired shape and physical dimensions. The substrate, for example, can be a sintered ceramic, sintered micro-porous carbon, glass fiber, cellulosic fiber, alumina, gamma-alumina, activated alumina, acidified alumina, a metal oxide containing labile anions, crystalline alumino-silicate such as a zeolite, amorphous silica-alumina, ion exchange resin, clay, ferric sulfate, porous ceramic, and the like. Such substrates can be in the form of mesh, such as screens, tubes, honeycomb structures, monoliths, and blocks of various shapes, including cylinders and toroids. The structure of the substrate will vary depending on the application. Suitable structural forms of the substrate can include a woven substrate, non-woven substrate, porous membrane, filter, fabric, textile, or other fluid permeable structure. The rare earth-containing additive can be incorporated into or coated onto a filter block or monolith for use as a filter, such as a cross-flow type filter. The rare earth and/or rare earth-containing additive can be in the form of particles coated on to or incorporated in the substrate. In some configurations, the rare earth and/or rare earth-containing additive can be ionically substituted for cations in the substrate. Typically, the rare earth-coated substrate comprises_at least about 0.1% by weight, more typically 1% by weight, more typically at least about 5% by weight, more typically at least about 10% by weight, more typically at least about 15% by weight, more typically at least about 20% by weight, more typically at least about 25% by weight, more typically at least about 30% by weight, more typically at least about 35% by weight, more typically at least about 40% by weight, more typically at least about 45% by weight, and more typically at least about 50% by weight rare earth and/or rare earth-containing composition. Typically, the rare earth-coated substrate includes no more than about 95% by weight, more typically no more than about 90% by weight, more typically no more than about 85% by weight, more typically no more than about 80% by weight, more typically no more than about 75% by weight, more typically no more than about 70% by weight, and even more typically no more than about 65% by weight rare earth and/or rare earth-containing composition.

In some formulations, the rare earth-containing additive includes a rare earth-containing composition supported on, coated on, or incorporated into a substrate, preferably the rare earth-containing composition is in the form of particulates. The rare earth-containing particulates can, for example, be supported or coated on the substrate with or without a binder. The binder may be any suitable binder, such as those set forth herein.

Further regarding formulations comprising the rare earth-containing additive comprising rare earth-containing granules, powder, particles, and/or particulates agglomerated and/or aggregated together with or without a binder, such formulations commonly have a mean, median, or P₉₀ particle size of at least about 1 μm, more commonly at least about 5 μm, more commonly at least about 10 μm, still more commonly at least about 25 μm. In some formulations, the rare earth-containing agglomerates or aggregates have a mean, median, or P₉₀ particle size distribution from about 100 to about 5,000 microns; a mean, median, or P₉₀ particle size distribution from about 200 to about 2,500 microns; a mean, median, or P₉₀ particle size distribution from about 250 to about 2,500 microns; or a mean, median, or P₉₀ particle size distribution from about 300 to about 500 microns. In other formulations, the agglomerates and/or aggregates can have a mean, median, or P₉₀ particle size distribution of at least about 100 nm, specifically at least about 250 nm, more specifically at least about 500 nm, even more specifically at least about 1 mm and yet even more specifically at least about 0.5 nm, the mean, median, or P₉₀ particle size distribution of the agglomerates and/or aggregates can be up to about 1 micron or more. Moreover, the rare earth-containing particulates, individually and/or in the form of agglomerates and/or aggregates, can have in some cases a surface area of at least about 5 m²/g, in other cases at least about 10 m²/g, in other cases at least about 70 m²/g, in yet other cases at least about 85 m²/g, in still yet other cases at least about 100 m²/g, in still yet other cases at least about 115 m²/g, in still yet other cases at least about 125 m²/g, in still yet other cases at least about 150 m²/g, in still yet other cases at least 300 m²/g, and in still yet other cases at least about 400 m²/g. In some configurations, the rare earth-containing particulates, individually and/or in the form of agglomerates or aggregates commonly can have a surface area from about 50 to about 500 m²/g, or more commonly from about 110 to about 250 m²/g. Commonly, the rare earth-containing agglomerate includes more than 10.01 wt. %, more commonly more than about 85 wt. %, even more commonly more than about 90 wt. %, yet even more commonly more than about 92 wt. % and still yet even more commonly from about 95 to about 96.5 wt. % rare earth-containing particulates, with the balance being primarily the binder. Stated another way, the binder can be less than about 15% by weight of the agglomerate, in some cases less than about 10% by weight, in still other cases less than about 8% by weight, in still other cases less than about 5% by weight, and in still other cases less than about 3.5% by weight of the agglomerate. In some formulations, the rare earth-containing particulates are in the form of powder and have aggregated nano-crystalline domains. The binder can include one or more polymers selected from the group consisting of thermosetting polymers, thermoplastic polymers, elastomeric polymers, cellulosic polymers and glasses. Preferably, the binder comprises a fluorocarbon-containing polymer and/or an acrylic-polymer.

### Oxidizing Agents

The oxidizing agent has substantially enough oxidizing potential to oxidize at least some cerium (III) to cerium (IV). The oxidizing agent may comprise a chemical oxidizing agent, an oxidation process, or combination of both.

A chemical oxidizing agent comprises a chemical composition in elemental or compounded form. The chemical oxidizing agent accepts an electron from cerium (III) to form cerium (IV). In the accepting of the electron, the oxidizing agent is reduced to form a reduced form of the oxidizing agent. Non-limiting examples of preferred chemical oxidizing agents are chlorine, chloroamines, chlorine dioxide, hypochlorites, trihalomethane, haloacetic acid, ozone, hydrogen peroxide, peroxygen compounds, hypobromous acid, bromoamines, hypobromite, hypochlorous acid, isocyanurates, tricholoro-s-triazinetriones, hydantoins, bromochloro-dimethyldantoins, 1-bromo-3-chloro-5,5-dimethyldantoin, 1,3-dichloro-5,5-dimethyldantoin, sulfur dioxide, bisulfates, and combinations thereof. It is further believed that in some configurations one or more the following chemical compositions may oxidize cerium (III) to cerium (IV) bromine, BrCl, permanganates, phenols, alcohols, oxyanions, arsenites, chromates, trichloroisocyanuric acid, and surfactants. The chemical oxidizing agent may further be referred to as an “oxidant” or an “oxidizer”. In some embodiments, the oxidizing agent can comprise a target material.

The chemical oxidizing contacted with the cerium (III) commonly has a concentration of more than about 1 ppm, more commonly of more than about 10 ppm, even more commonly of more than about 100 ppm, yet even more commonly of more than about 1,000 ppm, still yet even more commonly of more than about 10,000 ppm, still yet even more commonly of more than about 100,000 ppm, still yet even more commonly of more than about 1,000,000 ppm, still yet even more commonly of more than about 5,000,000 ppm, or still yet even more commonly of more than about 10,000,000 ppm.

The reduced form of the chemical oxidizing is typically present at a molar amount of no less than about 0.2 of the molar amount of the rare earth having the +4 oxidation state, more typically at a molar amount of no less than about 0.4 of the molar amount of the rare earth having the +4 oxidation state, even more typically at a molar amount of no less than about 0.6 of the molar amount of the rare earth having the +4 oxidation state, yet even more typically at a molar amount of no less than about 0.8 of the molar amount of the rare earth having the +4 oxidation state, still yet even more typically at a molar amount of no less than about 0.9 of the molar amount of the rare earth having the +4 oxidation state, still yet even more typically at a molar amount of no less than about 1.0 of the molar amount of the rare earth having the +4 oxidation state, still yet even more typically at a molar amount of no less than about 1.1 of the molar amount of the rare earth having the +4 oxidation state, still yet even more typically at a molar amount of no less than about 1.2 of the molar amount of the rare earth having the +4 oxidation state, still yet even more typically at a molar amount of no less than about 1.3 of the molar amount of the rare earth having the +4 oxidation state, still yet even more typically at a molar amount of no less than about 1.4 of the molar amount of the rare earth having the +4 oxidation state, still yet even more typically at a molar amount of no less than about 1.5 of the molar amount of the rare earth having the +4 oxidation state, still yet even more typically at a molar amount of no less than about 1.6 of the molar amount of the rare earth having the +4 oxidation state, still yet even more typically at a molar amount of no less than about 1.7 of the molar amount of the rare earth having the +4 oxidation state, still yet even more typically at a molar amount of no less than about 1.8 of the molar amount of the rare earth having the +4 oxidation state, still yet even more typically at a molar amount of no less than about 1.9 of the molar amount of the rare earth having the +4 oxidation state, or still yet even more typically at a molar amount of no less than about 2.0 of the molar amount of the rare earth having the +4 oxidation state.

In some embodiments, the chemical oxidizing agent can comprise one or more target materials. That is, one or more of the target materials can oxidize cerium (III) to cerium (IV) when contacted with the cerium (III). Furthermore, the contacting of the target material oxidizing agent with cerium (III) forms cerium (IV) and reduced form of the target material. The reduced form of the target material can be removed and/or sorbed by one or both of the rare earth additive and/or cerium (IV). Furthermore, in some embodiments the oxidized form of the rare earth and/or rare earth containing additive can oxidize a target material to form an oxidized form of the target material and a reduced form of the rare earth. For example, cerium (IV) can oxidize a target material to form an oxidized target material and reduced form of cerium (IV), that is, cerium (III) The cerium (III) or other rare earths can be contacted with the reduced form of the target material and/or with another target material to remove and/or sorb the reduced form the target material and/or the other target material. The other rare earths can be cerium (IV) or any lanthanoid other than cerium.

An oxidation process comprises a physical process that alone or in combination with a chemical oxidizing agent removes and/or facilitates the removal an electron from cerium (III) to form cerium (IV). Non-limiting examples of oxidation processes are electromagnetic energy, ultra violet light, thermal energy, ultrasonic energy, and gamma rays. While not wanting to be limited by theory, it is believed that the oxidation process can cause an electron transition in cerium (III) from a ground state level to an excited state level, thereby lowering the energy needed to remove the electron from cerium (III) to form cerium (IV). The excited state level of the electron in cerium (III) is a higher energy state of the electron than the ground state level. In some configurations, the higher energy state of the electron is sufficiently high enough that the electron is substantially removed from cerium (III), and cerium (IV) is formed. In other configurations, the electron is not removed by the oxidation process, but the electron in the excited state level is easily removed when cerium (III) in this excited state is contacted with a chemical oxidizing agent. It can be appreciated that, the electron in the excited state level of cerium (III) can be removed by chemical oxidizing agents having less oxidizing potential than oxidizing agents needed to remove an electron from the ground state level of cerium (III). In some instances, the excited state cerium (III) may be oxidized in combination with the chemical oxidizing agents indicated above, such as, but not limited to bromine, BrCl, permanganates, oxyanions, arsenates, chromates, phenols, alcohols, trichloroisocyanuric acid, and surfactants. Moreover, in other instances, the excited state cerium (III) may be oxidized in combination with a chemical oxidizing agent other than those indicated.

### Particulate Cerium (IV)

In accordance with some embodiments, contacting cerium (III) with an oxidizing agent forms at least some cerium (IV). Preferably, the contacting of the cerium (III) with the oxidizing agent occurs in fluid. More preferably, the contacting occurs in liquid, even more preferably in an aqueous solution. Preferably, the cerium (IV) formed is in the form particulates suspended and/or dispersed in the fluid.

The cerium (III) contacted with the oxidizing agent can be present at any concentration. Typically the cerium (III) concentration is greater than about 1×10⁻⁵ M, more typically greater than about 1×10⁻⁴ M, even more typically greater than about 1×10⁻³ M, yet even more typically greater than about 1×10⁻² M, still yet even more typically greater than about 1×10⁻¹ M, or still yet even more typically greater than about 1.0 M cerium (III).

In most embodiments, the water-soluble cerium (III), preferably in a dissociated, dissolved state in the water, is contacted with an oxidizing agent to form cerium (IV). The cerium (IV) preferably comprises a substantially insoluble form of cerium (IV). The oxidizing agent transforms a substantially water-soluble form of cerium, cerium (III), into a substantially water-insoluble form of cerium, cerium (IV). Typically, the cerium (IV) comprises one or more of cerium (IV) oxide, cerium (IV) hydroxide, cerium (IV) oxyhydroxy, cerium (IV) hydrous oxide, cerium (IV) hydrous oxyhydroxy, CeO₂, and/or Ce(IV)(O)_{w}(OH)ₓ(OH)_{y}.zH₂O where w, x, y and z can be zero or a positive, real number. Furthermore, the cerium (IV) may be in the form of a colloid, suspension, or slurry of particulates. The cerium (IV) particulates commonly can have a mean, median and/or P₉₀ particle size of less than about 1 nanometer, more commonly a mean, median and/or P₉₀ particle size from about 1 nanometer to about 1,000 nanometers, even more commonly a mean, median and/or P₉₀ particle size from about 1 micron to about 1,000 microns, or yet even more commonly a mean, median and/or P₉₀ particle size of at least about 1,000 microns. Preferably, the cerium (IV) particulates have a mean, median and/or P₉₀ particle size from about 0.1 to about 1,000 nm, more preferably from about 0.1 to about 500 nm. Even more preferably, the cerium (IV) particulates have a mean, median and/or P₉₀ particle size from about 0.2 to about 100 nm.

In some embodiments, the cerium (IV) particulates may have a mean and/or median surface area of at least about 1 m²/g, preferably a mean and/or median surface area of at least about 70 m²/g. In other embodiments, the cerium (IV) particulates may preferably have a mean and/or median surface area from about 25 m²/g to about 500 m²/g and more preferably, a mean and/or median surface area of about 100 to about 250 m²/g. In some embodiments, the cerium (IV) particulates may be in the form of one or more of a granule, crystal, crystallite, and particle.

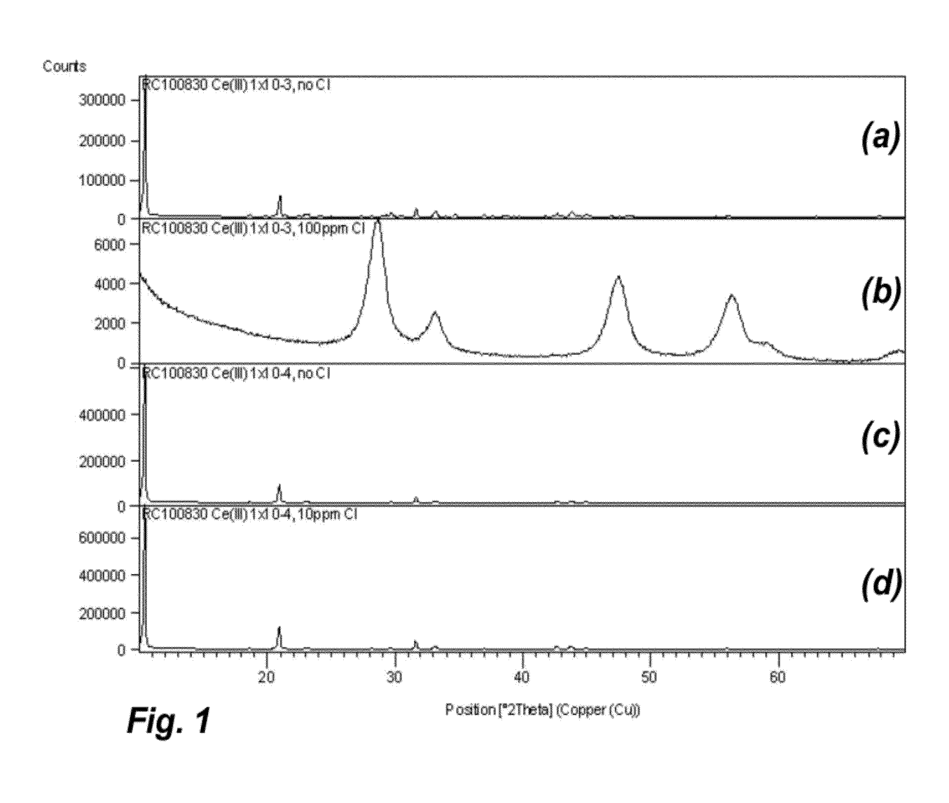

It is believed that the cerium (IV) particulates comprise crystals or crystallites, as evidenced by the x-ray diffraction pattern depicted in FIG. 1. Moreover, it is believed, the cerium (IV) particulate crystals and/or crystallites comprise one or more of nano-crystals, nano-crystallites and/or nanocrystalline domains.

The weight percent (wt. %) cerium (IV) content based on the total rare earth content of the cerium (IV) particulates typically is at least about 50 wt. % cerium (IV), more typically at least about 60 wt. % cerium (IV), even more typically at least about 70 wt. % cerium (IV), yet even more typically at least about 75 wt. % cerium (IV), still yet even more typically at least about 80 wt. % cerium (IV), still yet even more typically at least about 85 wt. % cerium (IV), still yet even more typically at least about 90 wt. % cerium (IV), still yet even more typically at least about 95 wt. % cerium (IV), and even more typically at least about 99 wt. % cerium (IV). Preferably, the cerium (IV) particulate is substantially devoid of rare earths other than cerium (IV). More preferably, the weight percent (wt. %) cerium (IV) content based on the total rare earth content of the cerium (IV) particulates is about 100 wt. % cerium (IV) and comprises one or more of cerium (IV) oxide, cerium (IV) hydroxide, cerium (IV) oxyhydroxy, cerium (IV) hydrous oxide, cerium (IV) hydrous oxyhydroxy, CeO₂, and/or Ce(IV) (O)_{w}(OH)ₓ(OH)_{y}.zH₂O, where w, x, y and can be zero or a positive, real number.

In accordance with some embodiments, having cerium (IV) provides for an opportunity to take advantage of sorption and oxidation/reduction chemistries of cerium (IV), such as, the strong interaction of cerium (IV) to sorb target materials such as deposit materials, oxyanions, colorants, dyes, dye carriers, inks, pigments, biological contaminants, chemical contaminants, physiologically active contaminants, and mixtures thereof. The sorption of the target material one or more of kills, deactivates, detoxifies, and/or substantially removes the target material from a target material-containing stream. Furthermore, forming the cerium (IV) from a cerium (III) solution provides for the opportunity to take advantage of one or both of cerium (III) solution chemistry and of cerium (IV) chemistries remove target materials. The cerium (IV) chemistries are the oxidation/reduction chemistry of cerium (IV) and/or the substantially insoluble nature of the cerium (IV) particulates. Furthermore, forming the cerium (IV) from a rare earth-containing additive containing rare earths other than cerium (III) and (IV) provides for an opportunity to take advantage of the interactions of other rare earths (that is, other than cerium (III) and/or cerium (IV)) with the target materials.

In some embodiments, having a rare earth-containing additive comprising +3 and +4 rare earths is advantageous. More specifically, having a cerium-containing additive comprising cerium (+3) and cerium (+4) is advantageous. For example, having solution phase cerium (+3) provides for an opportunity to take advantage of cerium (+3) solution phase sorption and/or precipitation chemistries, such as, but not limited to, the formation of insoluble cerium (+3) compositions with oxyanions. The strong interaction of cerium +3 with arsenate is an example of the formation of a substantially insoluble cerium (+3) oxyanion composition. Furthermore, having a cerium (+4) present provides for an opportunity to take advantage of sorption and oxidation/reduction chemistries of cerium (+4), such as, the strong interaction of cerium (+4) to form substantially insoluble target material-laden cerium (IV) compositions. A non-limiting example of such a substantially target material-laden cerium (IV) composition is cerium (IV) arsenite. Cerium (III) and cerium (IV), for example, can have dramatically differing capacities and/or abilities to kill, detoxify, and/or remove target materials from a target material-containing stream. Although cerium (III) and cerium (IV) both can remove phosphates, cerium (IV), and cerium (IV) oxide in particular, is generally more efficacious than cerium (III) in removing phosphate and aresenite than cerium (III). For example, cerium (IV) oxide, but not cerium (III), can remove arsenite, and, though both cerium (IV) oxide and cerium (III) can remove arsenate, cerium (III) appears to hold arsenate more tightly than cerium (IV) oxide.

### Target Materials

Examples of target materials include without limitation deposit materials, oxyanions, colorants, dyes, dye carriers, inks, pigments, biological contaminants, chemical contaminants, physiologically active contaminants, and mixtures thereof. How such target materials came to be present in the target material-containing stream, either through natural occurrence or through intentional or unintentional contamination, is non-limiting of the disclosure.

Deposit materials can include materials associated with a water handling system. Deposit materials include one or both a scale adhered to one or components of the water handling system and a material that has a tendency to deposit from water and is in the form of a suspended or dissolved state in the water. In other words, the deposit material can be in the form of a scale adhered to one or more components of the water handling system, a solid suspended in the water continuous phase, ions in a substantially dissociated, dissolved state in water, or a combination thereof. Furthermore, the deposit material may be an inorganic, mineral, organic, biological deposit materials, or a combination thereof. The biological deposit materials include, without limitation, bacteria, algae, fungi, molds, viruses, and other microbes. Non-limiting examples of inorganic, organic and mineral deposit materials are arsenates, arsenites, sulfates, carbonates, oxalates, silicates, phosphates, barium hydrogen phosphate (BaHPO₄), barium pyrophosphate (Ba₂P₂O₇), bismuth phosphate (BiPO₄), cadmium phosphate (Cd₃(PO₄)₂), mono-calcium phosphate (Ca(H₂PO₄)₂), di-calcium phosphate (CaHPO₄), calcium phosphate (Ca₃(PO₄)₂), lead hydrogen phosphate (PbHPO₄), lithium phosphate (Li₃PO₄), magnesium phosphate (Mg₃(PO₄H, nickel phosphate (NiP₂O₇), thallium phosphate (Tl₃PO₄), barium arsenate (Ba₃(ASO₄)₂), bismuth arsenate (BiAsO₄), cadmium arsenate (Cd₃(AsO₄)₂), calcium arsenate (Ca₃(AsO₄)₂), ferric arsenate (FeAsO₄), struvite (NH₄MgPO₄) and combinations thereof. Furthermore, arsenite deposit material can comprise H₂AsO₃¹⁻, HAsO₃²⁻ and AsO₃³⁻ anions in the solution phase and/or associate with at least one of barium, bismuth, cadmium, calcium, iron, cobalt, copper, silver, strontium, lead, mercury, nickel, beryllium, thallium, zinc, magnesium, aluminum and manganese. Arsenate deposit materials can comprise the H₂AsO₄¹⁻, HAsO₄²⁻, AsO₄³⁻ anions in the solution phase and/or associated with at least one of barium, bismuth, cadmium, calcium, iron, cobalt, copper, silver, strontium, zinc, lead, mercury, nickel, beryllium, thallium, magnesium, aluminum and manganese. Sulfate deposit material can comprise HSO₄¹⁻ and/or SO₄²⁻ anions in the solution phase and/or associated with at least one of barium, bismuth, cadmium, calcium, iron, cobalt, copper, silver, strontium, zinc, lead, mercury, nickel, beryllium, thallium, magnesium, aluminum and manganese. Carbonate deposit material can comprise HCO₃¹⁻ and/or (COO)₂²⁻ anions in the solution phase and/or associated with at least one of barium, bismuth, cadmium, calcium, iron, cobalt, copper, silver, strontium, zinc, lead, mercury, nickel, beryllium, thallium, magnesium, aluminum and manganese, Oxalate deposit material can comprise H(COO)₂¹⁻ and/or (COO)₂²⁻ anions in the solution phase and/or associated with at least one of barium, bismuth, cadmium, calcium, iron, cobalt, copper, silver, strontium, lead, mercury, nickel, beryllium, thallium, zinc, magnesium, aluminum and manganese. Silicate deposit material can comprise H₃SiO₄¹⁻, H₂SiO₄²⁻, H₂SO₄³⁻, SiO₄⁴⁻, Si₂O₇⁶⁻, SiₙO₃ₙ²ⁿ⁻, Si₄nO₁₁ₙ⁶ⁿ⁻, and Si₂ₙO₅ₙ²ⁿ⁻ anions, where n is a positive real number, in solution phase and/or as one of serpentine, acmite, gyrolite, gehlenite, silicate, quartz, critobalite, pectrolite, xonotilite, aluminosilicates, analcite, cancrinite, noelite. Phosphate deposit material can comprise H₂PO₄¹, HPO₄⁻ and PO₄³⁻ anions their analogues in solution phase and/or as one of struvite and hydroxyapatite. Furthermore, a phosphate deposit material can refer to H₂PO₄¹⁻, HPO₄²⁻, PO₄³⁻ (phosphates), P₃O₁₀⁵ (triphosphate), PₙO₃ₙ⁽ⁿ⁺²⁻⁾ (polyphosphate), P₃O₉³⁻ (cyclic trimethaphosphate), H₂PO₂⁻ (hypophosphite), one or more of their soluble forms, insoluble forms, acids, or combinations thereof. It can be appreciate that in some embodiments, the silicate and/or phosphate anions can be associated with at least one of barium, bismuth, cadmium, calcium, iron, cobalt, copper, silver, strontium, lead, mercury, nickel, beryllium, thallium, zinc, magnesium, aluminum and manganese. Struvite is a non-limiting example of a deposit material. Furthermore, with regards to the non-limiting example of struvite, the terms deposit and deposit material refers to one or more of a struvite (NH₄MgPO₄) scale adhered to a component of the water handling system, struvite particulates suspended in the water, and ammonium (NH₄⁺), magnesium (Mg²⁺) and phosphate (PO₄³⁻) in the dissolved state within water.

Examples of oxyanions include without limitation chemical compounds with the generic formula H_{w}AₓO_{y}^{z-}, where A represents a chemical element other than oxygen, O represents the element oxygen and w, x, y and z represent real numbers, and w and/or z may be zero. In the embodiments having oxyanions as a target material, “A” represents metal, metalloid, and/or non-metal elements. Preferably, the oxyanion includes oxyanions of elements having an atomic number of 6, 7, 13 to 17, 22 to 25, 31 to 35, 40 to 42, 44, 45, 49 to 53, 72 to 75, 77, 78, 82, 83, 85 and 92. These elements include carbon, nitrogen, aluminum, silicon, phosphorous, sulfur, chlorine, titanium, vanadium, chromium, manganese, arsenic, selenium, bromine, gallium, germanium, zirconium, niobium, molybdenum, ruthenium, rhodium, indium, tin, iodine, antimony, tellurium, hafnium, tantalum, tungsten, rhenium, iridium, platinum, lead, bismuth, astatine, and uranium. Examples for metal-based oxyanions include chromate, tungstate, molybdate, aluminates, zirconate, etc. Examples of metalloid-based oxyanions include arsenate, arsenite, antimonate, germanate, silicate, etc. Examples of non-metal-based oxyanions include phosphate, selemate, sulfate, etc. Examples of arsenic oxyananion include arsenates and arsenites. Non-limiting examples of arsenates include H₂AsO₄¹⁻, HAsO₄²⁻, and AsO₄³⁻ and non-limiting examples of arsenites H₂AsO₃¹⁻, HAsO₃²⁻, and AsO₃³⁻. Non-limiting examples of sulfates includes HSO₄⁻ and SO₄²⁻. Examples of sulfites include without limitation, HSO₃⁻ and SO₃²⁻. Examples of carbonates include without limitation HCO₃ and CO₃. Non-limiting examples of oxalates include H(COO)₂¹⁻ and (COO)₂²⁻. Silicates include without limitation H₃SiO₄¹⁻, H₂SiO₄²⁻, HSiO₄³⁻, SiO₄⁴⁻ Si₂O₇⁶⁻, SiₙO₃ₙ²ⁿ⁻, Si₄nO₁₁ₙ⁶ⁿ⁻, and Si₂ₙO₅ₙ²ⁿ⁻, where n is a positive real number. Furthermore, oxyanions of phosphorous include oxyanions formed from a PO₄ (phosphate) structural unit alone or linked together by sharing oxygen atoms to form a linear chain or cyclic ring structure, such as, H₂PO₄¹⁻, HPO₄²⁻, PO₄³⁻ (phosphates), P₃O₁₀⁵⁻ (triphosphate), PₙO₃ₙ⁽ⁿ⁺²⁾⁻ (polyphosphate), P₃O₉³⁻ (cyclic trimethaphosphate), trimetaphosphate, hexametaphosphate, HPO₃²⁻ (phosphate), H₂P₂O₅²⁻ (pyrophosphites), H₂PO₂ (hypophosphite), adenosine diphosphoric acid (ADM), guanosine 5′-diphosphate 3′-dipphosphate (ppGpp), phosphate esters and amides (such as, P(═O)(OR)₃, phosphatidylcholine, thiophosphyoryl (P(═S)(OR)₃), malation, cyclophosphamide, triphyenylphosphate and dithiophosphate), phosphoric and phosphinic acids and esters (such as, phosphonates (RP(═O)(OR′)₂), glyphostes, bisphosphates, and phosphinates (R₂P(═O)(OR′)), phosphine oxides and related P—N compounds (such as phosphine oxides (R₃P═O), imides (R₃PNR′)), chalcogenides (such as, R₃PE, where E=S, Se, or Te), phosphonium salts and phosphoranes (such as, PR₄⁺, and ylides), phosphites (such as, P(OR)₃), phosphorites (such as, P(OR)₂R′), phosphinites (such as, P(OR)R′₂), phosphines ((such as, PH₃), including one or more of their salts, acids, esters, anionic, and organophosphorus forms and mixtures thereof.

Regarding target materials comprising colorants and inks, a colorant comprises one or both of a pigment and a dye, while inks are colorants in a liquid or paste form.

In some embodiments, the target material comprises a dye. The dye is a colorant composed of groups of atoms called chromophores and auxchromes. Typically, dyes are classified according to chemical structure, usage, or application method. The chemical structure classification of dyes, for example, typically uses terms such as azo dyes (e.g., monoazo, disazo, trisazo, polyazo, hydroxyazo, carboxyazo, carbocyclic azo, heterocyclic azo (e.g., indoles, pyrazolones, and pyridones), azophenol, aminoazo, and metalized (e.g., copper (II), chromium (III), and cobalt (III)) azo dyes, and mixtures thereof), anthraquinone (e.g., tetra-substituted, disubstituted, trisubstituted and momosubstitued, anthroaquinone dyes (e.g., quinolines), premetallized anthraquinone dyes (including polycyclic quinones), and mixtures thereof), benzodifuranone dyes, polycyclic aromatic carbonyl dyes, indigoid dyes, polymethine dyes (e.g., azacarobocyanine, diazacarbocyanine, cyanine, hemicyanine, and diazahemicyanine dyes, triazolium, benothiazolium, and mixtures thereof), styryl dyes, (e.g., dicyanovinyl, tricyanovinyl, tetracyanoctylene dyes) diaryl carbonium dyes, triaryl carbonium dyes, and heterocyclic derivates thereof (e.g., triphenylmethane, diphenylmethane, thiazine, triphendioxazine, pyronine (xanthene) derivatives and mixtures thereof), phthalocyanine dyes (including metalized phthalocyanine dyes), quinophthalone dyes, sulfur dyes, (e.g., phenothiazonethianthrone) nitro and nitroso dyes (e.g., nitrodiphenylamines, metal-complex derivatives of o-nitrosophenols, derivatives of naphthols, and mixtures thereof), stilbene dyes, formazan dyes, hydrazone dyes (e.g., isomeric 2-phenylazo-1-naphthols, 1-phenylazo-2-naphthols, azopyrazolones, azopyridones, and azoacetoacetanilides), azine dyes, xanthene dyes, triarylmethane dyes, azine dyes, acridine dyes, oxazine dyes, pyrazole dyes, pyrazalone dyes, pyrazoline dyes, pyrazalone dyes, coumarin dye, naphthalimide dyes, carotenoid dyes (e.g., aldehydic carotenoid, β-carotene, canthaxanthin, and β-Apo-8′-carotenal), flavonol dyes, flavone dyes, chroman dye, aniline black dye, indeterminate structures, basic dye, quinacridone dye, formazan dye, triphendioxazine dye, thiazine dye, ketone amine dyes, caramel dye, poly(hydroxyethyl methacrylate)-dye copolymers, riboflavin, and copolymers, derivatives, and mixtures thereof. The application method classification of dyes uses the terms reactive dyes, direct dyes, mordant dyes, pigment dyes, anionic dyes, ingrain dyes, vat dyes, sulfur dyes, disperse dyes, basic dyes, cationic dyes, solvent dyes, and acid dyes.

In some embodiments, the target material comprises a dye carrier. The dye carrier is a substance enables dye penetration into fibers, particularly polyester, cellulose acetate, polyamide, polyacrylic, and cellulose triacetate fibers. The penetration of the dye carrier into the fiber lowers the glass-transition temperature of the fiber and facilitates the fiber to take in a water-insoluble dye. Typically, the dye carrier comprises an aromatic compound. Examples of dye carriers include phenolics (e.g., o-phenylphenol, p-phenylphenol, and methyl crestotinate), chlorinated aromatics (e.g., o-dichlorobenzene, and 1,3,5-trichlorobenzene), aromatic hydrocarbons and ethers (e.g., biphenyl, methylbiphenyl, diphenyl oxide, 1-methylnaphthalene, and 2-methylnaphthalene), aromatic esters (e.g., methyl benzoate, butyl benzoate, and benzyl benzoate), and phthalates (e.g., dimethyl phthalate, diethyl phthalate, diallyl phthalate, and dimethyl terephthalate). A dye carrier may also be referred to as a dyeing accelerant.

In some embodiments, the target material comprises a dye intermediate. The dye intermediate is a dye precursor or a compound other than the dye formed during dye preparation and/or manufacturing. Dye intermediates are generally divided into carbocycles and heterocylces. Carbocyles include benzene, naphthalene, sulfonic acid, diazo-1,2,4-acid, anthraquinone, phenol, aminothiazole nitrate, aryldiazonium salts, arylalkylsulfones, toluene, anisole, aniline, anilide, and chrysazin. Heterocylces include pyrazolones, pyridines, indoles, triazoles, aminothiazoles, aminobenzothiazoles, benzoisothiazoles, triazines, and thiopenes.

In some embodiments, the target material is a pigment. The pigment typically comprises a synthetic or natural (biological or mineral) material that changes the color of reflected or transmitted light as the result of wavelength-selective absorption. The pigment may comprise inorganic and/or organic materials. Inorganic pigments include elements, their oxides, mixed oxides, sulfides, chromates, silicates, phosphates, and carbonates. Examples of inorganic pigments, include cadmium pigments, carbon pigments (e.g., carbon black), chromium pigments (e.g., chromium hydroxide green and chromium oxide green), cobalt pigments, copper pigments (e.g., chlorophyllin and potassium sodium copper chlorophyllin), pyrogallol, pyrophyllite, silver, iron oxide pigments, clay earth pigments, lead pigments (e.g., lead acetate), mercury pigments, titanium pigments (e.g., titanium dioxide), ultramarine pigments, aluminum pigments (e.g., alumina, aluminum oxide, and aluminum powder), bismuth pigments (e.g., bismuth vanadate, bismuth citrate and bismuth oxychloride), bronze powder, calcium carbonate, chromium-cobalt-aluminum oxide, cyanide iron pigments (e.g., ferric ammonium ferrocyanide, ferric and ferrocyanide), manganese violet, mica, zinc pigments (e.g., zinc oxide, zinc sulfide, and zinc sulfate), spinels, rutiles, zirconium pigments (e.g., zirconium oxide and zircon), tin pigments (e.g., cassiterite), cadmium pigments, lead chromate pigments, luminescent pigments, lithopone (which is a mixture of zinc sulfide and barium sulfate), metal effect pigments, nacreous pigments, transparent pigments, and mixtures thereof. Examples of synthetic organic pigments include ferric ammonium citrate, ferrous gluconate, dihydroxyacetone, guaiazulene, and mixtures thereof. Examples of organic pigments from biological sources include alizarin, alizarin crimson, gamboge, cochineal red, betacyanins, betataxanthins, anthocyanin, logwood extract, pearl essence, paprika, paprika oleoresins, saffron, turmeric, turmeric oleoresin, rose madder, indigo, Indian yellow, tagetes meal and extract, Tyrian purple, dried algae meal, henna, fruit juice, vegetable juice, toasted partially defatted cooked cottonseed flour, quinacridone, magenta, phthalo green, phthalo blue, copper phthalocyanine, indanthone, triarylcarbonium sulfonate, triarylcarbonium PTMA salt, triaryl carbonium Ba salt, triarylcarbonium chloride, polychloro copper phthalocyanine, polybromochlor copper phthalocyanine, monoazo, disazo pyrazolone, monoazo benzimid-azolone, perinone, naphthol AS, beta-naphthol red, naphthol AS, disazo pyrazolone, BONA, beta naphthol, triarylcarbonium PTMA salt, disazo condensation, anthraquinone, perylene, diketopyrrolopyrrole, dioxazine, diarylide, isoindolinone, quinophthalone, isoindoline, monoazo benzimidazolone, monoazo pyrazolone, disazo, benzimidazolones, diarylide yellow dintraniline orange, pyrazolone orange, para red, lithol, azo condensation, lake, diaryl pyrrolopyrrole, thioindigo, aminoanthraquinone, dioxazine, isoindolinone, isoindoline, and quinphthalone pigments, and mixtures thereof. Pigments can contain only one compound, such as single metal oxides, or multiple compounds. Inclusion pigments, encapsulated pigments, and lithopones are examples of multi-compound pigments. Typically, a pigment is a solid insoluble powder or particle having a mean particle size ranging from about 0.1 to about 0.3 μm, which is dispersed in a liquid. The liquid may comprise a liquid resin, a solvent or both. Pigment-containing compositions can include extenders and opacifiers.

According to some embodiments, the target material comprises a biological contaminant. Examples of biological contaminants include, without limitation bacteria, fungi, protozoa, viruses, algae and other biological entities and pathogenic species. Such biological contaminants can typically be found in aqueous solutions. Specific non-limiting examples of biological contaminants can include bacteria such as Escherichia coli, Streptococcus faecalis, Shigella spp, Leptospira, Legimella pneumophila, Yersinia enterocolitica, Staphylococcus aureus, Pseudornonas aeruginosa, Klebsiella terrigena, Bacillus anthracis, Vibrio cholerae and Salmonella typhi, viruses such as hepatitis A, notoviruses, rotaviruses, and enteroviruses, protozoa such as Entamoeba histolytica, Giardia, Cryptosporidium parvum and others. Biological contaminants can also include various species such as fungi or algae that are generally non-pathogenic but which are advantageously removed. The biological contaminant may further be referred to as a microbe and/or microorganism.

According to some embodiments, the target material comprises a chemical contaminant. Chemical contaminants include chemical warfare agents, industrial chemicals, pesticides, insecticides, rodenticides, fungicide, herbicides, and fertilizers. In some embodiments, the chemical contaminant can include one or more of an organosulfur agent, an organophosphorous agent or a mixture thereof. Specific non-limiting examples of such agents include o-alkyl phosphonofluoridates, such as sarin and soman, o-alkyl phosphoramidocyanidates, such as tabun, o-alkyl, s-2-dialkyl aminoethyl alkylphosphonothiolates and corresponding alkylated or protonated salts, such as VX, mustard compounds, including 2-chloroethylchloromethylsulfide, humic acid, tannic acid, bis(2-chloroethyl)sulfide, bis(2-chloroethylthio)methane, 1,2-bis(2-chloroethylthio)ethane, 1,3-bis(2-chloroethylthio)-n-propane, 1,4-bis(2-chloroethylthio)-n-butane, 1,5-bis(2-chloroethylthio)-n-pentane, bis(2-chloroethylthiomethyl)ether, and bis(2-chloroethylthioethyl)ether, Lewisites, including 2-chlorovinyldichloroarsine, bis(2-chlorovinyl)chloroarsine, tris(2-chlorovinyl)arsine, bis(2-chloroethyl)ethylamine, and bis(2-chloroethyl)methylamine, saxitoxin, ricin, alkyl phosphonyldifluoride, alkyl phosphonites, chlorosarin, chlorosoman, amiton, 1,1,3,3,3,-pentafluoro-2-(trifluoromethyl)-1-propene, 3-quinuclidinyl benzilate, methylphosphonyl dichloride, dimethyl methylphosphonate, dialkyl phosphoramidic dihalides, alkyl phosphoramidates, diphenyl hydroxyacetic acid, quinuclidin-3-ol, dialkyl aminoethyl-2-chlorides, dialkyl aminoethane-2-ols, dialkyl aminoethane-2-thiols, thiodiglycols, pinacolyl alcohols, phosgene, cyanogen chloride, hydrogen cyanide, chloropicrin, phosphorous oxychloride, phosphorous trichloride, phosphorus pentachloride, alkyl phosphorous oxychloride, alkyl phosphites, phosphorous trichloride, phosphorus pentachloride, alkyl phosphites, sulfur monochloride, sulfur dichloride, and thionyl chloride. The term chemical contaminant can also refer to a chemical agent.

Non-limiting examples of industrial chemicals and materials include materials that have anionic functional groups such as phosphates, sulfates and nitrates, ether and/or carbonyl functional groups and may be substituted with chlorine, fluorine, and bromine atoms and/or ions and combinations thereof. Specific non-limiting examples can include acetaldehyde, acetone, acrolein, acrylamide, acrylic acid, acrylonitrile, aldrin/dieldrin, ammonia, aniline, arsenic, atrazine, barium, benzidine, 2,3-benzofuran, beryllium, 1,1′-biphenyl, bis(2-chloroethyl)ether, bis(chloromethyl)ether, bromodichloromethane, bromoform, bromomethane, 1,3-butadiene, 1-butanol, 2-butanone, 2-butoxyethanol, butraldehyde, carbon disulfide, carbon tetrachloride, carbonyl sulfide, chlordane, chlorodecone and mirex, chlorfenvinphos, chlorinated dibenzo-p-dioxins (CDDs), chlorine, chlorobenzene, chlorodibenzofurans (CDFs), chloroethane, chloroform, chloromethane, chlorophenols, chlorpyrifos, cobalt, copper, creosote, cresols, cyanide, cyclohexane, DDT, DDE, DDD, DEHP, di(2-ethylhexyl)phthalate, diazinon, dibromochloropropane, 1,2-dibromoethane, 1,4-dichlorobenzene, 3,3′-dichlorobenzidine, 1,1-dichloroethane, 1,2-dichloroethane, 1,1-dichloroethene, 1,2-dichloroethene, 1,2-dichloropropane, 1,3-dichloropropene, dichlorvos, diethyl phthalate, diisopropyl methylphosphonate, di-n-butylphtalate, dimethoate, 1,3-dinitrobenzene, dinitrocresols, dinitrophenols, 2,4- and 2,6-dinitrotoluene, 1,2-diphenylhydrazine, di-n-octylphthalate (DNOP), 1,4-dioxane, dioxins, disulfoton, endosulfan, endrin, ethion, ethylbenzene, ethylene oxide, ethylene glycol, ethylparathion, fenthions, fluorides, formaldehyde, freon 113, heptachlor and heptachlor epoxide, hexachlorobenzene, hexachlorobutadiene, hexachlorocyclohexane, hexachlorocyclopentadiene, hexachloroethane, hexamethylene diisocyanate, hexane, 2-hexanone, HMX (octogen), hydraulic fluids, hydrazines, hydrogen sulfide, iodine, isophorone, malathion, MBOCA, methamidophos, methanol, methoxychlor, 2-methoxyethanol, methyl ethyl ketone, methyl isobutyl ketone, methyl mercaptan, methylparathion, methyl t-butyl ether, methylchloroform, methylene chloride, methylenedianiline, methyl methacrylate, methyl-tert-butyl ether, mirex and chlordecone, monocrotophos, N-nitrosodimethylamine, N-nitrosodiphenyl amine, N-nitrosodi-n-propylamine, naphthalene, nitrobenzene, nitrophenols, perchloroethylene, pentachlorophenol, phenol, phosphamidon, phosphorus, polybrominated biphenyls (PBBs), polychlorinated biphenyls (PCBs), polycyclic aromatic hydrocarbons (PAHs), propylene glycol, phthalic anhydride, pyrethrins and pyrethroids, pyridine, RDX (cyclonite), selenium, styrene, sulfur dioxide, sulfur trioxide, sulfuric acid, 1,1,2,2-tetrachloroethane, tetrachloroethylene, tetryl, thallium, tetrachloride, trichlorobenzene, 1,1,1-trichloroethane, 1,1,2-trichloroethane, trichloroethylene (TCE), 1,2,3-trichloropropane, 1,2,4-trimethylbenzene, 1,3,5-trinitrobenzene, 2,4,6-trinitrotoluene (TNT), vinyl acetate, and vinyl chloride.

In some embodiments, the target material comprises a physiologically active material. The physiologically active material is typically an organic material. Examples of physiologically active materials include, without limitation, pharmaceutical and personal care products used by individuals for personal health or cosmetic reasons or used by agribusiness to enhance growth or health of livestock. Physiologically active materials include prescription and over-the-counter therapeutic drugs, veterinary drugs, fragrances, cosmetics, pesticides, herbicides, insecticides, rodenticides, hormones, stimulants (such as caffeine), fungicides, pheromones, and their metabolic products having physiological activity in animals. Examples include prescription, veterinary, and over-the-counter therapeutic drugs, fragrances, cosmetics, sun-screen agents, diagnostic agents, nutraceuticals, biopharmaceutical compounds, growth enhancing chemicals used in livestock operations, and primary and secondary metabolites, and derivatives of these compounds. In some applications, the physiologically active material comprises one or more of an antipyretics, analgesics, antimalarial drugs, antiseptics, antacids, reflux suppressants, antiflatulents, antidopaminergics, proton pump inhibitors (PPIs), H2-receptor antagonists, cytoprotectants, prostaglandin analogues, laxatives, antispasmodics, antidiarrhoeals, bile acid sequestrants, opioid, β-receptor blockers, calcium channel blockers, diuretics, cardiac glycosides, antiarrhythmics, nitrate, antianginals, vasoconstrictors, vasodilators, peripheral activators, antihypertensive drugs, ACE inhibitors, angiotensin receptor blockers, a blockers, calcium channel blockers, anticoagulants, heparin, antiplatelet drugs, fibrinolytics, anti-hemophilic factors, haemostatic drugs, atherosclerosis/cholesterol inhibitors, hypolipidaemic agents, statins, hypnotics, anaesthetics, antipsychotics, antidepressants, tricyclic antidepressants, monoamine oxidase inhibitors, lithium salts, selective serotonin reuptake inhibitors (SSRIs), antiemetics, anticonvulsants, antiepileptics, anxiolytics, barbiturates, movement disorder drugs, stimulants, amphetamines, benzodiazepines, cyclopyrrolones, dopamine antagonists, antihistamines, cholinergics, anticholinergics, emetics, cannabinoids, 5-HT (serotonin) antagonists, nonsteroidal anti-inflammatory drugs, opioids and various orphans such as paracetamol, tricyclic antidepressants, anticonvulsants, adrenergic neurone blocker, astringent, ocular lubricant, topical anesthetics, sympathomimetics, parasympatholytics, mydriatics, cycloplegics, antibiotics, topical antibiotics, sulfa drugs, aminoglycosides, fluoroquinolones, antiviral drugs, anti-fungal drugs, imidazoles, polyenes, corticosteroids, anti-allergy, mast cell inhibitors, anti-glaucoma, adrenergic agonists, beta-blockers, carbonic anhydrase inhibitors/hyperosmotics, cholinergics, miotics, parasympathomimetics, prostaglandin agonists/prostaglandin inhibitors, nitroglycerin, sympathomimetics, antihistamines, anticholinergics, steroids, antiseptics, local anesthetics, cerumenolyti, bronchodilators, anti-allergics, antitussives, mucolytics, decongestants, Beta2-adrenergic agonists, anticholinergics, androgens, antiandrogens, gonadotropin, human growth hormone, insulin, antidiabetics, sulfonylureas, biguanides, metformin, thiazolidinediones, insulin, thyroid hormones, antithyroid drugs, calcitonin, diphosphonate, vasopressin analogues, alkalising agents, quinolones, cholinergics, anticholinergics, anticholinesterases, antispasmodics, 5-alpha reductase inhibitor, selective alpha-1 blockers, sildenafils, fertility medications, ormeloxifene, spermicide, anticholinergics, haemostatic drugs, antifibrinolytics, Hormone Replacement Therapy (HRT), bone regulators, beta-receptor agonists, follicle stimulating hormone, luteinising hormone, LHRH, gamolenic acid, gonadotropin release inhibitor, progestogen, dopamine agonists, oestrogen, prostaglandins, gonadorelin, clomiphene, tamoxifen, Diethylstilbestrol, emollients, anti-pruritics, disinfectants, scabicides, pediculicides, tar products, vitamin A derivatives, vitamin D analogues, keratolytics, abrasives, systemic antibiotics, topical antibiotics, hormones, desloughing agents, exudate absorbents, fibrinolytics, proteolytics, sunscreens, antiperspirants, antibiotics, antileprotics, antituberculous drugs, antimalarials, anthelmintics, amoebicides, antiprotozoals, vaccines, immunoglobulins, immunosuppressants, interferons, monoclonal antibodies, anti-allergics, antihistamines, tonics, iron preparations, electrolytes, parenteral nutritional supplements, vitamins, anti-obesity drugs, anabolic drugs, haematopoietic drugs, food product drugs, barbiturates, HMG-CoA reductase inhibitors, and mixtures thereof. In some applications, the physiologically active material is one or more of caffeine, acetaminophen, ibuprofen, dimethoprim, trimethoprim, sulfonamide, sulfamethoxazole, bis(2-ethylhexyl)phthalate, diethyl phthalate, cotinine, nicotine, lincomycini, sulfadimethoxine, sulfamethazine, sulfathiazole, tylosin, cholesterol, coprostan-3-ol, dihydrocholesterol, ergosterol, stigmastanol, stigmasterol, bezafibrate, clofibric acid, carbamazepine, diclofenac, naproxen, propranolol, ketoprofen, mefenamic acid, androstenedione, estrone, progesterone, estradiol, pentoxifylline, ethynylestradiol, synthetic estrogen EE2, endogenous estrogen 17β-estradiol (E2) and 17α-ethinylstradiol (EE2), estrone, meprobamate, phenyloin, ethinyl estradiol, mestranol, norethindrone, erythromycine, atenolol, triclosan, bisphenol A, nonylphenol, DEET, iopromide, TCEP, roxithromycin, erythromycin-H₂O, gemfibrozil, meprobamate, phenyloin, fluoxetine, diazepam, ethynylestradiol, atorvastatin, norfluoxetine, o-hydroxy atorvastatin, p-hydroxy atorvastatin, risperiodine, testosterone, risperidone, enalapril, simvastatin, simvastatin hydroxyl acid, clofibrate, phthalate esters, primidone, fluoroquinolones, norfloxacin, ofloxacin, ciprofloxacin, tetracycline, doxycycline, estriol, D-norgestrel, clopidogrel, enoxparin, celecoxib, rofecoxib, valdecoxib, omeprazole, esomeprazole, fexofenadine, quetiapine, metoprolol, budesonide, paracetamol, propylphenazone, acetaminophenone, ibuprofen methyl ester, quinolone, macrolide antibiotics, synthetic steroid hormone, loratadine, cetirizine, and mixtures thereof. In some applications, the physiologically active material can be selected from the group consisting essentially of prescription drug, over-the-counter therapeutic drug, veterinary drug, fragrance, cosmetic, sun-screen agent, diagnostic agent, nutraceutical, biopharmaceutical active compound, growth enhancing chemical, antimicrobial, estrogenic steroid, antidepressant, selective serotonin reuptake inhibitor, calcium-channel blocker, antiepileptic drug, phenyloin, valproate, carbamazepine, multi-drug transporter, efflux pump, musk aroma chemical, triclosan, genotoxic drug, and mixtures thereof.

### The Target Material-Containing Stream

The target material-containing stream can be any fluid stream. The fluid stream may be derived from any source containing one or more target materials. Preferably, the target material-containing stream comprises an aqueous stream. The aqueous stream may be derived from any source containing one or more target materials. Non-limiting examples of suitable aqueous streams are recreational waters, municipal waters, wastewaters, well waters, septic waters, drinking waters, and naturally occurring waters.

Non-limiting examples of recreational waters are swimming pool waters, brine pool waters, therapy pool waters, diving pool waters, sauna waters, spa waters, and hot tube waters. Non-limiting examples of municipal waters are drinking waters, waters for irrigation, well waters, waters for agricultural use, waters for architectural use, reflective pool water, water-fountain water, water-wall water, use, non-potable waters for municipal use and other non-potable municipal waters. Wastewaters include without limitation, municipal and/or agricultural run-off waters, septic waters, waters formed and/or generated during an industrial and/or manufacturing process, waters formed and/or generated by a medical facility, waters associated with mining, mineral production, recovery and/or processing (including petroleum), evaporation pound waters, and non-potable disposal waters. Well waters include without limitation waters produced from a well for the purpose of human consumption, agricultural use (including consumption by a animal, irrigation of crops or consumption by domesticated farm animals), mineral-containing waters, waters associated with mining and petroleum production. Non-limiting examples of naturally occurring waters include associated with rains, storms, streams, rivers, lakes, aquifers, estuaries, lagoons, and such.

The target material-containing stream is typically obtained from one or more of the above sources and processed, conveyed and/or manipulated by a water handling system. Furthermore, the target material is removed from the water handling system by contacting the target material with cerium (IV).

In accordance with some embodiments, one or more of a deposit material, oxyanion, colorant, dye, dye carrier, ink, pigment, biological contaminant, chemical contaminant, and physiologically active contaminant target material is removed from a target material-containing stream when the one or more target material is contacted with cerium (IV). The cerium (IV) is formed in one or both of the first fluid and target material-containing stream.

### Water Handling Systems

The water handling system can vary depending on the aqueous stream, water, source of the water/aqueous stream, target materials contained in the water/aqueous stream, and/or water/aqueous stream treatment process. The water can be, without limitation, any recreational water, municipal water, wastewater, well water, septic water, drinking water, and/or naturally occurring water. The water source can be, without limitation, any swimming pool, brine pool, therapy pool, diving pool, sauna, spa, hot tube, drinking, irrigation system, well, agricultural process, architectural process, reflective pool, water-fountain, water-wall, use, non-potable municipal and/or industrial stream, municipal and/or agricultural run-off, septic system, industrial and/or manufacturing stream, medical facility, mining process stream, mineral production stream, petroleum production, recovery, and/or processing stream, evaporation pound, disposal stream, rain, storm, stream, river, lake, aquifer, estuary, lagoon, and such.

The water handling system components and configuration can vary depending on the treatment process, water, and water source. While not wanting to limited by example, municipal and/or wastewater handling systems typically one or more of the following process units: clarifying, disinfecting, coagulating, aerating, filtering, separating solids and liquids, digesting, and polishing. The number and ordering of the process units can vary. Furthermore, some process units may occur two or more times within a water handling system. It can be appreciated that the one or more process units are in fluid communication.

The water handling system may or may not have a clarifier. Some water handling systems may have more than one clarifier, such as primary and final clarifiers. Clarifiers typically reduce cloudiness of the water by removing biological matter (such as bacteria and/or algae), suspended and/or dispersed chemicals and/or particulates from the water. Commonly a clarification process occurs before and/or after a filtration process.

The water handling system may or may not contain a filtering process. Typically, the water handling system contains at least one filtering process. Non-limiting examples of common filtering processes include without limitation screen filtration, trickling filtration, particulate filtration, sand filtration, macro-filtration, micro-filtration, ultra-filtration, nano-filtration, reverse osmosis, carbon/activated carbon filtration, dual media filtration, gravity filtration and combinations thereof. Commonly a filtration process occurs before and/or after a disinfection process. For example, a filtration process to remove solid debris, such as solid organic matter and grit from the water typically precedes the disinfection process. In some embodiments, a filtration process, such as an activated carbon and/or sand filtrations follows the disinfection process. The post-disinfection filtration process removes at least some of the chemical disinfectant remaining in the treated water.

The water handling system may or may not include a disinfection process. The disinfection process may include without limitation treating the aqueous stream and/or water with one or more of fluorine, fluorination, chlorine, chlorination, bromine, bromination, iodine, iodination, ozone, ozonation, electromagnetic irradiation, ultra-violet light, gama rays, electrolysis, chlorine dioxide, hypochlorite, heat, ultrasound, trichloroisocyanuric acid, soaps/detergents, alcohols, bromine chloride (BrCl), cupric ion (Cu²⁺), silver, silver ion (Ag⁺), permanganate, phenols, and combinations thereof. Preferably, the water handling system contains a single disinfection process, more preferably the water handling system contains two or more disinfection processes. Disinfection process are typically provided to one of at least remove, kill and/or detoxify pathogenic material contained in the water. Typically, the pathogenic material comprises biological contaminants.

The water handling system may or may not include coagulation. The water handling system may contain one or more coagulation processes. Typically, the coagulation process includes adding a flocculent to the water in the water handling system. Typical flocculants include aluminum sulfate, polyelectrolytes, polymers, lime and ferric chloride. The flocculent aggregates the particulate matter suspended and/or dispersed in the water, the aggregated particulate matter forms a coagulum. The coagulation process may or may not include separating the coagulum from the liquid phase. In some embodiments, coagulation may comprise part, or all, the entire clarification process. In other embodiments, the coagulation process is separate and distinct from the clarification process. Typically, the coagulation process occurs before the disinfection process.

The water handling system may or may not include aeration. Within the water handing system, aeration comprises passing a stream of air and/or molecular oxygen through the water contained in the water handling system. The aeration process promotes oxidation of contaminants contained in the water being processed by the water handling system, preferably the aeration promotes the oxidation of biological contaminates. The water handling system may contain one or more aeration processes. Typically, the disinfection process occurs after the aeration process.

The water handling system may or may not have one or more of a heater, a cooler, and a heat exchanger to heat and/or cool the water being processed by the water handling system. The heater may be any method suitable for heating the water. Non-limiting examples of suitable heating processes are solar heating systems, electromagnetic heating systems (such as, induction heating, microwave heating and infrared), immersion heaters, and thermal transfer heating systems (such as, combustion, stream, hot oil, and such, where the thermal heating source has a higher temperature than the water and transfers heat to the water to increase the temperature of the water). The heat exchanger can be any process that transfers thermal energy to or from the water. The heat exchanger can remove thermal energy from the water to cool and/or decrease the temperature of the water. Or, the heat exchanger can transfer thermal energy to the water to heat and/or increase the temperature of the water. The cooler may be any method suitable for cooling the water. Non-limiting examples of suitable cooling process are refrigeration process, evaporative coolers, and thermal transfer cooling systems (such as, chillers and such where the thermal (cooling) source has a lower temperature than the water and removes heat from the water to decrease the temperature of the water). Any of the clarification, disinfection, coagulation, aeration, filtration, sludge treatment, digestion, nutrient control, solid/liquid separation, and/or polisher processes may further include before, after and/or during one or both of a heating and cooling process. It can be appreciated that a heat exchanger typically includes at least one of heating and cooling process.

The water handling system may or may not include a digestion process. Typically, the digestion process is one of an anaerobic or aerobic digestion process. In some configurations, the digestion process may include one of an anaerobic or aerobic digestion process followed by the other of the anaerobic or aerobic digestion processes. For example, one such configuration can be an aerobic digestion process followed by an anaerobic digestion process. Commonly, the digestion process comprises microorganisms that breakdown the biodegradable material contained in the water. The anaerobic digestion of biodegradable material proceeds in the absence of oxygen, while the aerobic digestion of biodegradable material proceeds in the presence of oxygen. In some water handling systems the digestion process is typically referred to as biological stage/digester or biological treatment stage/digester. Moreover, in some systems the disinfection process comprises a digestion process.

The water handling system may or may not include a nutrient control process. Furthermore, the water handling system may include one or more nutrient control processes. The nutrient control process typically includes nitrogen and/or phosphorous control. Moreover, nitrogen control commonly may include nitrifying bacteria. Typically, phosphorous control refers to biological phosphorous control, preferably controlling phosphorous that can be used as a nutrient for algae. Nutrient control typically includes processes associated with control of oxygen demand substances, which include in addition to nutrients, pathogens, and inorganic and synthetic organic compositions. The nutrient control process can occur before or after the disinfection process.

The water handling system may or may not include a solid/liquid separation process. Preferably, the water handling system includes one or more solid/liquid separation processes. The solid/liquid separation process can comprise any process for separating a solid phase from a liquid phase, such as water. Non-limiting examples of suitable solid liquid separation processes are clarification (including trickling filtration), filtration (as described above), vacuum and/or pressure filtration, cyclone (including hydrocyclones), floatation, sedimentation (including gravity sedimentation), coagulation (as described above), sedimentation (including, but not limited to grit chambers), and combinations thereof.

The water handling system may or may not include a polisher. The polishing process can include one or more of removing fine particulates from the water, an ion-exchange process to soften the water, an adjustment to the pH value of the water, or a combination thereof. Typically, the polishing process is after the disinfection step.

While the water handling system typically includes one or more of a clarifying, disinfecting, coagulating, aerating, filtering, separating solids and liquids, digesting, and polishing processes, the water handling system may further include additional processing equipment. The additional processing equipment includes without limitation holding tanks, reactors, purifiers, treatment vessels or units, mixing vessels or elements, wash circuits, precipitation vessels, separation vessels or units, settling tanks or vessels, reservoirs, pumps, cooling towers, heat exchangers, valves, boilers, gas liquid separators, nozzles, tenders, and such. Furthermore, the water handling system includes conduit(s) interconnecting the unit operations and/or additional processing equipment. The conduits include without limitation piping, hoses, channels, aqua-ducts, ditches, and such. The water is conveyed to and from the unit operations and/or additional processing equipment by the conduit(s). Moreover, each unit operations and/or additional processing equipment is in fluid communication with the other unit operations and/or additional processing equipment by the conduits.

Removal of the Target Material

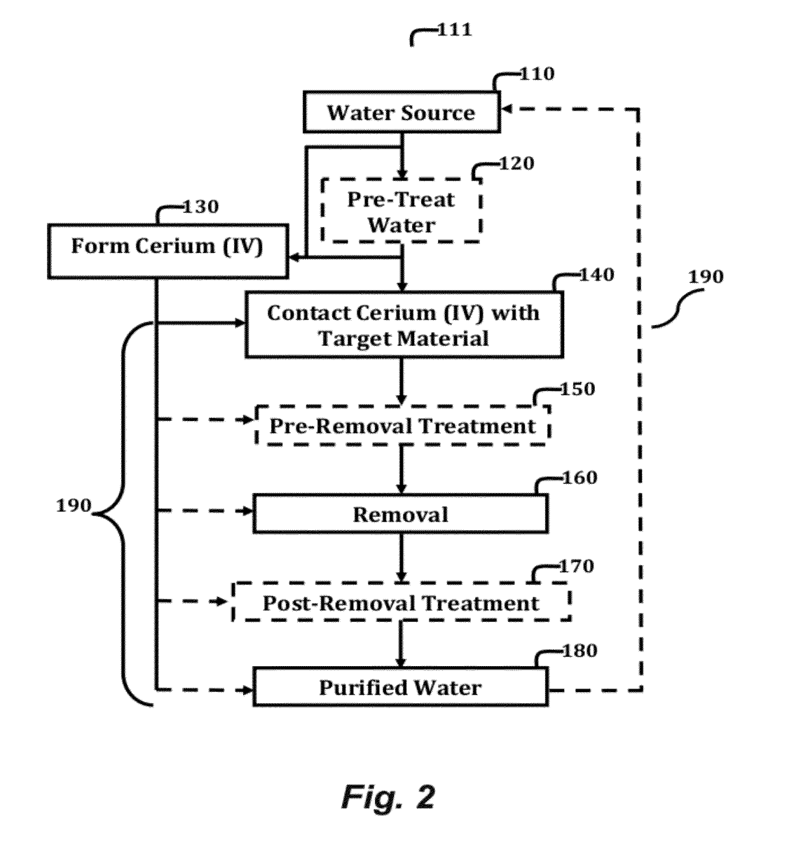

FIG. 2 depicts a process 111 for removing a target material from a target material-containing stream according to an embodiment.

In step 110, a target material-containing stream is provided to water handling system 190.

The target material-containing stream may be derived from any aqueous stream. Non-limiting examples of suitable aqueous streams include without limitation recreational waters, municipal waters, wastewaters, well waters, septic waters, drinking waters, naturally occurring waters and combinations thereof.

Step 120 is an optional step. In step 120, the target material-containing stream may be pre-treated to form a pre-treated target material-containing stream. The pre-treatment can comprise one or more of clarifying, disinfecting, coagulating, aerating, filtering, separating solids and liquids, digesting, and polishing processes. More specifically, the pre-treatment process can commonly comprise one of clarifying, disinfecting, coagulating, aerating, filtering, separating solids and liquids, digesting, and polishing processes, more commonly any two of clarifying, disinfecting, coagulating, aerating, filtering, separating solids and liquids, digesting, and polishing processes arranged in any order, even more commonly any three of clarifying, disinfecting, coagulating, aerating, filtering, separating solids and liquids, digesting, and polishing processes arranged in any order, yet even more commonly any four of clarifying, disinfecting, coagulating, aerating, filtering, separating solids and liquids, digesting, and polishing processes arranged in any order, still yet even more commonly any five of clarifying, disinfecting, coagulating, aerating, filtering, separating solids and liquids, digesting, and polishing processes arranged in any order, still yet even more commonly any six of clarifying, disinfecting, coagulating, aerating, filtering, separating solids and liquids, digesting, and polishing processes arranged in any order, still yet even more commonly any seven of clarifying, disinfecting, coagulating, aerating, filtering, separating solids and liquids, digesting, and polishing processes arranged in any order, still yet even more commonly any eight of clarifying, disinfecting, coagulating, aerating, filtering, separating solids and liquids, digesting, and polishing processes arranged in any order, still yet even more commonly any nine of clarifying, disinfecting, coagulating, aerating, filtering, separating solids and liquids, digesting, and polishing processes arranged in any order, still yet even more commonly any ten of clarifying, disinfecting, coagulating, aerating, filtering, separating solids and liquids, digesting, and polishing processes arranged in any order, still yet even more commonly any eleven of clarifying, disinfecting, coagulating, aerating, filtering, separating solids and liquids, digesting, and polishing processes arranged in any order, and yet still even more commonly each of clarifying, disinfecting, coagulating, aerating, filtering, separating solids and liquids, digesting, and polishing process arranged in any order. In some configurations, the pre-treatment may comprise or may further comprise processing by one or more of the additional process equipment of the water-handling system.

In step 130, cerium (IV) is formed in one or more of the target material-containing stream, the optionally pre-treated target material-containing stream, a side-stream water or a combination thereof. The side-stream water is a water stream other than the target material-containing and/or optionally pre-treated target material-containing streams. Preferably, the side-stream water comprises one of de-ionized water, drinking water, municipal water, water substantially free of a target material, water substantially devoid of a target material, potable water or a mixture thereof.

The cerium (IV) is formed by contacting a rare earth-containing additive with an oxidizing agent. The rare earth-containing additive comprises a rare earth and/or rare earth-containing composition comprising at least some water-soluble cerium (III). The water-soluble cerium (III) preferably comprises a water-soluble cerium (III) salt.

In some embodiments, the a rare earth-containing additive comprises in addition to the water-soluble cerium (III) composition one or more other rare earths other than cerium (III), such as, cerium (IV), yttrium, scandium, lanthanum, praseodymium, neodymium, samarium, europium, gadolinium, terbium, dysprosium, holmium, erbium, thulium, ytterbium, and lutetium. The other rare earths may or may not be water-soluble. Suitable water-soluble rare earth compositions include rare earth chlorides, rare earth bromides, rare earth iodides, rare earth astatides, rare earth nitrates, rare earth sulfates, rare earth oxalates, rare earth perchlorates, rare earth carbonates, and mixtures thereof.

In some formulations, the water-soluble cerium composition preferably comprises cerium (III) chloride, CeCl₃. In other formulations, the rare earth-containing additive comprises a water-soluble cerium (III) salt, such as a cerium (III) chloride, cerium (III) bromide, cerium (III) iodide, cerium (III) astatide, cerium perhalogenates, cerium (III) carbonate, cerium (III) nitrate, cerium (III) sulfate, cerium (III) oxalate and mixtures thereof. In some formulations, the water-soluble cerium composition preferably consists essentially of cerium (III) chloride, CeCl₃. In other formulations, the rare earth-containing additive consists essentially of a water-soluble cerium (III) salt, such as a cerium (III) chloride, cerium (III) bromide, cerium (III) iodide, cerium (III) astatide, cerium perhalogenates, cerium (III) carbonate, cerium (III) nitrate, cerium (III) sulfate, cerium (III) oxalate and mixtures thereof. In some formulation, the rare earth-containing additive includes a water-soluble lanthanum (III) compositions. In some formulations, the water-soluble lanthanum (III) composition preferably comprises lanthanum (III) chloride, LaCl₃. In other formulations, the rare earth-containing additive comprises a water-soluble lanthanum (III) salt, such as a lanthanum (III) chloride, lanthanum (III) bromide, lanthanum (III) iodide, lanthanum (III) astatide, lanthanum perhalogenates, lanthanum (III) carbonate, lanthanum (III) nitrate, lanthanum (III) sulfate, lanthanum (III) oxalate and mixtures thereof. In some formulations, the water-soluble lanthanum (III) composition preferably consists essentially of lanthanum (III) chloride, LaCl₃. In other formulations, the rare earth-containing additive consists essentially of a water-soluble lanthanum (III) salt, such as a lanthanum (III) chloride, lanthanum (III) bromide, lanthanum (III) iodide, lanthanum (III) astatide, lanthanum perhalogenates, lanthanum (III) carbonate, lanthanum (III) nitrate, lanthanum (III) sulfate, lanthanum (III) oxalate and mixtures thereof. In some formulation, the rare earth-containing additive includes a combination of water-soluble cerium (III) and lanthanum (III) compositions.

The rare earth and/or rare earth-containing composition in the rare earth-containing additive can comprise rare one or more earths in elemental, ionic or compounded forms dissolved in a solvent, such as water, or in the form of nano-particles, particles larger than nanoparticles, agglomerates, or aggregates or combinations and/or mixtures thereof. The rare earth and/or rare earth-containing composition can be in a supported and/or unsupported form. The rare earths may comprise rare earths having the same or different valence and/or oxidation states and/or numbers. Furthermore, the rare earths may comprise a mixture of different rare earths. Preferably, the rare earths may comprise a mixture of two or more of yttrium, scandium, cerium, lanthanum, praseodymium, and neodymium.

In some embodiments, the rare earth-containing additive comprises one or more of: an aqueous solution containing substantially dissociated, dissolved forms of the rare earths and/or rare earth-containing compositions; free flowing granules, powder, particles, and/or particulates of rare earths and/or rare earth-containing compositions containing at least some water-soluble cerium (III); free flowing aggregated granules, powder, particles, and/or particulates of rare earths and/or rare earth-containing compositions substantially free of a binder and containing at least some water-soluble cerium (III); free flowing agglomerated granules, powder, particles, and/or particulates comprising a binder and rare earths and/or rare earth-containing compositions one or both of in an aggregated and non-aggregated form and containing at least some water-soluble cerium (III); rare earths and/or rare earth-containing compositions containing at least some water-soluble cerium (III) and supported on substrate; and combinations thereof.

The oxidizing agent has substantially enough oxidizing potential to oxidize at least some of the cerium (III) to cerium (IV). The oxidizing agent comprises one or more of a chemical oxidizing agent, an oxidation process, or combination of both. Preferably, the chemical oxidizing agent comprises at least one of chlorine, chloroamines, chlorine dioxide, hypochlorites, trihalomethane, haloacetic acid, ozone, hydrogen peroxide, peroxygen compounds, hypobromous acid, bromoamines, hypobromite, hypochlorous acid, isocyanurates, tricholoro-s-triazinetriones, hydantoins, bromochloro-dimethyldantoins, 1-bromo-3-chloro-5,5-dimethyldantoin, 1,3-dichloro-5,5-dimethyldantoin, sulfur dioxide, bisulfates, and combinations thereof. In some embodiments, the chemical oxidizing agent comprises one or more of bromine, BrCl, permanganates, phenols, alcohols, oxyanions, arsenites, chromates, trichloroisocyanuric acid, and surfactants. In some configurations, the oxidizing process comprises one or more of electromagnetic energy, ultra violet light, thermal energy, ultrasonic energy, and gamma rays.

The oxidizing agent transforms a substantially water-soluble form of cerium, preferably cerium (III), into a substantially water-insoluble form of cerium, preferably cerium (IV). In preferred embodiments, the cerium (IV) comprises one or more of cerium (IV) oxide, cerium (IV) hydroxide, cerium (IV) oxyhydroxy, cerium (IV) hydrous oxide, cerium (IV) hydrous oxyhydroxy, CeO₂, and/or Ce(IV) (O)_{w}(OH)ₓ(H₂O)_{y}.zH₂O, where w, x, y and z can be zero or a positive, real number. The cerium (IV) is preferably in the form of a colloid, suspension, or slurry of cerium (IV)-containing particulates.

In some embodiments, the cerium (IV)-containing particulates have a mean, median and/or P₉₀ particle size from about 0.1 to about 1,000 nm, more preferably from about 0.1 to about 500 nm. Even more preferably, the cerium (IV)-containing particulates have a mean, median and/or P₉₀ particle size from about 0.2 to about 100 nm. In some embodiments, the cerium (IV)-containing particulates commonly have a mean, median and/or P₉₀ particle size of less than about 1 nanometer. In other embodiments, the cerium (IV)-containing particulates have a mean, median and/or P₉₀ particle size of less than about 1 nanometer. In some embodiments, the cerium (IV)-containing particulate is in the form of one or more of a granule, crystal, crystallite, and particle.

Preferably, the cerium (IV)-containing particulates have a mean and/or median surface area of at least about 1 m²/g, more preferably a mean and/or median surface area of at least about 70 m²/g. In some embodiments, the cerium (IV)-containing particulates mean and/or median surface area from about 25 m²/g to about 500 m²/g, preferably of about 100 to about 250 m²/g.

In some embodiments, it is advantageous to have a mixture comprising cerium (IV) and a rare earth-containing additive having one or more +3 rare earths. More specifically, it is particularly advantageous to have a mixture comprising cerium (IV) and a cerium-containing additive having cerium (III) in a substantially water-soluble form. Water-soluble cerium (III) and water-insoluble cerium (IV), for example, can have dramatically different capacities and/or abilities to kill, detoxify, and/or remove target materials from a target material-containing stream. For example, having solution phase cerium (III) provides for an opportunity to take advantage of cerium (III) solution phase sorption and/or precipitation chemistries, such as, but not limited to, the formation of insoluble cerium (III) compositions with oxyanions. Furthermore, having a cerium (IV) present provides for an opportunity to take advantage of sorption and oxidation/reduction chemistries of cerium (IV), such as, the strong interaction of cerium (IV) with target materials. For example, cerium (IV) forms a substantially water-insoluble target material-laden cerium (IV) compositions with oxyanions and/or organic matter.

In some embodiments, it is advantageous to have a rare earth-containing additive comprises substantially one or more +3 rare earths. More specifically, it is particularly advantageous to have a rare earth-containing additive comprising substantially one or more water-soluble rare earths, preferably water-soluble rare earths having a +3 oxidation state. More preferably, the rare earth-containing composition comprises cerium in a substantially water-soluble form. It can be appreciated that, that in some configurations and embodiments one or more of target materials being removed and/or sorbed by cerium (IV) can be substantially removed and/or sorbed by cerium (III). That is, in some configurations, formulations and embodiments, one or more target materials can be removed from the target material-containing stream by rare earth having a +3 or a rare earth having a +4 oxidation. In other words, the target material may be removed by a rare having a +3 oxidation state in the substantial absence of a rare earth having a +4 oxidation. Conversely, the target material may be removed by a rare having a +4 oxidation state in the substantial absence of a rare earth having a +3 oxidation state.

In some embodiments, a molar ratio of a water-soluble rare earths, including water-solution cerium (III) to a water-insoluble cerium (IV) after contacting cerium (III) with an oxidizing agent to form cerium (IV) is commonly no more than about 1:1, more commonly is no more than about 1:5×10⁻¹, even more commonly is no more than about 1:1×10⁻¹, yet even more commonly is no more than about 1:1×10⁻², still yet even more commonly is no more than about 1:1×10⁻³, still yet even more commonly is no more than about 1:1×10⁻⁴, still yet even more commonly is no more than about 1:1×10⁻⁵, or still yet even more commonly is no more than about 1:1×10⁻⁶. In some embodiments, a molar ratio of a water-soluble trivalent rare earths, including water-soluble cerium (III), to the cerium (IV) is no more than about 1:1, more commonly is no more than about 1:5×10⁻¹, even more commonly is no more than about 1:1×10⁻¹, yet even more commonly is no more than about 1:1×10⁻², still yet even more commonly is no more than about 1:1×10⁻³, still yet even more commonly is no more than about 1:1×10⁻⁴, still yet even more commonly is no more than about 1:1×10⁻⁵, or still yet even more commonly is no more than about 1:1×10⁻⁶. The molar ratios do not include rare earths comprising the target material-laden rare earth composition.

In some embodiments, the molar ratio of cerium (III) to cerium (IV) after oxidizing water-soluble cerium (III) to cerium (IV) with the oxidizing agent is no more than about 1:1, more commonly is no more than about 1:5×10⁻¹, even more commonly is no more than about 1:1×10⁻¹, yet even more commonly is no more than about 1:1×10⁻², still yet even more commonly is no more than about 1:1×10⁻³, still yet even more commonly is no more than about 1:1×10⁻⁴, still yet even more commonly is no more than about 1:1×10⁻⁵, or still yet even more commonly is no more than about 1:1×10⁻⁶. In some embodiments, the molar ratio of cerium (IV) to cerium (III) in the rare earth-containing additive is about 1 to about 1×10⁻⁷, more commonly is about 1 to about 1×10⁻⁶, even more commonly is about 1 to about 1×10⁻⁵, yet even more commonly is about 1 to about 1×10⁻⁴, still yet even more commonly is about 1 to about 1×10⁻³, still yet even more commonly is about 1 to about 1×10²⁻, still yet even more commonly is about 1 to about 1×10⁻¹, or still yet even more commonly is about 1:1.

In some less preferred embodiments, the molar ratio of cerium (IV) to cerium (III) after the formation of cerium (IV) after oxidizing cerium (III) with an oxidizing agent is no more than about 1:1, more commonly is no more than about 1:5×10⁻¹, even more commonly is no more than about 1:1×10⁻¹, yet even more commonly is no more than about 1:1×10⁻², still yet even more commonly is no more than about 1:1×10⁻³, still yet even more commonly is no more than about 1:1×10⁻⁴, still yet even more commonly is no more than about 1:1×10⁻⁵, or still yet even more commonly is no more than about 1:1×10⁻⁶. In some less preferred embodiments, the molar ratio of cerium (III) to cerium (IV) in the rare earth-containing additive is about 1 to about 1×10⁻⁷, more commonly is about 1 to about 1×10⁻⁶, even more commonly is about 1 to about 1×10⁻⁵, yet even more commonly is about 1 to about 1×10⁻⁴, still yet even more commonly is about 1 to about 1×10⁻³, still yet even more commonly is about 1 to about 1×10⁻², still yet even more commonly is about 1 to about 1×10⁻¹, or still yet even more commonly is about 1:1.

Further, the molar ratios of cerium (III) and cerium (IV) apply for any combinations of soluble and insoluble forms of cerium (III) and soluble and insoluble forms of cerium (IV).

In accordance with some embodiments, the contacting of the rare earth-containing additive containing at least some water-soluble cerium (III) with the oxidizing agent oxidizes at least some cerium (III) to cerium (IV). Typically, the contacting of the rare earth-containing additive containing at least some water-soluble cerium (III) with the oxidizing agent oxidizes at least about 5 mole % of the water-soluble cerium (III) contained in the rare earth-containing additive to cerium (IV), more commonly at least some water-soluble cerium (III) with the oxidizing agent oxidizes at least about 10 mole % of the water-soluble cerium (III) contained in the rare earth-containing additive to cerium (IV), even more commonly at least some water-soluble cerium (III) with the oxidizing agent oxidizes at least about 20 mole % of the water-soluble cerium (III) contained in the rare earth-containing additive to cerium (IV), yet even more commonly at least some water-soluble cerium (III) with the oxidizing agent oxidizes at least about 30 mole % of the water-soluble cerium (III) contained in the rare earth-containing additive to cerium (IV), still yet even more commonly at least some water-soluble cerium (III) with the oxidizing agent oxidizes at least about 40 mole % of the water-soluble cerium (III) contained in the rare earth-containing additive to cerium (IV), still yet even more commonly at least some water-soluble cerium (III) with the oxidizing agent oxidizes at least about 50 mole % of the water-soluble cerium (III) contained in the rare earth-containing additive to cerium (IV), still yet even more commonly at least some water-soluble cerium (III) with the oxidizing agent oxidizes at least about 60 mole % of the water-soluble cerium (III) contained in the rare earth-containing additive to cerium (IV), still yet even more commonly at least some water-soluble cerium (III) with the oxidizing agent oxidizes at least about 70 mole % of the water-soluble cerium (III) contained in the rare earth-containing additive to cerium (IV), still yet even more commonly at least some water-soluble cerium (III) with the oxidizing agent oxidizes at least about 80 mole % of the water-soluble cerium (III) contained in the rare earth-containing additive to cerium (IV), still yet even more commonly at least some water-soluble cerium (III) with the oxidizing agent oxidizes at least about 90 mole % of the water-soluble cerium (III) contained in the rare earth-containing additive to cerium (IV), still yet even more commonly at least some water-soluble cerium (III) with the oxidizing agent oxidizes at least about 95 mole % of the water-soluble cerium (III) contained in the rare earth-containing additive to cerium (IV), still yet even more commonly at least some water-soluble cerium (III) with the oxidizing agent oxidizes at least about 99 mole % of the water-soluble cerium (III) contained in the rare earth-containing additive to cerium (IV), and yet still even more commonly at least some water-soluble cerium (III) with the oxidizing agent oxidizes at least about 99.9 mole % of the water-soluble cerium (III) contained in the rare earth-containing additive to cerium (IV). In can be appreciated that the oxidation of cerium (III) to cerium (IV) can occur over a period of seconds, over a period of hours, over a period of days, or even weeks.

In step 140, one or more target materials contained in the target material-containing stream is contacted with the cerium (IV) formed in step 130 to form a target material-laden rare earth composition and a barren stream. The barren stream contains less of at least one target material than the target material-containing stream.

The one or more target materials may be contained in the target material-containing stream or in the optionally pre-treated target material-containing stream. Preferably, the cerium (IV) is contacted with the one or more target materials in one of a clarifying, disinfecting, coagulating, aerating, filtering, separating solids and liquids, digesting, and polishing process or in a process step other than the clarifying, disinfecting, coagulating, aerating, filtering, separating solids and liquids, digesting, and polishing processes, such as in one of the addition process equipment of the water handling system 190. More preferably, the contacting of the cerium (IV) with the one or target materials comprises one of a clarification, disinfection, coagulation, filtration, aeration, nutrient control, polisher or combination thereof process.

While not wanting to be limited by example, the clarification process can comprise contacting cerium (IV) with one or more target materials to remove and/or sorb target materials as an aspect of the clarification process. More specifically, cerium (IV) may be contacted with and remove and/or sorb one or more of biological material, deposit material, organic chemicals or other target materials suspended and dispersed in the target material-containing stream or in the optionally pre-treated target material-containing stream during a clarification process.

In a similar manner, the coagulation process can comprise contacting cerium (IV) with target material to form to coagulate comprising the target material-laden rare earth composition. The target material can comprise one or more of biological material, deposit material, organic chemicals or other target materials suspended and dispersed in one or both of the target material-containing stream and the optionally pre-treated target material-containing stream.

Furthermore, the disinfection process can comprise contacting cerium (IV) with an infectious target material to remove and/or detoxify infectious target materials-contained in one or both of the target material-containing stream and the optionally pre-treated target material-containing stream. It can be appreciated that, the disinfection material performing the disinfection process is not removed, absorbed, precipitated, killed and/or deactivated by the cerium (IV).

Moreover, the filtration process can comprise contacting cerium (IV) with one or more target materials in the one or both of the target material-containing and the optionally pre-treated target material-containing streams to remove at least some, if not most, of the one or more target materials by sorbing the one or more target materials during the filtering of the one or both of the target material-containing and the optionally pre-treated target material-containing streams.

Regarding an aeration process, cerium (IV) can be contacted with one or more target materials present and/or formed during aeration of one or both of the target material-containing and the optionally pre-treated target material-containing streams to remove and/or sorb at least some, if not most, of the one or more target materials.

Further regarding a digestion process, cerium (IV) can be contacted with one or more target materials during a chemical and/or biological digestion process to remove and/or sorb at least some, if not most, of the target materials present and/or formed during the chemical and/or biological digestion process of the one or both of the target material-containing and the optionally pre-treated target material-containing streams. It can be appreciated that, the chemical and/or biological material, respectively, performing the chemical and/or biological digestion process is not substantially removed, absorbed, precipitated, killed and/or deactivated by the cerium (IV).

In one configuration, the nutrient control process can comprise contacting the cerium (IV) with one or more target materials contained with the one or both of the target material-containing and the optionally pre-treated target material-containing streams. Preferably, at least one of the one or more target materials comprises a nutrient, such as without limitation, phosphate. More preferably, contacting the cerium (IV) with the nutrient target material removes at least some, if not most, of the nutrient target material from the one or both of the target material-containing and the optionally pre-treated target material-containing streams.

In some embodiments, the polishing process can comprise contacting the cerium (IV) one or more target materials contained in one or both of the target material-containing and the optionally pre-treated target material-containing streams. The one or more target materials can be deposit materials, biological matter, microbes, bacteria, algae, mold, fungus, or other materials contained in one or both of the target material-containing and optionally pre-treated target material-containing streams. The contacting of the cerium (IV) with the one or more target materials forms a target material-laden rare earth composition and a barren stream. The barren stream being the polished solution having a reduced target material content compared to one or both of the target material-containing stream and the optionally pre-treated target material-containing stream.

However, the contacting of the cerium (IV) with the one or more target materials is less preferred during a disinfection process when the cerium (IV) can kill and/or deactivate the disinfecting bacteria and/or precipitate and/or sorb the disinfecting fluoride. Furthermore, contacting cerium (IV) with the one or more target materials is less preferred during some filtering and digester processes, such as trickling filtration and digestion, which are typically carried-out using microbes, particularly when the cerium (IV) may kill and/or deactivate the microbes.

Preferably, the contacting of the cerium (IV) with the one or more target materials forms a target material-laden rare earth composition. The target material-laden rare earth composition is formed by cerium (IV) sorbing the target material and/or a component of the target material. Sorbing the target material refers to one or more of absorption, adsorption, and/or precipitation of the target material, a chemical entity of the target material and/or an oxidized form of the target material in the form of a target-laden rare composition. While not wanting to be limited by example, taking TM to be a target material “TM” comprising two chemical entities “T” and “M” chemically bonded together, cerium (IV) can remove the target material TM from a target material-containing stream by one or more of absorbing, adsorbing and precipitating one or both chemical entities “T” and “M” of the target material. In some embodiments, cerium (IV) can oxidize the target material to form an oxidized target material and cerium (III). In some configurations, the oxidized target material may not be toxic, therefore, does not need to be removed from solution. In some configurations, the oxidized form of the target material is easier and/or more effectively removed from solution from one or more of the rare earths, rare earth additive or cerium (IV) and the reduced form of the target material. Moreover, a composition of matter is form when the target material, a chemical entity of the target material and/or an oxidized form of the target material is one or more of absorbed, adsorbed and precipitated by the cerium (IV), the rare earth additive and/or a rare earth comprising the rare earth additive.

In some embodiments, the target material comprises a toxic substance. The one or more of absorption, adsorption, and/or precipitation of the target material, a chemical entity of the target material and/or an oxidized form of the target material in the form of a target material-laden rare earth composition substantially detoxifies the target material-containing stream.

In accordance with some embodiments, a barren stream is form by contacting cerium (IV) with one or more of the target materials in the target material-containing stream. The barren stream has a lower content of at least one target material compared to the target material-containing stream. Commonly, the barren stream content is at least about 0.9 of the target material-containing stream, more commonly the barren stream content is at least about 0.8 of the target material-containing stream, even more commonly the barren stream content is at least about 0.7 of the target material-containing stream, yet even more commonly the barren stream content is at least about 0.6 of the target material-containing stream, still yet even more commonly the barren stream content is at least about 0.5 of the target material-containing stream, still yet even more commonly the barren stream content is at least about 0.4 of the target material-containing stream, still yet even more commonly the barren stream content is at least about 0.3 of the target material-containing stream, still yet even more commonly the barren stream content is at least about 0.2 of the target material-containing stream, still yet even more commonly the barren stream content is at least about 0.1 of the target material-containing stream, still yet even more commonly the barren stream content is at least about 0.05 of the target material-containing stream, still yet even more commonly the barren stream content is at least about 0.01 of the target material-containing stream, still yet even more commonly the barren stream content is at least about 0.005 of the target material-containing stream, still yet even more commonly the barren stream content is at least about 0.001 of the target material-containing stream, still yet even more commonly the barren stream content is at least about 0.5 of the target material-containing stream, still yet even more commonly the barren stream content is at least about 0.0005 of the target material-containing stream, still yet even more commonly the barren stream content is at least about 0.0001 of the target material-containing stream, still yet even more commonly the barren stream content is at least about 5×10⁻⁵ of the target material-containing stream, still yet even more commonly the barren stream content is at least about 1×10⁻⁵ of the target material-containing stream, still yet even more commonly the barren stream content is at least about 5×10⁻⁶ of the target material-containing stream, and still yet even more commonly the barren stream content is at least about 1×10⁻⁶ of the target material-containing stream. Typically, the target material content in the barren stream content is no more than about 100,000 ppm, more typically the target material content in the barren stream content is no more than about 10,000 ppm, even more typically the target material content in the barren stream content is no more than about 1,000 ppm, yet even more typically the target material content in the barren stream content is no more than about 100 ppm, still yet even more typically the target material content in the barren stream content is no more than about 10 ppm, still yet even more typically the target material content in the barren stream content is no more than about 1 ppm, still yet even more typically the target material content in the barren stream content is no more than about 100 ppb, still yet even more typically the target material content in the barren stream content is no more than about 10 ppb, still yet even more typically the target material content in the barren stream content is no more than about 1 ppb, and yet still even more typically the target material content in the barren stream content is no more than about 0.1 ppb.

In some embodiments, the cerium (IV) can remove and/or inhibit deposition of a deposit material from the water and/or water handling system. While not wanting to be bound by any theory, the cerium (IV) can remove and/or inhibit deposition of the deposit material from the water and/or water handling system by many possible mechanisms. In accordance with some embodiments, the contacting of the cerium (IV) with the deposit material substantially removes at least some, if not most, of the deposit material and/or inhibits deposition of deposit material from the water and/or water handling system. In some configurations, the contacting of the cerium (IV) with the deposit material forms a deposit-laden rare earth composition.

The target material-laden rare earth composition can have a rare earth:target material ratio, preferably a cerium (IV):target material ratio. The rare earth:target material ratio can vary. While not wanting to be limited by theory and/or example, the target material-laden rare earth compositions having a rare earth:target material ratio less than 1 have a greater molar removal capacity of the target material than target material-laden rare earth compositions having a rare earth:target material ratio 1 or more. In some embodiments, the target material in the rare earth:target material ratio is an oxyanion and the rare earth:target material ratio is a rare earth:oxyanion ratio.

It is believed that the rare earth:target material ratio can vary depending on pH value of the water. In some embodiments, the rare earth:target material ratio increases as the pH value of the water increases. In some embodiments, the rare earth:target material ratio decreases with decreases in the pH value of the water. In other embodiment, the rare earth:target material ratio is substantially unchanged over a range of water pH values.

In some embodiments, the rare earth:target material ratio is no more than about 0.1, the rare earth:target material ratio is no more than about 0.2, the rare earth:target material ratio is no more about 0.3, the rare earth:target material ratio is no more than about 0.4, the rare earth:target material ratio is no more than about 0.5, the rare earth:target material ratio is no more than about 0.6, the rare earth:target material ratio is no more than about 0.7, the rare earth:target material ratio is no more than about 0.8, the rare earth:target material ratio is no more than about 0.9, the rare earth:target material ratio is no more than about 1.0, the rare earth:target material ratio is no more than about 1.1, the rare earth:target material ratio is no more than about 1.2, the rare earth:target material ratio is no more than about 1.3, the rare earth:target material ratio is no more than about 1.4, the rare earth:target material ratio is no more than about 1.5, the rare earth:target material ratio is no more than about 1.6, the rare earth:target material ratio is no more than about 1.7, the rare earth:target material ratio is no more about 1.8, the rare earth:target material ratio is no more than about 1.9, the rare earth:target material ratio is no more than about 1.9, or the rare earth:target material ratio is more than about 2.0 at a water pH value of no more than about pH −2, at a water pH value of more than about pH −1, at a water pH value of more than about pH 0, at a water pH value of more than about pH 1, at a water pH value of more than about pH 2, at a water pH value of more than about pH 3, at a water pH value of more than about pH 4, at a water pH value of more than about pH 5, at a water pH value of more than about pH 6, at a water pH value of more than about pH 7, at a water pH value of more than about pH 8, at a water pH value of more than about pH 9, at a water pH value of more than about pH 10, at a water pH value of more than about pH 11, at a water pH value of more than about pH 12, at a water pH value of more than about pH 13, or at a water pH value of more than about pH 14.

In some embodiments, having a rare earth-containing additive that forms an aqueous phase +3 rare earth is advantageous. For example, having an aqueous phase rare earth (+3) provides for an opportunity to take advantage of rare earth (+3) solution phase sorption and/or precipitation chemistries, such as, but not limited to, the formation of insoluble rare earth (+3) compositions with oxyanions. While not wanting to be limited by theory, it is believed that the solution phase rare earth (+3) is substantially dissolved in the aqueous solution and is present as a rare earth (+3) ion. The strong interaction of the +3 rare earth with arsenate is an example of the formation of insoluble rare earth (+3) oxyanion composition. The +3 rare earth may comprise one or more of yttrium (+3), lanthanum (+3), cerium (+3), praseodymium (+3), samarium (+3), europium (+3), gadolinium (+3), terbium (+3), dysprosium (+3), holmium (+3), erbium (+3), thulium (+3), ytterbium (+3), and lutetium (+3). Preferably, the +3 rare earth comprises cerium (+3).

In many applications, cerium is highly effective in removing and/or inhibiting deposition of deposit materials comprising oxyanions. In preferred applications, cerium is highly effective in removing and/or inhibiting deposition of deposit material comprising one or more of phosphate, arsenate, or arsenite. While not wanting to be limited by example, cerium (III) phosphate (CePO₄) has a 1:1 molar ratio and cerium (IV) phosphate (Ce₃(PO₄)₄) has a 1:1.3 molar ratio of cerium to PO₄³⁻. Furthermore, cerium has a 1:1 molar ratio of cerium (III) to both arsenate and arsenite, while cerium (IV) a 1:1.3 molar ratio of cerium (IV) to both arsenate and arsenite.

However, contacting water-soluble cerium derived from CeCl₃, with a phosphate-, arsenate-, arsenite-, antimonate-, bismuthate-containing deposit material produces a deposit-laden cerium composition, typically in the form the deposit-laden cerium composition is in the form of a precipitate having a cerium to oxyanion ratio from about 1:1.3 to about 1:2.6, more commonly from about 1:1.3 to about 1:1, and even more commonly from about 1:1.3 to about 1:1,5. It can be appreciated that the oxyanion comprises one phosphate, arsenate, arsenite, antimonite, bismuthate or one of their protonated forms, or mixture thereof.

While not wishing to be bound by any theory, it is believed that the precipitate formed by contacting a water-soluble cerium (III) salt with a phosphate-containing aqueous solution is a mixture of CePO₄ and Ce₃(PO₄)₄. The cerium may be a substantially water-soluble cerium-containing composition or a substantially water insoluble cerium-containing composition.

In some rare earth-containing additive formulations, a non-rare earth metal and/or metalloid is included with the rare earth-containing additive and/or added separately from the rare earth-containing additive to reduce rare earth requirements. Such metals or metalloids include iron (III), aluminum (III), calcium (II), zirconium, and hafnium salts and mixtures thereof. The non-rare-earth metal or metalloid salt can be added before, concurrent, and/or after one or both of steps 130 and 140. Inclusion of a non-rare earth and/or metalloids can be much less expensive than adding the rare earth-containing additives alone. By way of a non-limiting example, certain forms of phosphate (such as phosphate anion) can be removed by the non-rare-earth metal and/or metalloid while others (such as tripolyphosphates) are not. It can be appreciated that commonly the non-rare earth metal or metalloid may remove certain forms of phosphate to one of a greater, lesser or about equal extend to the rare earth. The molar ratio of the rare earth metal to the non-rare earth metal or metalloid is commonly no more than about 0.75 moles rare earth:1 mole of non-rare earth metal or metalloid, more commonly no more than about 0.50 moles rare earth:1 mole of non-rare earth metal or metalloid, and even more commonly no more than about 0.25 moles rare earth: 1 mole of non-rare earth metal or metalloid. More specifically, non-rare earth metals and/or metalloids can be used to remove some, but not most or all, of target material and the rare earth, particularly cerium (IV), can remove the target material not removed by one or both of the non-rare earth metal and/or metalloid.

Step 150 is an optional step. In step 150, the barren stream may be treated to form a treated barren stream. The treatment can comprise one or more of clarifying, disinfecting, coagulating, aerating, filtering, separating solids and liquids, digesting, and polishing processes. More specifically, the treatment process can commonly comprise one of clarifying, disinfecting, coagulating, aerating, filtering, separating solids and liquids, digesting, and polishing, more commonly any two of clarifying, disinfecting, coagulating, aerating, filtering, separating solids and liquids, digesting, and polishing arranged in any order, even more commonly any three of clarifying, disinfecting, coagulating, aerating, filtering, separating solids and liquids, digesting, and polishing arranged in any order, yet even more commonly any four of clarifying, disinfecting, coagulating, aerating, filtering, separating solids and liquids, digesting, and polishing arranged in any order, still yet even more commonly any five of clarifying, disinfecting, coagulating, aerating, filtering, separating solids and liquids, digesting, and polishing arranged in any order, still yet even more commonly any six of clarifying, disinfecting, coagulating, aerating, filtering, separating solids and liquids, digesting, and polishing arranged in any order, still yet even more commonly any seven of clarifying, disinfecting, coagulating, aerating, filtering, separating solids and liquids, digesting, and polishing arranged in any order, still yet even more commonly any eight of clarifying, disinfecting, coagulating, aerating, filtering, separating solids and liquids, digesting, and polishing arranged in any order, still yet even more commonly any nine of clarifying, disinfecting, coagulating, aerating, filtering, separating solids and liquids, digesting, and polishing arranged in any order, still yet even more commonly any ten of clarifying, disinfecting, coagulating, aerating, filtering, separating solids and liquids, digesting, and polishing arranged in any order, still yet even more commonly any eleven of clarifying, disinfecting, coagulating, aerating, filtering, separating solids and liquids, digesting, and polishing arranged in any order, and yet still even more commonly each of clarifying, disinfecting, coagulating, aerating, filtering, separating solids and liquids, digesting, and polishing arranged in any order. Furthermore, the treatment may or may not include contacting the treated barren stream with cerium (IV) to further remove any target materials contained with the barren stream.

In step 160, the target material-laden rare earth composition is separated from one or both of the barren stream and the treated barren stream to one or both of a separated barren stream and a substantially purified stream. The separated barren stream and the substantially purified stream have a substantially reduced concentration, compared to the target material-containing stream, of one or more of the target materials contained in the target material-containing stream. Preferably, the separated barren stream and the substantially purified stream are one or more of substantially lacking, devoid and free, compared to the target material-containing stream, of one or more of the target materials contained in the target material-containing stream. The target material-laden rare earth composition can be separated from the one or both of the barren stream and the treated barren stream by any suitable solid liquid separation process. Non-limiting examples of suitable solid liquid separation processes are clarification (including thickening) filtration (including vacuum and/or pressure filtering), cyclone (including hydrocyclones), floatation, sedimentation (including gravity sedimentation), coagulation, flocculation and combinations thereof. In some embodiments, the target material-laden rare earth composition is separated from one or both of the barren stream and the treated barren stream to one or both of a separated barren stream and a substantially purified stream by a sequential series of solid liquid separating processes. Furthermore, in some embodiments, cerium (IV) can be contacted with the one or both of the barren and the treated barren streams to remove any target materials contained within the streams. When the separation process comprises a sequential series of solid liquid separations, the cerium (IV) is preferably contacted with the one or both of the barren and the treated barren streams comprising the earlier, that is upstream, rather than the later, that is downstream, of the solid liquid separations comprising the sequential series.

Step 170 is an optional step. In step 170, the separated barren stream may be post-treated to form a substantially purified stream. Preferably, the purified stream comprises substantially purified water. The post-treatment can comprise one or more of clarifying, disinfecting, coagulating, aerating, filtering, separating solids and liquids, digesting, and polishing processes. More specifically, the post-treatment process can commonly comprise one of clarifying, disinfecting, coagulating, aerating, filtering, separating solids and liquids, digesting, and polishing, more commonly any two of clarifying, disinfecting, coagulating, aerating, filtering, separating solids and liquids, digesting, and polishing arranged in any order, even more commonly any three of clarifying, disinfecting, coagulating, aerating, filtering, separating solids and liquids, digesting, and polishing arranged in any order, yet even more commonly any four of clarifying, disinfecting, coagulating, aerating, filtering, separating solids and liquids, digesting, and polishing arranged in any order, still yet even more commonly any five of clarifying, disinfecting, coagulating, aerating, filtering, separating solids and liquids, digesting, and polishing arranged in any order, still yet even more commonly any six of clarifying, disinfecting, coagulating, aerating, filtering, separating solids and liquids, digesting, and polishing arranged in any order, still yet even more commonly any seven of clarifying, disinfecting, coagulating, aerating, filtering, separating solids and liquids, digesting, and polishing arranged in any order, still yet even more commonly any eight of clarifying, disinfecting, coagulating, aerating, filtering, separating solids and liquids, digesting, and polishing arranged in any order, still yet even more commonly any nine of clarifying, disinfecting, coagulating, aerating, filtering, separating solids and liquids, digesting, and polishing arranged in any order, still yet even more commonly any ten of clarifying, disinfecting, coagulating, aerating, filtering, separating solids and liquids, digesting, and polishing arranged in any order, still yet even more commonly any eleven of clarifying, disinfecting, coagulating, aerating, filtering, separating solids and liquids, digesting, and polishing arranged in any order, and yet still even more commonly each of clarifying, disinfecting, coagulating, aerating, filtering, separating of solids and liquids, digesting, and polishing arranged in any order. Preferably, the post-treatment process comprises one of sand bed filtering process, clarifying process, polishing process, separating of solids and liquids, or combination thereof. More preferably, the post-treatment process comprises sand bed filtering. Furthermore, the post-treatment may or may not include contacting the separated barren stream with cerium (IV) to further remove any target materials contained with the separated barren stream.

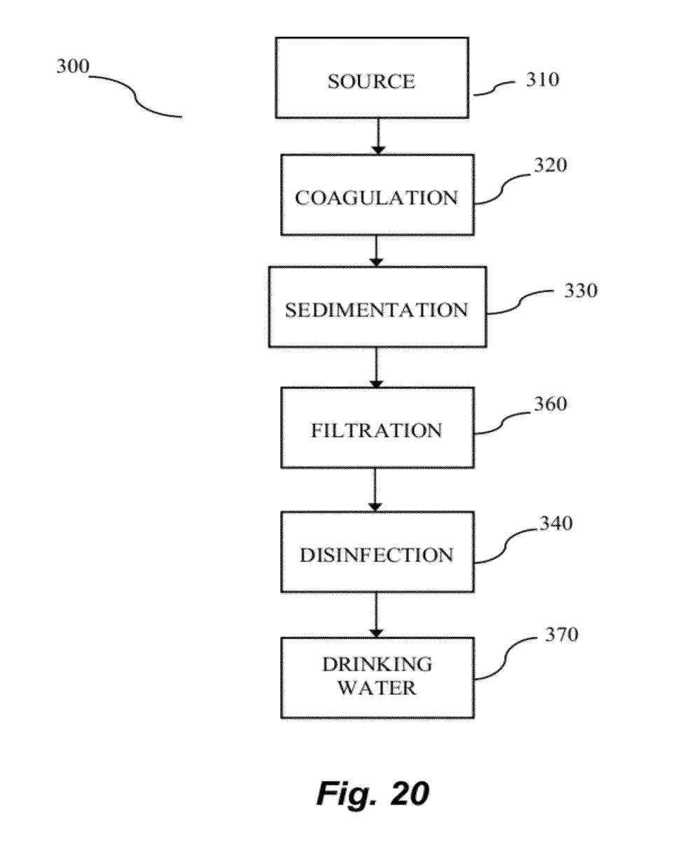

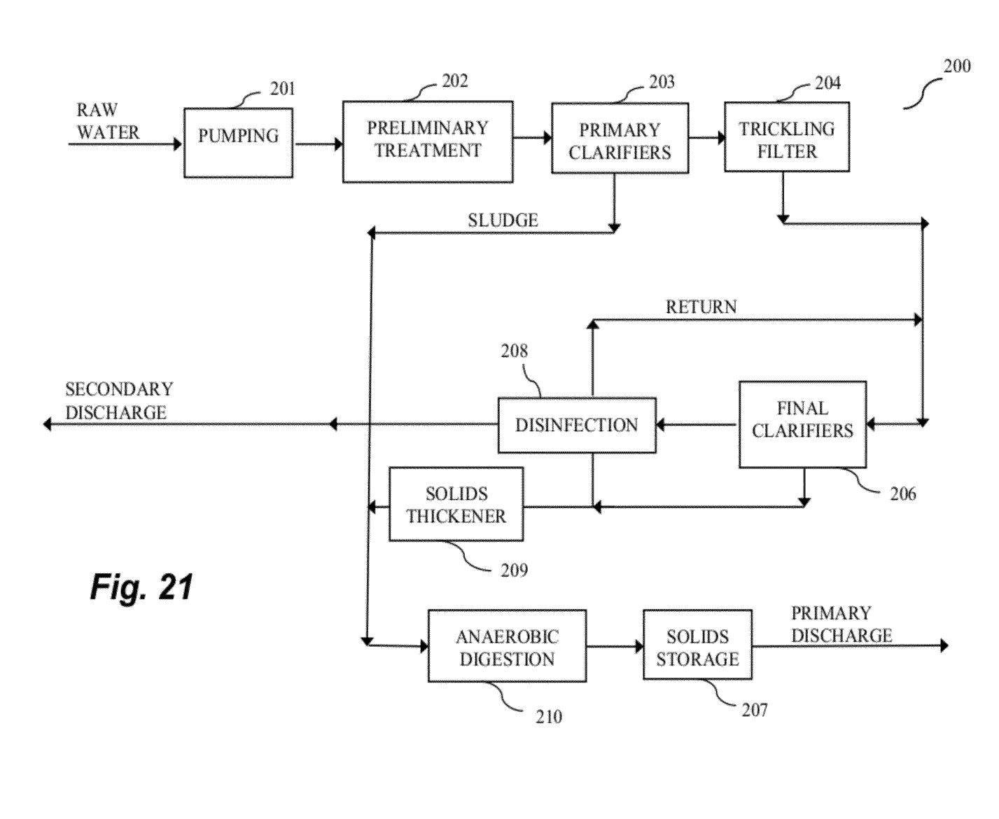

FIG. 20 depicts a typical municipal drinking water handling system 300 for treating water source 310 to form purified drinking water. The water handling system 300 includes the water source 310, and one or more of coagulation process 320, disinfection process 340, sedimentation process 330, and filtration process 360. It can be appreciated that the water source 210 and the one or more of coagulation 320, disinfection 340, sedimentation 330, and filtration 360 processes are in fluid communication. The water source 310 can be any fluid stream, preferably the water source comprises a target material-containing stream. Non-limiting sources in river, lakes, wells, raw or treated wastewater, aquifers, ground water, and such. In some embodiments, the water handling system 300 comprises a water source 310 in fluid communication with the coagulation process 320. The coagulation process 320 removes dirt and other particles suspended in the water derived from the water source 310. Alum and/or other coagulation/flocculation chemicals are added to the derived water to form a coagulum and/or flocculated particles comprising the coagulation/flocculation chemicals and the dirt and/or other particles. The coagulum and/or flocculated particles are suspended in the derived water. After the coagulation process 320 the water containing the coagulum and/or flocculated particles suspended in the derived water is transferred to the sedimentation process 330. It can be appreciated that, the coagulation 320 and sedimentation 330 processes are in fluid communication. The sedimentation comprises a solids/liquid separation process. More specifically, the coagulum and/or flocculated particles are typically more dense than the derived water. The denser coagulum and/or flocculated particles settle to the bottom of the sedimentation vessel and a substantially sediment-free water is formed. The substantially sediment-free water is transferred to a filtration process 360. The sedimentation 330 and filtration 360 processes are in fluid communication. The substantially sediment-free water is subjected to one or more filtering process to remove substantially most, if not all, particulates from the sediment-free water to form substantially particulate-free water in filtration process 360. Typically, the filtration process 360 comprises one or more of sand and/or gravel filter beds, carbon, charcoal and/or active carbon filters to name few. The substantially particle-free fee water is transferred to a disinfection process 340. The disinfection 340 and filtration 360 process are in fluid communication. The disinfection process can be any disinfection process. The disinfection process kills any bacteria and/or microorganism in the water to form drinking water. Some municipal water treatment processes further include a fluorination and/or polishing processes (not depicted in FIG. 20) after the disinfection process 360. The after one or more of the disinfection 360 and one or both of the fluorination and polishing processes the drinking water is dispersed to the end-user. In some embodiments, the rare earth-containing additive and/or cerium (IV) can be contacted with the water and/or target material prior to, during, or after the coagulation process 320. In some embodiments, the rare earth-containing additive and/or cerium (IV) may be contacted with the water and/or target material prior to, during, or after the sedimentation process 330. In some embodiments, the rare earth-containing additive and/or cerium (IV) may be contacted with the water and/or target material prior to, during, or after the filtration process 360. In some embodiments, where the disinfection process comprises a disinfecting material that can be precipitated and/or sorbed by the rare earth-containing additive and/or cerium (IV) at least most, if not substantially all, of the rare earth-containing additive or cerium (IV) is remove from the water prior to the disinfection process 340. However, if the disinfection comprises a disinfecting material that is not substantially, or is not all, precipitated and/or sorbed by the rare earth-containing additive and/or cerium (IV) it is not necessary to remove them prior to the disinfecting process 340. Furthermore, in such instances, one or both of rare earth-containing additive and cerium (IV) may be may be contacted with the water and/or target material prior to, during, or after the disinfection process 340. Furthermore, when the water handling system 300 comprises a fluorination process it is desirous to remove at least most, if not substantially all, of the rare earth containing additive and/or cerium (IV) before the fluorination process. Rare earths typically form substantially insoluble-complexes with fluoride (F¹⁻) and can interfere with the fluorination process. Additionally, one or more steps, other than rare earth-containing additive addition and/or cerium (IV), can be omitted to meet the requirements of a specific application. Furthermore, the cerium (IV) may or may not formed by an in situ process any one or more of coagulation process 320, disinfection process 340, sedimentation process 330, and filtration process 360.

FIG. 23 depicts a typically wastewater water handling system 200 for treating wastewater. The wastewater handling system 200 comprises one or more of a pumping process 201, preliminary treatment process 202, primary clarifier process 203, trickling filter process 204, final clarifier process 206, disinfection process 208, solid thickener 209, anaerobic digestion process 210, and solid storage process 207. It can be appreciate that the one or more a pumping 201, preliminary treatment 202, primary clarifier 203, trickling filter 204, final clarifier 206, disinfection 208, solid thickener, anaerobic digestion 210, and solid storage 207 processes are in fluid communication. A raw water comprising may be any fluid stream. Preferably, the raw water source comprises a target material-containing stream. Non-limiting examples of suitable raw water sources are municipal waters, wastewaters, well waters, septic waters, drinking waters, and naturally occurring waters. Typical wastewaters include without limitation municipal and/or agricultural run-off waters, septic waters, waters formed and/or generated during an industrial and/or manufacturing process, waters formed and/or generated by a medical facility, waters associated with mining, mineral production, recovery and/or processing (including petroleum), evaporation pound waters, and non-potable disposal waters. The raw water is transported typically from the raw water source to the preliminary treatment process 202 by pumping process 201. The pumping process 201 can be any type of fluid pumping or transporting process. The transporting process can include gravity free, trucking, piping, or any other fluid transporting processes. The preliminary treatment process 202 may include one or more of pH adjustment, filtration process, solid/liquid separating process, temperature adjustment, or such to form a pre-treated water. The preliminary treatment process 202 substantially prepares and conditions the water for the primary clarifier 203. The primary clarifier 203 is typically a coagulation process to remove particles suspended in the pre-treated water. Coagulation and/or flocculation chemicals are added to the pre-treated water to form a coagulum comprising the coagulation and/or flocculation chemicals and the particles. The coagulum is suspended in the pre-treated water. After the clarifier 203 the water containing the coagulum suspended in the pre-treated water is transferred to one or both of a secondary discharge and to a further treatment process. The further treatment process comprises the trickling filter 204 and/or anaerobic digestion 210 processes. Typically, the trickling filter 204 and anaerobic digestion 210 processes comprises microbes that removed contaminants from the pre-treated water. The trickling filter 204 typically comprises microbes attached to a support such as sand, gravel, pebbles or other support material. The anaerobic digestion process 201 contains bacteria and/or other microbes that consume contaminants in the absence of oxygen to form a digested-water. The digested-water is transferred to a solids storage process 207. Typically, the solid storage process 207 is a solids/liquid separation process that separates coagulum and other solids contained in the digested-water to form a primary water for discharge. The primary water is typically suitable for land application. Returning to the trickling filter 204, the support can remove the coagulum and the microbes, such as bacteria and algae remove organic and inorganic contaminants to form a filtered-water. The first-filtered water is transferred to final clarifier process 206. The filtered-water contains particles suspended within it. The final clarifier is similar to the primary clarifier, that is coagulation and/or flocculation chemicals are added to the filtered-water to form a final coagulum comprising the coagulation and/or flocculation chemicals and the particles. The final coagulum is separated from the filter-water in the final clarifier to form a separated-coagulum and a clarified water. The clarified water is transferred to disinfection process 208. The disinfection process 208 can be any disinfection process. The disinfection process 208 kills any bacteria and/or microorganism in the water to form disinfected water. In some embodiments, disinfected water is transferred to secondary discharge. In some embodiment, the disinfected water is transferred to the anaerobic digestion process 210 to be further treated and form a primary discharge. In some embodiments, the disinfected water is transferred to the final clarifier for further clarification. Returning to the separated coagulum formed in the final clarifier, the separated coagulum is transferred to the solids thickener process 209. The solids thickener process 209 is a solids/liquid separation process that separates coagulum and other solids for a sludge and a substantially sludge-free water. The substantially sludge-free can be discharged a second discharge water or transferred to the anaerobic digestion process 210. The rare earth-containing additive and/or cerium (IV) can contacted with one or target materials prior to, during and/or after one or more of the pumping process 201, the preliminary treatment process 202, the primary clarifier process 203, the final clarifier process 206, the solids thickener process 209, and the solids storage process 207 to remove and/or detoxify one or more target materials contained in the water handling system 200 water being processed. It can be appreciated that the any rare earth-containing additive and/or cerium (IV) contained in the water should preferably be substantially removed from the water prior to water being charged the disinfection process 208, trickling filter process 204, and/or anaerobic digestion process 210 when the microbes and/or disinfection process disinfecting agent can be killed, destroyed and/or deactivated by one or both of the rare earth-containing additive and cerium (IV). However, the rare earth-containing additive and/or cerium can be contacted with the target material prior to and/or during the disinfection process if the disinfecting agent is not removed and/or sorbed by the rare earth-containing additive and/or cerium (IV). Moreover, the rare earth-containing additive and/or cerium (IV) can be contacted with the target material prior to and/or cerium (IV) the anaerobic digestion process 210 and/or trickling filter process 204 if the microbes and/or algae are not killed, destroyed, precipitated and/or sorbed by the rare earth-containing additive and/or cerium (IV). Additionally, one or more steps, other than rare earth-containing additive addition and/or cerium (IV), can be omitted to meet the requirements of a specific application. Furthermore, the cerium (IV) may or may not formed by an in situ process any one or more the pumping process 201, preliminary treatment process 202, primary clarifier process 203, trickling filter process 204, final clarifier process 206, disinfection process 208, solid thickener 209, anaerobic digestion process 210, and solid storage process 207.

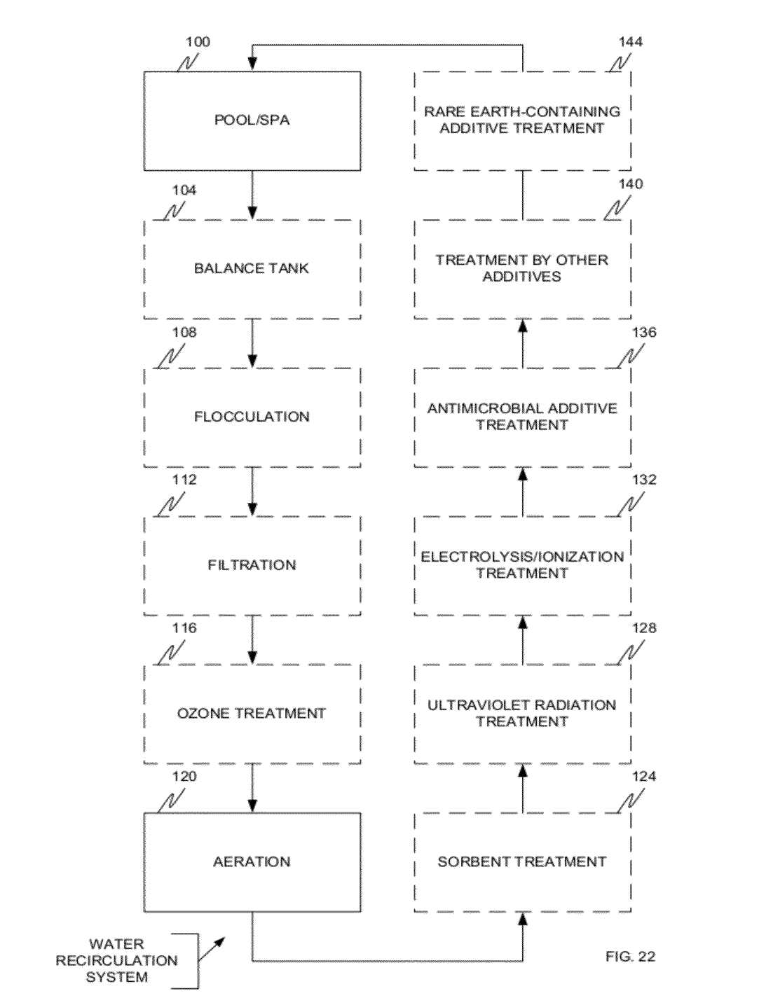

FIG. 22 depicts a typical water recirculation system for a pool, hot tub, or spa 100. Pools include above-ground, fiberglass, vinyl-lined, gunite, and poured-concrete pools. Hot tubs, spas, and therapy pools generally have hotter water than swimming and bathing pools but can have similar water treatment elements in their respective water recirculation systems. The water recirculation systems generally pump water to be treated in a continual cycle from the pool, hot tub, or spa through various water treatment elements to remove selected contaminants or target materials and back to the pool, hot tub, or spa again. The treatment elements, typically, remove dangerous pathogens, such as bacteria and viruses, and biological materials, maintain chemical balance of the water to inhibit damage to the components of the pool, hot tub, or spa and irritation of or harm the health of swimmers or bathers, and maintain water clarity. In some pool, hot tub, or spa designs, a disinfectant, such as a halogen (with chlorine being common), is used to kill pathogens. While an ordering of steps is depicted in FIG. 1, it is to be understood that the steps can be rearranged in innumerable ways to meet the requirements of a specific application. Additionally, one or more steps, other than rare earth-containing additive addition and/or cerium (IV), can be omitted to meet the requirements of a specific application.

Water to be treated from the pool, hot tub, or spa 100 optionally flows through one or more drains and particle removal screens (strainer baskets) (to remove debris such as leaves, suntan oil, hair, and other objects) (not shown) to a balance tank 104. The drains can be in the bottom and/or sides of the pool, hot tub, or spa 100. A balance tank 100 is used in pools that do not use skimmer boxes. It stores excess water generated from the displacement of swimmers' bodies. A pool with a balance tank maintains a substantially constant depth regardless of how many people are in the pool. Once swimmers exit the pool, the extra water that the balance tank has been holding returns to the pool, and the balance tank returns to its normal operating level. The balance tank can also be fitted with an equalizing and control valve (not shown) and can be an advantageous location to dose chemicals.

Water to be treated from the balance tank 104 is contacted with one or more flocculants in step 108 to remove visible floating particles of organic matter, such as skin tissue, saliva, soap, cosmetic products, skin fats, and textile fibers, and control turbidity. As will be appreciated, flocculation is a process where colloids come out of suspension in the form of floc or flakes (which are formed by particulates clumping together). This action can differ from precipitation in that, prior to flocculation, colloids are simply suspended in a liquid and not actually dissolved in a solution. Suitable flocculants include alum, aluminum chlorohydrate, iron, calcium, magnesium, polyacrylamides, poly(acrylamide-co-acrylic acid), poly(acrylic acid), poly(vinyl alcohol), aluminum sulfate, calcium oxide, calcium hydroxide, iron (II) sulfate, iron (III) chloride, polyDADMAC, sodium aluminate, sodium silicate, chitosan, isinglass, moring a seeds, gelatin, strychnos, guar gum, and alginates.

After flocculation (step 108), the water to be treated, in filtration step 112, is passed through a filter to remove flocs, flakes and other solid material that was not removed by the strainer basket (not shown). An exemplary filter is a high-rate sand filter. Other exemplary filters include a diatomaceous earth filter or cartridge filter. Other volume and settling filters may be used.

The filtered water, in step 116, is optionally contacted with ozone (O₃) from an ozone generator. Ozone oxidizes most metals (except for gold, platinum, and indium), nitric oxide to nitrogen dioxide, carbon to carbon dioxide, and ammonia to ammonium nitrate. Ozone can decompose urea and disinfect the water to be treated. Ozone readily oxidizes cerium (III) salts to cerium (IV) oxide. Ozone can be dosed to the full recycle stream of the water to be treated or only a portion, or side stream, of the recycle stream. The concentration of ozone in the recycle stream after step 116 typically ranges from about 0.01 g/m³ to about 15 g/m³, more typically from about 0.1 g/m³ to about 10 g/m³, more typically from about 0.25 g/m³ to about 7.5 g/m³, more typically from about 0.25 g/m³ to about 5 g/m³, and even more typically from about 0.40 g/m³ to about 2.0 g/m³.

In step 120, the water to be treated is optionally aerated, such as by induced air, Aeration is performed in spas, by the venturi effect, for a massage effect of bathers. It is believed that is some configurations aeration could oxidize cerium (III) to cerium (IV) oxide.

In optional step 124, a sorbent 124 is contacted with the water to be treated to remove selected contaminants. The sorbent 124 can be, for example, granular activated carbon, powdered activated carbon, zeolites, clays, and diatomaceous earth.

The recirculated water is, in optional step 128, contacted with ultraviolet light to kill pathogens and other microscopic and macroscopic organisms, particularly algae. As will be appreciated, ultraviolet light is electromagnetic radiation with a wavelength shorter than that of visible light, commonly in the range of from about 10 nm to about 400 nm. Ultraviolet light can be generated by an ultraviolet fluorescent lamp, ultraviolet LED, ultraviolet laser, and the like. Ultraviolet light can oxidize chemical compounds. By way of example, ultraviolet light oxidizes cerium (III) salts to cerium (IV) oxide. While not wishing to be bound by any theory, ultraviolet light can form an excited state or states of cerium (III) or cerium (IV).

The recirculated water, in optional step 132, is subjected to electrolysis and/or ionized by an ionizer. Electrolysis or ionization can form free oxygen in situ. In one configuration, oxidation is achieved by passing the water to be treated through a chamber while low voltage electric current is passed to conductive (titanium) plates in a chamber. The process causes the electro-physical separation of the water to be treated into free oxygen atoms and hydroxyl ions. This step can readily oxidize cerium (III) salts to cerium (IV) oxide.

An antimicrobial additive can optionally be added in step 136. Examples of antimicrobial additives include disinfecting agents, such as chlorine or bromine (in the form of calcium or sodium hypochlorite or hypobromite or hypochlorous or hypobromous acid), chlorine dioxide, chlorine gas, iodine, bromine chloride, metal cations (e.g., Cu²⁺ and Ag⁺), potassium permanganate (KMnO₄), phenols, alcohols, quaternary ammonium salts, hydrogen peroxide, brine, and other mineral sanitizers.

The antimicrobial additive can be added anywhere in the recirculation system. It is generally added downstream of filtration 112 using a chemical feeder or doser. Alternatively, it can be added directly to the pool using tablets in the skimmer boxes.

In optional step 140, other (non-rare-earth-containing) additives can be added. Other additives include buffers, chelators, water softening agents, and pool shock additives (such as high doses of potassium monopersulfate or granulated chlorine). Other additives, for example, maintain the water chemistry requirement(s), particularly the pH, total alkalinity, and calcium hardness. Pool shock additives can oxidize cerium (III) salts to cerium (IV) oxide.

The rare earth-containing additive is added in step 144, and the treated water thereafter reintroduced into the pool/spa 100. Although the rare earth-containing additive is shown as being added in a particular location, it will be understood by one of ordinary skill in the art that the rare earth-containing additive can be added anywhere in the water recirculation system. For example, the rare earth-containing additive can be added directly to the pool/spa 100, to the balance tank 104, during or after flocculation (step 198), upstream of filtration (step 112) or during filtration, such as by incorporation into the filter (not shown), before, during, or after ozone generation (step 116) or aeration (step 120), before or during sorbent treatment (step 124), such as by co-addition with the sorbent or incorporation or integration into the sorbent matrix, before, during or after ultraviolet treatment (step 128), before, during, or after electrolysis/ionization (step 132), before, during or after antimicrobial additive treatment (step 136), and before, during, or after addition of other additives (step 140).

In accordance with some embodiments, cerium (IV), typically in the form of cerium (IV) oxide, may be formed in situ, or within the water, from cerium (III) oxidation during ozone treatment (step 116), aeration (step 120), ultraviolet radiation treatment (step 128), electrolysis/ionization treatment (step 132), antimicrobial additive treatment (step 136), and treatment by other additives (step (140). Alternatively, cerium (IV) can be formed by contacting a rare earth composition with an oxidant.

Although in situ oxidation of cerium (III) salts to cerium (IV) can cause nanoparticles of cerium (IV) oxide to be formed, thereby introducing turbidity into the water to be treated, the nanoparticles can disperse through the water to be treated in the water recirculation system and collect advantageously on the filter. Turbidity may be introduced into the pool/spa 100 if cerium (IV) is formed in or upstream of the pool/spa 100 without intermediate filtration. Addition of a cerium (III) salt and oxidation of the cerium (III) to cerium (IV) can occur between the pool/spa 100 and filtration step 112 to capture finely sized particulates before they are introduced into the pool/spa 100. As noted, the filtration step 112 can be relocated or a second filtration step (not shown) introduced after rare earth-containing additive treatment for this purpose. In the latter event, the second filtration step could include a finely sized solids filter, such as a semi-permeable, partly porous, membrane filter (e.g., reverse osmosis filter, nanofilter, ultrafilter, or microfilter), a carbon block filter, or other suitable finely sized solids filter to remove at least most of the cerium (III) phosphate, cerium (IV) oxide nanoparticles, and target material-loaded cerium (IV) oxide particles from the water to be recirculated to the pool/spa 100.

Each of the waters comprising each of the clarifying, disinfecting, coagulating, aerating, filtering, separating solids and liquids, digesting, and polishing processes have a pH value. The pH value of each of the waters comprising each of the clarifying, disinfecting, coagulating, aerating, filtering, separating solids and liquids, digesting, and polishing processes can vary; commonly, the pH may be from about pH 0 to about pH 14, more commonly the pH of may be from about pH 1 to about pH 13, even more commonly the pH may be from about pH 2 to about pH 12, even more commonly the pH may be from about pH 3 to about pH 11, yet even more commonly the pH may be from about pH 4 to about pH 10, still yet even more commonly the pH may be from about pH 5 to about pH 9, or still yet even more commonly the pH may be from about pH 6 to about pH 8. In some configurations, the pH value is commonly about pH 0, more commonly the pH value is about pH 1, even more commonly the pH value is about pH 2, yet even more commonly the pH value is about pH 3, still yet even more commonly the pH value is about pH 4, still yet even more commonly the pH value is about pH 5, still yet even more commonly the pH value is about pH 6, still yet even more commonly the pH value is about pH 7, still yet even more commonly the pH value is about pH 8, still yet even more commonly the pH value of one and/or both of a target material-containing stream and the aqueous solution other the target material-containing stream are about pH 9, still yet even more commonly the pH value is about pH 10, still yet even more commonly the pH value is about pH 11, still yet even more commonly the pH value is about pH 12, still yet even more commonly the pH value is about pH 13, or still yet even more commonly the pH value is about pH 14.

Each of the waters comprising each of the clarifying, disinfecting, coagulating, aerating, filtering, separating solids and liquids, digesting, and polishing processes have a solution temperature. The solution temperature of can vary depending on the water (that is, commonly, the solution temperature is ambient temperature. Typically, the solution temperature ranges from about −5 degrees Celsius to about 50 degrees Celsius, more typically from about 0 degrees Celsius to about 45 degrees Celsius, yet even more typically from about 5 degrees Celsius to about 40 degrees Celsius and still yet even more typically from about 10 degrees Celsius to about 35 degrees Celsius. It can be appreciated that each of the waters comprising each of the clarifying, disinfecting, coagulating, aerating, filtering, separating solids and liquids, digesting, and polishing processes may include optional processing units and/or operations that heat and/or cool one or more of each of the waters. In some configurations, each of the waters may be heated to have a temperature of typically at least about 20 degrees Celsius, more typically at least about 25 degrees Celsius, even more typically at least about 30 degrees Celsius, yet even more typically of at least about 35 degrees Celsius, still yet even more typically of at least about 40 degrees Celsius, still yet even more typically of at least about 45 degrees Celsius, still yet even more typically of at least about 50 degrees Celsius, still yet even more typically of at least about 60 degrees Celsius, still yet even more typically of at least about 70 degrees Celsius, still yet even more typically of at least about 80 degrees Celsius, still yet even more typically of at least about 90 degrees Celsius, still yet even more typically of at least about 100 degrees Celsius, still yet even more typically of at least about 110 degrees Celsius, still yet even more typically of at least about 120 degrees Celsius, still yet even more typically of at least about 140 degrees Celsius, still yet even more typically of at least about 150 degrees Celsius, or still yet even more typically of at least about 200 degrees Celsius. In some configurations, each of the waters comprising each of the clarifying, disinfecting, coagulating, aerating, filtering, separating solids and liquids, digesting, and polishing processes may be cooled to have a temperature of typically of no more than about 110 degrees Celsius, more typically of no more than about 100 degrees Celsius, even more typically of no more than about 90 degrees Celsius, yet even more typically of no more than about 80 degrees Celsius, still yet even more typically of no more than about 70 degrees Celsius, still yet even more typically of no more than about 60 degrees Celsius, still yet even more typically of no more than about 50 degrees Celsius, still yet even more typically of no more than about 45 degrees Celsius, still yet even more typically of no more than about 40 degrees Celsius, still yet even more typically of no more than about 35 degrees Celsius, still yet even more typically of no more than about 30 degrees Celsius, still yet even more typically of no more than about 25 degrees Celsius, still yet even more typically of no more than about 20 degrees Celsius, still yet even more typically of no more than about 15 degrees Celsius, still yet even more typically of no more than about 10 degrees Celsius, still yet even more typically of no more than about 5 degrees Celsius, or still yet even more typically of no more than about 0 degrees Celsius.

As used herein cerium (III) may refer to cerium (+3), and cerium (+3) may refer to cerium (III). As used herein cerium (IV) may refer to cerium (+4), and cerium (+4) may refer to cerium (IV).

### EXAMPLES

The following examples are provided to illustrate certain embodiments and are not to be construed as limitations on the embodiments, as set forth in the appended claims. All parts and percentages are by weight unless otherwise specified.

### Example 1

This example is to the formation of insoluble cerium (IV) by the contacting of water-soluble cerium (III) with and oxidizing agent. The oxidizing agent is an aqueous solution containing chlorine. Two aqueous solutions of cerium (III) were prepared from cerium (III) chloride, one solution was about 1×10−3 M and the other aqueous solution was about 1×10−4 M in cerium (III). The 1×10−3 M cerium (III) solution was contacted with an aqueous solution containing 100 ppm chlorine and the 1×10−4 M cerium (III) solution was contacted with an aqueous solution containing 10 ppm chlorine. After each of the cerium (III) solutions with the respective chlorine solutions, the solutions were filtered and the filtrate was subject to an x-ray diffraction analysis. FIG. 1 (a)-(c) depict the x-ray diffraction analysis before and after contacting the cerium (III) containing solutions with the aqueous solutions containing chlorine. FIG. 1(b) is the x-ray diffraction pattern indicative of cerium (IV) oxide, CeO2. That is, the x-ray diffraction pattern contained peaks at about 28, 32.5, 47 and 56 Cu-2-theta. In other words, the 100 ppm chlorine solution substantially oxidized the cerium (III) contained in the 1×10−3 M cerium (III) solution to produce substantially enough cerium (IV) to obtain an x-ray diffraction of the formed cerium (IV), that is an x-ray diffraction pattern indicative of CeO2. Similarly the 1×10−3 M and 1×10−4 M cerium (III), prior to contacting with the chlorine solutions, were filtered and the resulting filtrates were analyzed by x-ray diffraction analysis, see FIGS. 1(a) and (d), neither cerium (III) solution contained detectable amounts of cerium (IV). FIG. 1 (d) depicts the x-ray diffraction analysis of filtrate obtained from the 1×10−4 M cerium (III) solution after being contacted with 10 ppm chlorine solution. The x-ray diffraction pattern lacks peaks at about 28, 32.5, 47 and 56 Cu-2-theta. In other words, either cerium (IV) oxide was not formed or the amount of cerium (IV) oxide formed is less than or about equal to the signal-to-noise level in the x-ray diffraction analysis. That is, the amount of cerium (IV) formed is below the detection limit of the x-ray diffraction analysis procedure. Similarly, aeration of 1×10⁻³ M and 1×10−4 M cerium (III) solutions (that is bubbling air through the solutions) did not produce detectable amounts of cerium (IV) oxide.

### Example 2

A set of tests were conducted to determine a maximum arsenic loading capacity of soluble cerium (III) chloride CeCl₃ in an arsenic-containing stream to reduce the arsenic concentration to less than 50 ppm. As shown by Table 1, arsenic-containing streams (hereinafter alkaline leach solutions) tested had the following compositions:

TABLE 1

| | Volume | | | | |
|---|---|---|---|---|---|
| Test | of DI | Na₂CO₃ | Na₂SO₄ | Na₂HAsO₄—7H₂O | As |
| Number | (mL) | (g) | (g) | (g) | g/L |
| 1 | 500 | 10 | 8.875 | 1.041 | 0.5 |
| 2 | 500 | 10 | 8.875 | 2.082 | 1 |
| 3 | 500 | 10 | 8.875 | 4.164 | 2 |
| 4 | 500 | 10 | 8.875 | 6.247 | 3 |
| 5 | 500 | 10 | 8.875 | 8.329 | 4 |
| 6 | 500 | 10 | 8.875 | 10.411 | 5 |
| 7 | 500 | 10 | 8.875 | 12.493 | 6 |

The initial pH of the seven alkaline leach solutions was approximately pH 11, the temperatures of the solutions were approximately 70 to 80° C., and the reaction times were approximately 30 minutes.

Seven alkaline leach solutions were made with varying arsenic (V) concentrations, which can be seen in Table 1 above. Each solution contained the same amount of sodium carbonate (20 g/L) and sodium sulfate (17.75 g/L). In a first series of tests, 3.44 mL of cerium chloride (CeCl₃) were added to every isotherm and equates to 0.918 g CeO₂ (approximately 0.05 mole Ce) In a second series of tests, 6.88 mL of cerium chloride was added to every test and equates to 1.836 g CeO₂ (approximately 0.1 mole Ce). Below is the guideline on how each isotherm test was performed.

In a first step, 200 mL of solution were measured out by weight and transferred into a 400 mL Pyrex beaker. The beaker was then placed on hot/stir plate and heated to 70-80° C. while being stirred.

In a second step, 3.44 mL of cerium chloride were measured out, by weight, and poured into the mixing beaker of hot alkaline leach solution. Upon the addition of cerium chloride, a white precipitate formed instantaneously. To ensure that the white precipitate was not cerium carbonate [Ce₂(CO₃)₃.xH₂O], step three was performed.

In the third step, 4.8 mL of concentrated HCl were slowly added dropwise. Fizzing was observed. The solution continued to mix for 30 minutes and was then allowed to cool for 4 hours before sampling.

The results are shown in Table 2:

Analysis Using ICP-AES

TABLE 2

| Approx- | | | | | | |
|---|---|---|---|---|---|---|
| imate | | Molar | Final As | | Loading | Percent |
| Moles of | | Ratio | Concen- | Arsenic | Capac- | Arsenic |
| Cerium | Arsenic | (Ce/ | tration | Removed | ity | Re- |
| Added | (g/L) | As) | (mg/L) | (mg) | (mg/g) | moved |
| 0.005 | 0.5 | 4.2 | 0 | 100 | 104 | 100 |
| | 1.0 | 2.1 | 8 | 199 | 206 | 99 |
| | 2.0 | 1.0 | 159 | 367 | 380 | 92 |
| | 3.0 | 0.7 | 903 | 412 | 426 | 69 |
| | 4.0 | 0.5 | 1884 | 408 | 422 | 51 |
| | 5.0 | 0.4 | 2663 | 445 | 461 | 45 |
| | 6.0 | 0.4 | 3805 | 409 | 422 | 34 |
| 0.01 | 0.5 | 8.3 | 0 | 102 | 53 | 100 |
| | 1.0 | 4.2 | 0 | 201 | 104 | 100 |
| | 2.0 | 2.1 | 55 | 388 | 201 | 97 |
| | 3.0 | 1.4 | 109 | 577 | 299 | 96 |
| | 4.0 | 1.1 | 435 | 709 | 367 | 89 |
| | 5.0 | 0.8 | 1149 | 759 | 392 | 76 |
| | 6.0 | 0.7 | 1861 | 810 | 419 | 67 |

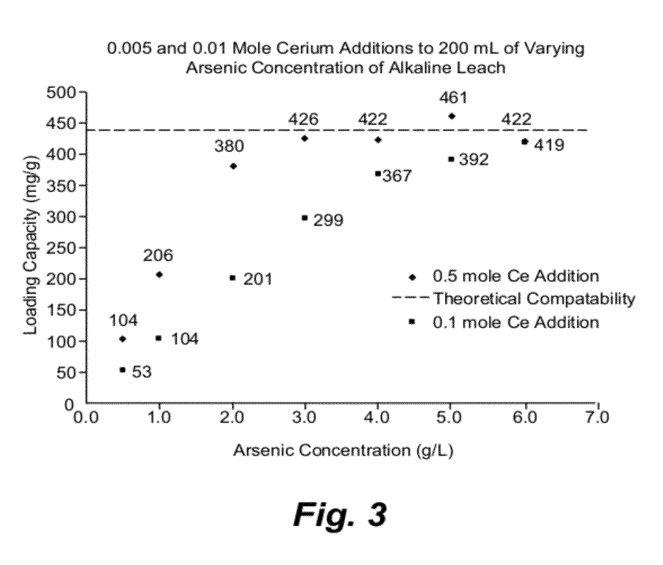

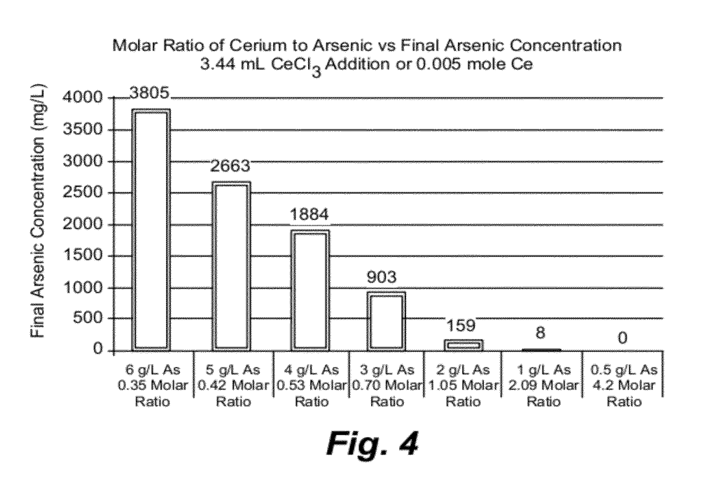

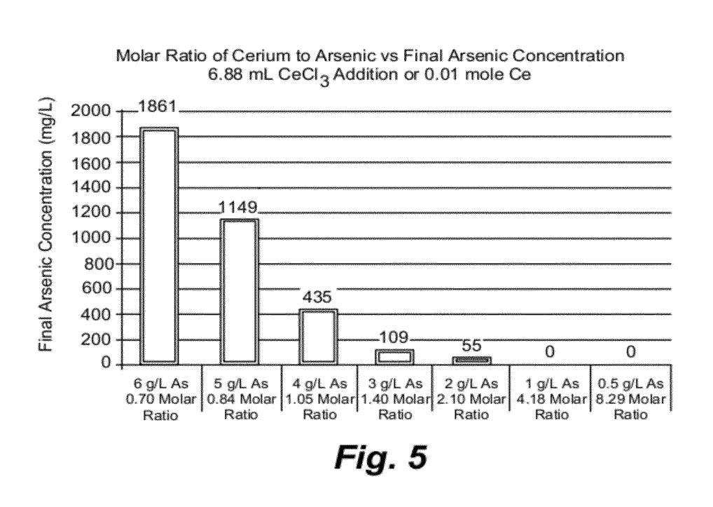

FIG. 3 shows that the loading capacity begins to level off at the theoretical capacity of 436 mg/g if cerium arsenate (CeAsO₄) was formed, leading one to believe it was formed. FIG. 4 displays that the molar ratio of cerium to arsenic required to bring down the arsenic concentration to less than 50 ppm lies somewhere between a 1 molar and 2 molar ratio. However, at a 2 molar ratio a loading capacity of 217 was achieved. FIG. 5 shows very similar results (essentially double the addition of CeCl₃); at a molar ratio between 1 and 2, the dissolved arsenic concentration can be below 50 ppm. This capacity may be improved with a lower molar ratio and tighter pH control.

### Example 3

In another experiment, 40 grams of cerium (IV) dioxide particles were loaded into a f-inch column giving a bed volume of approximately 50 ml. The cerium dioxide bed had an arsenic-containing process stream [75% As(V), 25% As (III)] flowed through the bed and successfully loaded the media with approximately 44 mg of arsenic per gram CeO₂ or with approximately 1,700 mg of arsenic total added to the column. Following this, the arsenic loaded cerium dioxide bed had the equivalent of six bed volumes of 5% NaOH solution passed through the bed, at a flow rate of 2 mL/min. This solution released approximately 80% of the 44 mg of arsenic per gram CeO₂. Subsequently, the same cerium media was then treated again with the arsenic contaminated process stream [75% As(V), 25% As(III)], loading the media with another 25 mg of arsenic per gram CeO₂ or with another 1,000 mg of arsenic. This experiment demonstrates how to regenerate, and thereby prolong the life of, the insoluble fixing agent and shows that the pH of the arsenic-containing solution can be important to determining the performance of the insoluble fixing agent.

### Example 4

In this example, the product of cerium and arsenic was shown to contain more arsenic than would be anticipated based upon the stoichiometry of gasparite, the anticipated product of cerium and arsenic. Furthermore, the X-ray diffraction pattern suggests that the product is amorphous or nanocrystalline and is consistent with ceria or, possibly, gasparite. The amorphous or nanocrystalline phase not only permits the recycling of process water after arsenic sequestration but does so with a far greater arsenic removal capacity than is observed from other forms of cerium addition, decreasing treatment costs and limiting environmental hazards.

Eight 50 mL centrifuge tubes were filled with 25 mL each of a fully oxidized solution of arsenate/sulfate/NaOH while another eight 50 mL centrifuge tubes were filled with 25 mL each of a fully reduced solution of arsenite/sulfide/NaOH that had been sparged with molecular oxygen for 2 hours. Both solutions contained 24 g/L arsenic, 25 g/L NaOH, and the equivalent of 80 g/L sulfide. Each sample was then treated with either cerium (IV) nitrate or cerium (III) chloride. The cerium salt solutions were added in doses of 1, 2, 3, or 5 mL. No pH adjustments were made, and no attempt was made to adjust the temperature from ambient 22° C.

Fifteen of sixteen test samples showed the rapid formation of a precipitate that occupied the entire ˜25 mL volume. The reaction between the two concentrated solutions took place almost immediately, filling the entire solution volume with a gel-like precipitate. The sixteenth sample, containing 5 mL of cerium (IV) remained bright yellow until an additional 5 mL of 50% NaOH was added, at which point a purple solid formed.

Solids formed from the reaction of cerium and arsenic were given an hour to settle with little clarification observed. The samples were then centrifuged at 50% speed for 5 minutes. At this point, the total volume of the solution and the volume of settled solids were recorded, and a 5 mL sample was collected for analysis. Since little more than 5 mL of supernatant solution was available (the concentration of arsenic was 24 g/L, meaning that the concentration of cerium was also quite elevated), the samples were filtered using 0.45 micron papers. The four samples with 5 mL of cerium salt added were not filtered. The supernatant solutions were collected and the volume recorded.

The filter cake from the reaction was left over the weekend in plastic weight boats atop a drying oven. Seventy-two hours later, the content of each boat was weighed, and it was determined that the pellets were still very moist (more mass present than was added to the sample as dissolved solids). The semi-dry solids of the samples with 2 mL of cerium salt solution were transferred to a 130° C. drying oven for one hour, then analyzed by XRD.

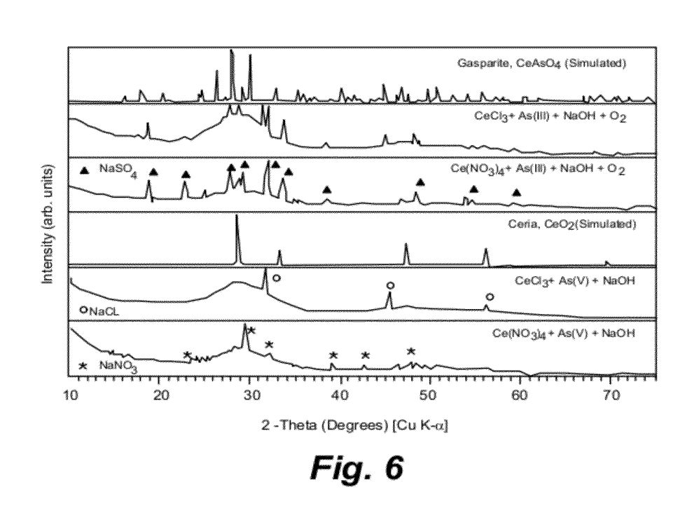

The XRD results are shown in FIG. 6. XRD results are presented for gasparite (the expected product) and the various systems that were present during the experiments, with “ceria” corresponding to cerium dioxide. As can be seen from FIG. 6, the XRD analysis did not detect any crystalline peaks or phases of arsenic and cerium solids in the various systems. The only crystalline material present was identified as either NaCl, NaNO₃ (introduced with the rare earth solutions) or Na₂SO₄ that was present in the samples prepared from Na₂SO₄. However, the broad diffraction peaks at about 29, 49, and 57 degrees 2-Theta could be indicative of very small particles of ceria or, possibly, gasparite.

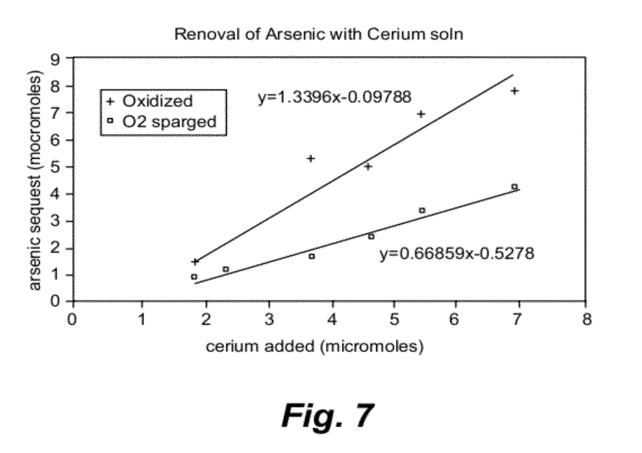

The arsenic content of supernatant solutions was measured using ICP-AES. It was observed that both cerium (IV) and cerium (III) effectively removed arsenic from the system to about the same extent. As can be seen from Table 3 below and FIG. 7, a greater difference in arsenic removal was found between the fully oxidized system, and the system which was fully reduced before molecular oxygen sparging. FIG. 7 shows a plot for arsenic micromoles removed in an “oxidized” system staring with arsenate and a “molecular oxygen sparged” system starting with arsenite, which was subsequently oxidized to arsenate through molecular oxygen sparging.

TABLE 3

| | | | Arsenite/sulfide/ | | Arsenate/sulfate/ | |
|---|---|---|---|---|---|---|
| | | | NaOH + O2 | | NaOH | |
| | | | | As | | As |
| Cerium | mL | CeO₂ | As | capacity | As | capacity |
| Additive | Ce | (g) | ppm | (mg/g) | ppm | (mg/g) |
| cerium (III) | 1 | 0.33 | 21200 | 242 | 20000 | 276 |
| chloride | 2 | 0.65 | 18800 | 271 | 8700 | 576 |
| | 3 | 0.98 | 11200 | 324 | 1000 | 596 |
| cerium (IV) | 1 | 0.26 | 21600 | 265 | 19200 | 429 |
| nitrate | 2 | 0.52 | 18800 | 237 | 8000 | 764 |
| | 3 | 0.77 | 13600 | 322 | 3200 | 672 |

| | | | | |
|---|---|---|---|---|
| control | 0 | 0.0 | 25200 | 24400 |

FIG. 7 shows the amount of arsenic consumed by the formation of precipitated solids, plotted as a function of the amount of cerium added. The resultant soluble arsenic concentrations from this experiment can be divided into two groups: samples containing fully oxidized arsenate and sulfate and samples containing arsenite and sulfite that was sparged with molecular oxygen. The oxidation state of the cerium used as the soluble fixing agent had considerably less impact on the efficacy of the process, allowing both Ce(III) and Ce(IV) data to be fit with a single regression line for each test solution. In the case of the fully oxidized solution, arsenic sequestration with the solids increases in an arsenic to cerium molar ratio of 1:3, potentially making a product with a stoichiometry of Ce₃As₄.

### Example 5

A series of experiments were performed, the experiments embody the precipitation of arsenic, in the As (V) state, from a highly concentrated waste stream of pH less than pH 2 by the addition of a soluble cerium salt in the Ce (III) state followed by a titration with sodium hydroxide (NaOH) solution to a range of between pH 6 and pH 10.

In a first test, a 400 mL solution containing 33.5 mL of a 0.07125 mol/L solution of NaH₂AsO₄ was stirred in a beaker at room temperature. The pH was adjusted to roughly pH 1.5 by the addition of 4.0 mol/L HNO₃, after which 1.05 g of Ce(NO₃)₃.6H₂O was added. No change in color or any precipitate was observed upon the addition of the cerium (III) salt. NaOH (1.0 mol/L) was added to the stirred solution at a dropwise pace to bring the pH to pH 10.1. The pH was held at pH 10.2±0.2 for a period of 1.5 hours under magnetic stir. After the reaction, the solution was removed from the stir plate and allowed to settle undisturbed for 12 to 18 hours. The supernatant was decanted off and saved for ICP-MS analysis of Ce and As. The solids were filtered through a 0.4 μm cellulose membrane and washed thoroughly with 500 to 800 mL of de-ionized water. The solids were air-dried and analyzed by X-ray diffraction.

In a second test, a simulated waste stream solution was prepared with the following components: As (1,200 ppm), F (650 ppm), Fe (120 ppm), S (80 ppm), Si (50 ppm), Ca (35 ppm), Mg (25 ppm), Zn (10 ppm), and less than 10 ppm of Al, K, and Cu. The pH of the solution was titrated down to pH 0.4 with concentrated HCl (12.1 mol/L), and the solution was heated to 70° C. A solution of CeCl₃ (6.3 mL, 1.194 mol/L) was added to the hot solution, and the pH was slowly increased to pH 7.5 by dropwise addition of NaOH (20 wt. %, 6.2 mol/L). The solution was then allowed to age at 70° C. under magnetic stirring for 1.5 hours, holding pH at pH 7.5±0.2. The solution was then removed from the heat and allowed to settle undisturbed for 12 to 18 hours. The supernatant was decanted off and saved for ICP-MS analysis of Ce and As. The precipitated solids were centrifuged and washed twice before being filtered through a 0.4 μm cellulose membrane and washed thoroughly with 500 to 800 mL of de-ionized water. The solids were air-dried and analyzed by X-ray diffraction.

In a third test, solid powders of the novel Ce—As compound were tested for stability in a low-pH leach test. 0.5 g of the novel Ce—As compound were added to 10 mL of an acetic acid solution with a pH of either pH 2.9 or pH 5.0. The container was sealed and rotated for 18±2 hours at 30±2 revolutions per minute at an ambient temperature in the range of 22±5° C. After the required rotation time, the solution was filtered through a 0.2 micron filter and analyzed by ICP-MS for Ce and As which may have been leached from the solid. Less than 1 ppm of As was detected by ICP-MS.

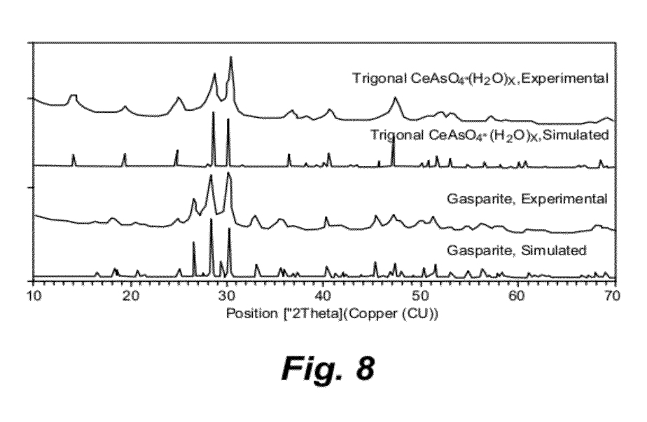

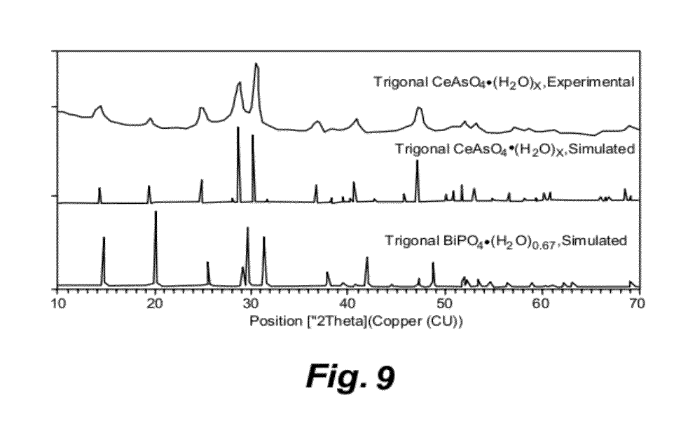

FIG. 8 compares the X-Ray Diffraction (“XRD”) results for the novel Ce—As compound (shown as trigonal CeAs O₄.(H₂O)_{X} (both experimental and simulated) and gasparite (both experimental and simulated). FIG. 9 compares the XRD results for trigonal CeAs O₄.(H₂O)_{X} (both experimental and simulated) and trigonal BiP O₄.(H₂O)_{0.67} (simulated). The XRD results show that the precipitated crystalline compound is structurally different from gasparite (CeAsO₄), which crystallizes in a monoclinic space group with a monazite-type structure, and is quite similar to trigonal BiP O₄.(H₂O)_{0.67}.

Experiments with different oxidation states of Ce and As demonstrate that the novel Ce—As compound requires cerium in the Ce (III) state and arsenic in the As(V) state. pH titration with a strong base, such as sodium hydroxide, seems to be necessary. As pH titration with sodium carbonate produces either gasparite, a known and naturally occurring compound or a combination of gasparite and trigonal CeAsO₄.(H₂O)_{X}. The use of cerium chloride and cerium nitrate both successfully demonstrated the successful synthesis of the novel compound. The presence of other metal species, such as magnesium, aluminum, silicon, calcium, iron, copper, and zinc, have not been shown to inhibit the synthesis of the novel compound. The presence of fluoride will compete with arsenic removal and produce an insoluble CeF₃ precipitate. Solutions containing only arsenic and cerium show that a Ce:As atomic ratio of 1:1 is preferable for forming the novel compound, and solutions containing excess cerium have produced a cerium oxide (CeO₂) precipitate in addition to the novel compound. Additionally, the novel compound appears to be quite stable when challenged with a leach test requiring less than 1 ppm arsenic dissolution in solution of pH 2.9 and pH 5.0.

### Example 6

In a first test, 50 mL of synthetic waste water containing 24 g/L arsenic, 25 g/L sodium hydroxide, and 80 g/L sodium sulfide were added to a flask and heated to 70° C. under magnetic stir. Initial solution pH was found to be pH 12.0. Dropwise addition of 19.6 g of cerium-aluminum chloride solution (83.7 g/L Ce, 54.0 g/L Al, D=1.29 g/L) yielded a flaky, white solid precipitate. Sodium hydroxide solution (NaOH, 20%) was added as needed to maintain a solution pH of pH 10.0 or higher during addition of the bimetallic lanthanide-based salt solution. After complete addition of the bimetallic lanthanide-based salt solution, the solution is aged at 70° C. under magnetic stir for 30 minutes. After cooling, the final solution pH is pH 10.4. The solid precipitate was filtered through a 0.4 μm membrane and dried. ICP-AES analysis of the feed and treated solutions indicates that the arsenic concentration was decreased from 23,800 ppm to 4,300 ppm. This is an 82% removal rate at a capacity of 730 mg arsenic/gram of CeO₂.

In a second test, 30 mL of synthetic waste water containing 24 g/L arsenic, 25 g/L sodium hydroxide, and 80 g/L sodium sulfide were added to a flask at 22° C. under magnetic stir. Initial solution pH was found to be pH 13.0. Dropwise addition of 11.9 g of cerium-aluminum chloride solution (83.7 g/L Ce, 54.0 g/L Al, D=1.29 g/L) yielded a flaky, white solid precipitate. Sodium hydroxide solution (NaOH, 20%) was added as needed to maintain a solution pH of pH 10.0 or higher during addition of the bimetallic lanthanide-based salt solution. After complete addition of the bimetallic lanthanide-based salt solution, the solution is heated to 70° C. under magnetic stir and aged for 60 minutes. After cooling, the final solution pH is pH 11.0. The solid precipitate was centrifuged and washed with water two times, then dried. ICP-AES analysis of the feed and treated solutions indicates that the arsenic concentration was decreased from 23,800 ppm to 2,750 ppm. This is an 89% removal rate at a capacity of 770 mg arsenic/gram of CeO₂.

### Example 7

In a first test, 30 mL of synthetic waste water containing 24 g/L arsenic, 25 g/L sodium hydroxide, and 80 g/L sodium sulfide were added to a flask and heated to 70° C. under magnetic stir. Initial solution pH was found to be pH 12.8. Dropwise addition of 17.3 g of aluminum chloride solution (54.0 g/L Al, D=1.20 g/L) yielded a flaky, white solid precipitate. Sodium hydroxide solution (NaOH, 20%) was added as needed to maintain a solution pH of pH 10.0 or higher during addition of the aluminum chloride solution. After complete addition of the aluminum-based salt solution, the solution is aged at 70° C. under magnetic stir for 30 minutes. After cooling, the final solution pH is pH 10.3. The solid precipitate was centrifuged and washed with water two times, and thereafter air-dried. ICP-AES analysis of the feed and treated solutions indicates that the arsenic concentration was decreased from 23,800 ppm to 6,830 ppm. This is a 73% removal rate at a capacity of 200 mg arsenic/gram of Al₂O₃.

In a second test, 30 mL of synthetic waste water containing 24 g/L arsenic, 25 g/L sodium hydroxide, and 80 g/L sodium sulfide was added to a flask and heated to 70° C. under magnetic stir. Initial solution pH was found to be pH 12.5. Dropwise addition of 17.3 g of aluminum chloride solution (54.0 g/L Al, D=1.20 g/L) yielded a flaky, white solid precipitate. Sodium hydroxide solution (NaOH, 20%) was added as needed to maintain a solution pH of pH 9.0 or higher during addition of the aluminum salt solution. After complete addition of the aluminum salt solution, the solution is heated to 70° C. under magnetic stir and aged for 30 minutes. After cooling, the final solution pH is pH 9.2. The solid precipitate was centrifuged and washed with water two times, and thereafter air-dried. ICP-AES analysis of the feed and treated solutions indicates that the arsenic concentration was decreased from 23,800 ppm to 3,120 ppm. This is an 87.5% removal rate at a capacity of 245 mg arsenic/gram of Al₂O₃.

### Example 8

In this Example, a test solution containing 1.0 ppmw chromium calculated as Cr was prepared by dissolving reagent grade potassium dichromate in distilled water. This solution contained Cr⁺⁶ in the form of oxyanions and no other metal oxyanions. A mixture of 0.5 gram of lanthanum oxide (La₂O₃) and 0.5 gram of cerium dioxide (CeO₂) was slurried with 100 milliliters of the test solution in a glass container. The resultant slurries were agitated with a Teflon coated magnetic stir bar for 15 minutes. After agitation the water was separated from the solids by filtration through Whatman #41 filter paper and analyzed for chromium using an inductively coupled plasma atomic emission spectrometer. This procedure was repeated twice, but instead of slurrying a mixture of lanthanum oxide and cerium dioxide with the 100 milliliters of test solution, 1.0 gram of each was used. The results of these tests 1-3 are set forth below in Table 4.

TABLE 4

| | Oxyanion | | | | |
|---|---|---|---|---|---|
| | in Water | | | Oxyanion in | Oxyanion |
| Example | Before Test | | Slurried | Water After | Removed |
| Number | Element | (ppmw) | Material | Test (ppmw) | (percent) |
| 1 | Cr | 1.0 | 0.5 gm La₂O₃ | ≦0.013 | ≧98.7 |
| | | | 0.5 gm CeO₂ | | |
| 2 | Cr | 1.0 | 1.0 gm CeO₂ | ≦0.001 | ≧99.9 |
| 3 | Cr | 1.0 | 1.0 gm La₂O₃ | ≦0.015 | ≧98.5 |
| 4 | Sb | 1.0 | 0.5 gm La₂O₃ | ≦0.016 | ≧98.4 |
| | | | 0.5 gm CeO₂ | | |
| 5 | Sb | 1.0 | 1.0 gm CeO₂ | ≦0.016 | ≧98.4 |
| 6 | Sb | 1.0 | 1.0 gm La₂O₃ | ≦0.100 | ≧90.0 |
| 7 | Mo | 1.0 | 0.5 gm La₂O₃ | ≦0.007 | ≧99.3 |
| | | | 0.5 gm CeO₂ | | |
| 8 | Mo | 1.0 | 1.0 gm CeO₂ | ≦0.001 | ≧99.9 |
| 9 | Mo | 1.0 | 1.0 gm La₂O₃ | ≦0.009 | ≧99.1 |
| 10 | V | 1.0 | 1.0 gm La₂O₃ | ≦0.004 | ≧99.6 |
| 11 | V | 1.0 | 1.0 gm CeO₂ | 0.120 | 88.0 |
| 12 | V | 1.0 | 1.0 gm La₂O₃ | ≦0.007 | ≧99.3 |
| 13 | U | 2.0 | 0.5 gm La₂O₃ | ≦0.017 | ≧98.3 |
| | | | 0.5 gm CeO₂ | | |
| 14 | U | 2.0 | 1.0 gm CeO₂ | 0.500 | 75.0 |
| 15 | U | 2.0 | 1.0 gm La₂O₃ | ≦0.050 | ≧95.0 |
| 16 | W | 1.0 | 0.5 gm La₂O₃ | ≦0.050 | ≧95.0 |
| | | | 0.5 gm CeO₂ | | |
| 17 | W | 1.0 | 1.0 gm CeO₂ | ≦0.050 | ≧95.0 |
| 18 | W | 1.0 | 1.0 gm La₂O₃ | ≦0.050 | ≧95.0 |

As can be seen the lanthanum oxide, the cerium dioxide and the equal mixture of each were effective in removing over 98 percent of the chromium from the test solution.

Tests 4-6

The procedures of Tests 1-3 were repeated except that a test solution containing 1.0 ppmw antimony calculated as Sb was used instead of the chromium test solution. The antimony test solution was prepared by diluting with distilled water a certified standard solution containing 100 ppmw antimony along with 100 ppmw each of As, Be, Ca, Cd, Co, Cr, Fe, Li, Mg, Mn, Mo, Ni, Pb, Se, Sr, Ti, Tl, V, and Zn. The results of these tests are also set forth in Table 4 and show that the two rare earth compounds alone or in admixture were effective in removing 90 percent or more of the antimony from the test solution.

Tests 7-9

The procedures of Tests 1-3 were repeated except that a test solution containing 1.0 ppmw molybdenum calculated as Mo was used instead of the chromium test solution. The molybdenum test solution was prepared by diluting with distilled water a certified standard solution containing 100 ppmw molybdenum along with 100 ppmw each of As, Be, Ca, Cd, Co, Cr, Fe, Li, Mg, Mn, Ni, Pb, Sb, Se, Sr, Ti, Tl, V, and Zn. The results of these tests are set forth in Table 4 and show that the lanthanum oxide, the cerium dioxide and the equal weight mixture of each were effective in removing over 99 percent of the molybdenum from the test solution.

Tests 10-12

The procedures of Tests 1-3 were repeated except that a test solution containing 1.0 ppmw vanadium calculated as V was used instead of the chromium test solution. The vanadium test solution was prepared by diluting with distilled water a certified standard solution containing 100 ppmw vanadium along with 100 ppmw each of As, Be, Ca, Cd, Co, Cr, Fe, Li, Mg, Mn, Mo, Ni, Pb, Sb, Se, Sr, Ti, Tl, and Zn. The results of these tests are set forth in Table 4 and show that the lanthanum oxide and the equal weight mixture of lanthanum oxide and cerium dioxide were effective in removing over 98 percent of the vanadium from the test solution, while the cerium dioxide removed about 88 percent of the vanadium.

Tests 13-15

The procedures of Tests 1-3 were repeated except that a test solution containing 2.0 ppmw uranium calculated as U was used instead of the chromium test solution. The uranium test solution was prepared by diluting a certified standard solution containing 1,000 ppmw uranium with distilled water. This solution contained no other metals. The results of these tests are set forth in Table 4 and show that, like in Tests 10-12, the lanthanum oxide and the equal weight mixture of lanthanum oxide and cerium dioxide were effective in removing the vast majority of the uranium from the test solution. However, like in those examples, the cerium dioxide was not as effective removing about 75 percent of the uranium.

Tests 16-18

The procedures of Tests 1-3 were repeated except that a test solution containing 1.0 ppmw tungsten calculated as W was used instead of the chromium test solution. The tungsten test solution was prepared by diluting a certified standard solution containing 1,000 ppmw tungsten with distilled water. The solution contained no other metals. The results of these tests are set forth in Table 4 and show that the lanthanum oxide, cerium dioxide, and the equal weight mixture of lanthanum oxide and cerium dioxide were equally effective in removing 95 percent or more of the tungsten from the test solution.

Although this disclosure has been described by reference to several embodiments of the disclosure, it is evident that many alterations, modifications and variations will be apparent to those skilled in the art in light of the foregoing description. Accordingly, it is intended to embrace within the disclosure all such alternatives, modifications and variations that fall within the spirit and scope of the appended claims.

### Example 9

In a first test, twenty 3.6 g packets of cherry Kool-Aid™ unsweetened soft drink mix (containing Red 40 (as azo dye having the composition 2-naphthalenesulfonic acid, 6-hydroxy-5-((2-methoxy-5-methyl-4-sulfophenyl)azo) disodium salt, and disodium 6-hydroxy-5-((2-methoxy-5-methyl-4-sulfophenyl)azo)-2-naphthalenesulfonate) and Blue 1 (a disodium salt having the formula C₃₇H₃₄N₂Na₂O₉S₃) dyes) were added to and mixed with five gallons of water. For use in the first test, a column setup was configured such that the dyed water stream enters and passes through a fixed bed of insoluble cerium (IV) oxide to form a treated solution. The dyed, colored water was pumped through the column setup. The treated solution was clear of any dyes, and at the top of the bed there was a concentrated band of color, which appeared to be the Red 40 and Blue 1 dyes.

In a second test, cherry Kool-Aid™ unsweetened soft drink mix (containing Red 40 and Blue 1 dyes) was dissolved in water, and the mixture stirred in a beaker. Insoluble cerium (IV) oxide was added and kept suspended in the solution by stirring. When stirring ceased, the cerium oxide settled, leaving behind clear, or colorless, water. This example is intended to replicate water treatment by a continuous stirred tank reactor (CSTR).

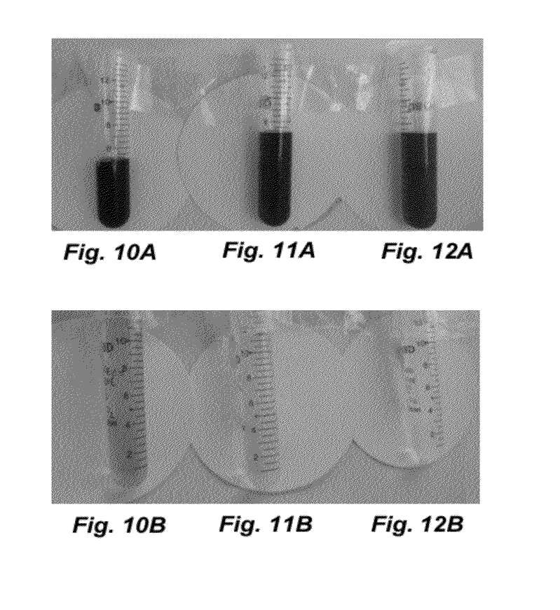

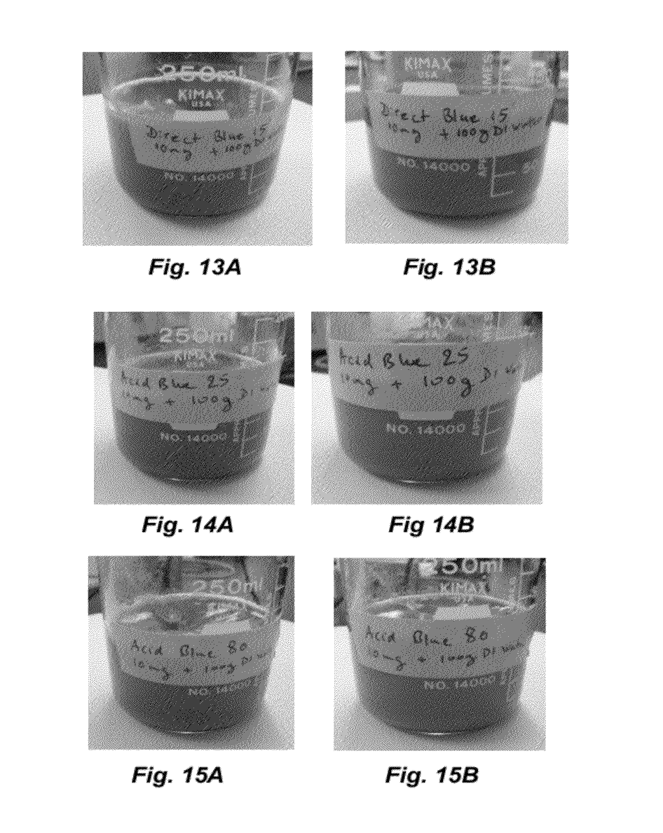

In a third test, 10.6 mg of Direct Blue 15 (C₃₄H₂₄N₆Na₄O₁₆S₄, from Sigma-Aldrich) was dissolved in 100.5 g of de-ionized water. The Direct Blue 15 solution (FIG. 10A) was stirred for 5 min. using a magnetic stir bar before adding 5.0012 g of high surface area ceria (CeO₂). The ceria-containing Direct Blue 15 solution was stirred. The ceria-containing Direct Blue 15 solution 2 min and 10 min after adding the ceria are, respectively, showed in FIGS. 13A and 13B. After stirring for 10 min, a filtrate was extracted using a 0.2 μm syringe filter. The filtrate was clear and substantially colorless, having a slightly visible blue tint (FIG. 10B).

In a fourth test, 9.8 mg of Acid Blue 25 (45% dye content, C₂₀H₁₃N₂NaO₅S, from Sigma-Aldrich) was dissolved in 100.3 g of de-ionized water. The Acid Blue 25 solution (FIG. 11A) was stirred for 5 min. using a magnetic stir bar before adding 5.0015 g of high surface area ceria (CeO₂). The ceria-containing Acid Blue 25 solution was stirred. The ceria-containing Acid Blue 25 solution 2 min and 10 min after adding the ceria are, respectively, showed in FIGS. 14A and 14B. After stirring for 10 min, a filtrate was extracted using a 0.2 μm syringe filter. The filtrate was clear and substantially colorless, and lacked any visible tint (FIG. 11B).

In a fifth test, 9.9 mg of Acid Blue 80 (45% dye content, C₃₂H₂₈N₂Na₂O₈S₂, from Sigma-Aldrich) was dissolved in 100.05 g of de-ionized water. The Acid Blue 80 solution (FIG. 12A) was stirred for 5 min. using a magnetic stir bar before adding 5.0012 g of high surface area ceria (CeO₂). The ceria-containing Acid Blue 80 solution was stifled. The ceria-containing Acid Blue 80 solution 2 min and 10 min after adding the ceria are, respectively, showed in FIGS. 15A and 15B. After stirring for 10 min, a filtrate was extracted using a 0.2 μm syringe filter. The filtrate was clear and substantially colorless, and lacked any visible tint (FIG. 12B).

Based on these tests and while not wishing to be bound by any theory, the dyes are believed to sorb or otherwise react with the cerium (IV) oxide.

### Example 10

15 ml of CeO₂ obtained from Molycorp, Inc.'s Mountain Pass facility was placed in a ⅞″ inner diameter column.

600 ml of influent containing de-chlorinated water and 3.5×10⁴/ml of MS-2 was flowed through the bed of CeO₂ at flow rates of 6 ml/min, 10 ml/min and 20 ml/min. Serial dilutions and plating were performed within 5 minutes of sampling using the double agar layer method with E. Coli, host and allowed to incubate for 24 hrs at 37° C.

The results of these samples are presented in Table 5.

TABLE 5

| Bed and Flow | Influent | Effluent | Percent | |
|---|---|---|---|---|
| Rate | Pop./ml | Pop/ml | reduction | Challenger |
| CeO₂ 6 ml/min | 3.5 × 10⁴ | 1 × 10⁰ | 99.99 | MS-2 |
| CeO₂ 10 ml/min | 3.5 × 10⁴ | 1 × 10⁰ | 99.99 | MS-2 |
| CeO₂ 20 ml/min | 3.5 × 10⁴ | 1 × 10⁰ | 99.99 | MS-2 |

The CeO₂ bed treated with the MS-2 containing solution was upflushed. A solution of about 600 ml of de-chlorinated water and 2.0×10⁶/ml of Klebsiella terrgena was prepared and directed through the column at flow rates of 10 ml/min, 40 ml/min and 80 ml/min. The Klebsiella was quantified using the Idexx Quantitray and allowing incubation for more than 24 hrs. at 37° C.

The results of these samples are presented in Table 6.

TABLE 6

| Bed and Flow | Influent | Effluent | Percent | |
|---|---|---|---|---|
| Rate | Pop./ml | Pop/ml | reduction | Challenger |
| CeO₂ 10 ml/min | 2.0 × 10⁶ | 1 × 10⁻² | 99.99 | Klebsiella |
| CeO₂ 40 ml/min | 2.0 × 10⁶ | 1 × 10⁻² | 99.99 | Klebsiella |
| CeO₂ 80 ml/min | 2.0 × 10⁶ | 1 × 10⁻² | 99.99 | Klebsiella |

The CeO₂ bed previously challenged with MS-2 and Klebsiella terrgena was then challenged with a second challenge of MS-2 at increased flow rates. A solution of about 1000 ml de-chlorinated water aid 2.2×10⁵/ml of MS-2 was prepared and directed through the bed at flow rates of 80 ml/min, 120 ml/min and 200 ml/min. Serial dilutions and plating were performed within 5 minutes of sampling using the double agar layer method with E. Coli host and allowed to incubate for 24 hrs at 37° C.

The results of these samples are presented in Table 7.

TABLE 7

| Bed and Flow | Influent | Effluent | Percent | |
|---|---|---|---|---|
| Rate | Pop./ml | Pop/ml | reduction | Challenger |
| CeO₂ 80 ml/min | 2.2 × 10⁵ | 1 × 10⁰ | 99.99 | MS-2 |
| CeO₂ 120 ml/min | 2.2 × 10⁵ | 1.4 × 10² | 99.93 | MS-2 |
| CeO₂ 200 ml/min | 2.2 × 10⁵ | 5.6 × 10⁴ | 74.54 | MS-2 |

### Example 11

ABS plastic filter housings (1.25 inches in diameter and 2.0 inches in length) were packed with ceric oxide (CeO₂) that was prepared from the thermal decomposition of 99% cerium carbonate. The housings were sealed and attached to pumps for pumping an aqueous solution through the housings. The aqueous solutions were pumped through the material at flow rates of 50 and 75 ml/min. A gas chromatograph was used to measure the final content of the chemical contaminant. The chemical contaminants tested, their initial concentration in the aqueous solutions, and the percentage removed from solution are presented in Table 8.

TABLE 8

| | | Starting | % | % |
|---|---|---|---|---|
| | | Concen- | Removal | Removal |
| Common | | tration | at 50 | at 75 |
| Name | Chemical Name | (mg/L) | ml/min | ml/min |
| VX | O-ethyl-S-(2- | 3.0 | 99% | 97% |
| | isopropylamino- | | | |
| | ethyl)methylphos- | | | |
| | phonothiolate | | | |
| GB | Isopropyl methyl- | 3.0 | 99.9% | 99.7% |
| (sarin) | phosphono- | | | |
| | fluoridate | | | |
| HD | Bis(2-chloro- | 3.0 | 92% | 94% |
| (mustard) | ethyl)sulfide | | | |
| Meth- | O,S-dimethyl phos- | 0.184 | 95% | 84% |
| amidophos | phoramidothioate | | | |
| Mono- | Dimethyl (1E)-1- | 0.231 | 100% | 100% |
| chrotophos | methyl-3-(methyl- | | | |
| | amino)-3-oxo-1- | | | |
| | propenylphosphate | | | |
| Phos- | 2-chloro-3- | 0.205 | 100% | 95% |
| phamidon | (diethylamino)- | | | |
| | 1-methyl-3-oxo- | | | |
| | 1-propenyl | | | |
| | dimethylphosphate | | | |

### Example 12

This example demonstrates the affinity of halogens for rare earth metals. A series of tests were performed to determine if certain halogens, particularly fluoride (and other halogens), compete with the binding of arsenic to cerium chloride. Arsenic is known to bind strongly to cerium chloride in aqueous media when using water soluble cerium chloride (CeCl3). This halogen binding affinity was determined by doing a comparison study between a stock solution containing fluoride and one without fluoride. Materials used were: CeCl3 (1.194 M Ce or 205.43 g/L REO) and 400 mL of the stock. The constituents of the stock solution, in accordance with NSF P231 “general test water 2” (“NSF”), are shown in Tables 9 and 102:

TABLE 9
Amount of Reagents Added

| | | Amount of |
|---|---|---|
| | Amount of | Reagent Added |
| | Reagent Added | to 3.5 L (g) |
| Compound | to 3.5 L (g) | No Fluoride |
| NaF | 5.13 | 0 |
| AlCl₃•6H₂O | 0.13 | 0.13 |
| CaCl₂•2 H₂O | 0.46 | 0.46 |
| CuSO₄•5H₂O | 0.06 | 0.06 |
| FeSO₄•7H₂O | 2.17 | 2.16 |
| KCl | 0.16 | 0.15 |
| MgCl₂•6H₂O | 0.73 | 0.74 |
| Na₂SiO₃•9H₂O | 1.76 | 1.76 |
| ZnSO₄•7H₂O | 0.17 | 0.17 |
| Na₂HAsO₄•7H₂O | 18.53 | 18.53 |

TABLE 10
Calculated Analyte Concentrations

| | Theoretical | Theoretical |
|---|---|---|
| | Concentration | Concentration (mg/L) |
| Element | (gm/L) | No Fluoride |
| Cl | 19032 | 15090 |
| Na | 1664 | 862 |
| K | 24 | 22 |
| Cu | 4 | 4 |
| Fe | 125 | 124 |
| Zn | 11 | 11 |
| As | 1271 | 1271 |
| Mg | 25 | 20 |
| Ca | 36 | 36 |
| Al | 16 | 16 |
| Si | 50 | 50 |
| S | 79 | 79 |
| F | 663 | 0 |

The initial pH of the stock solution was pH approximately 0-1. The temperature of the stock solution was elevated to 70° C. The reaction or residence time was approximately 90 minutes.

The procedure for precipitating cerium arsenate with and without the presence of fluorine is as follows:

### Step 1:

Two 3.5 L synthetic stock solutions were prepared, one without fluorine and one with fluorine. Both solutions contained the compounds listed in Table 9.

### Step 2:

400 mL of synthetic stock solution was measured gravimetrically (402.41 g) and transferred into a 600 mL Pyrex beaker. The beaker was then placed on hot/stir plate and was heated to 70° C. while being stirred.

### Step 3:

Enough cerium chloride was added to the stock solution to meet a predetermined molar ratio of cerium to arsenic. For example, to achieve a molar ratio of one ceria mole to one mole of arsenic 5.68 mL of cerium chloride was measure gravimetrically (7.17 g) and added to the stirring solution. Upon addition of cerium chloride a yellow/white precipitate formed instantaneously, and the pH dropped due to the normality of the cerium chloride solution being 0.22. The pH was adjusted to approximately 7 using 20% sodium hydroxide.

### Step 4:

Once the cerium chloride was added to the 70° C. solution, it was allowed to react for 90 minutes before being sampled.

### Step 5:

Repeat steps 2-4 for all desired molar ratios for solution containing fluoride and without fluoride.

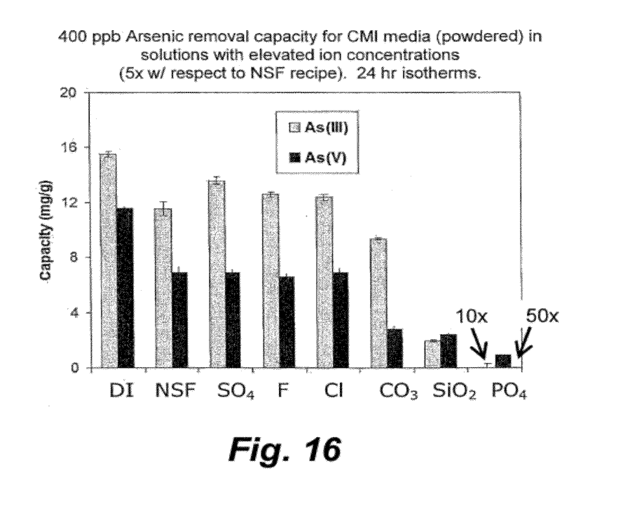

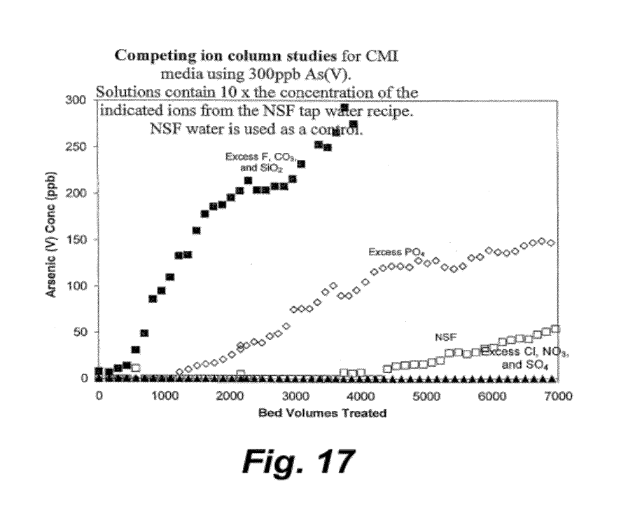

The results are presented in Table 11 and FIGS. 16 and 17.

TABLE 11
Table 11. The residual arsenic concentration in supernatant
solution after precipitation with cerium chloride solution.

| | Residual As Concentration | Residual As Concentration no |
|---|---|---|
| Molar Ratio | w/Fluoride Present (mg/L) | Fluoride Present (mg/L) |
| 1.00 | 578 | 0 |
| 1.10 | 425 | 0 |
| 1.20 | 286 | 0 |
| 1.30 | 158.2 | 0 |
| 1.40 | 58.1 | 0 |
| 1.50 | 13.68 | 0 |
| 1.60 | 3.162 | 0 |
| 1.71 | 0 | 0 |
| 1.81 | 10.2 | 0 |
| 1.90 | 0 | 0 |
| 2.01 | 0 | 0 |

A comparison of loading capacities for solutions containing or lacking fluoride shows a strong affinity for halogens and halogenated compounds. FIG. 16 shows the affinity of cerium III for fluoride in the presence of arsenic. FIG. 17 shows that the loading capacities (which is defined as mg of As per gram of CeO₂) for solutions lacking fluoride are considerably higher at low molar ratios of cerium to arsenic. Sequestration of fluorinated organic compounds, particularly fluorinated pharmaceutical compounds, using rare earth metals, and particularly cerium, is clearly indicated.

Solutions with a cerium to arsenic molar ratio of approximately 1.4 to 1 or greater had a negligible difference in the loading capacities between solution that contained F and not having F. This leads one to believe that an extra 40% cerium was needed to sequester the F; then the remaining cerium could react with the arsenic.

These results confirm that the presence of fluoride effectively competes with the sequestration of arsenic. The interference comes from the competing reaction forming CeF₃; this reaction has a much more favorable Ksp. In light of these results, an arsenic-free aqueous solution gives better removal of fluorinated compounds.

### Example 13

This example demonstrates the successful removal of sulfate-containing compounds, halogenated compounds, carbonate-containing compounds, and phosphate-containing compounds, using a cerium dioxide powder. A cerium powder, having a 400 ppb arsenic removal capacity, was contacted with various solutions containing arsenic (III) as arsenite and arsenic (V) as arsenate and elevated concentrations of the compounds that compete for the known binding affinity between arsenic and cerium. The competing organic compounds included sulfate ions, fluoride ions, chloride ions, carbonate ions, silicate ions, and phosphate ions at concentrations of approximately 500% of the corresponding NSF concentration for the ion. The cerium dioxide powder was further contacted with arsenic-contaminated distilled and NSF P231 “general test water 2” (“NSF”) water. Distilled water provided the baseline measurement.

The results are presented in FIG. 16. As can be seen from FIG. 16, the ions in NSF water caused, relative to distilled water, a decreased cerium dioxide capacity for both arsenite and arsenate, indicating a successful binding of these compounds to the rare earth metal. The presence of carbonate ion decreased the cerium dioxide removal capacity for arsenate more than arsenite. The presence of silicate ion decreased substantially cerium dioxide removal capacities for both arsenite and arsenate. Finally, phosphate ion caused the largest decrease in cerium dioxide removal capacities for arsenite (10×NSF concentration) and arsenate (50×NSF concentration), with the largest decrease in removal capacity being for arsenite.

### Example 14

Additional competing ion column studies were performed for a 300 ppb arsenate solution and the cerium powder of the prior experiment. The solution contained ten times the concentrations of fluoride ion, chloride ion, carbonate ion, sulfate ion, silicate ion, nitrate ion, and phosphate ion relative to the NSF standard.

The results are shown in FIG. 17. The greatest degree of arsenate competitive binding was experienced in the solutions containing elevated levels of chloride, nitrate, and sulfate ion. The next greatest degree of arsenate removal was for the solution containing elevated levels of phosphate ions.

### Example 15

This example demonstrates the removal of specific physiologically-active compounds from aqueous media using rare earth metals. A series of tests were performed to determine if certain organic compounds were removed from water following exposure to cerium oxide.

Media Preparation:

20 mg of Molycorp HSA cerium oxide was measured out in a plastic weigh boat for each sample to be tested. Approximately 10 mL of DI was added to the weigh boat and the media was allowed to wet for 30 minutes.

Influent Preparation:

30 mL Stock solutions were prepared from solid or liquid reagents for each of the reagents in question. Influents were prepared from the stock solutions in 2.5 L batches for each reagent in question. 2.5 L of DI was measured out gravimetrically into a 4 L bottle. HEPES sodium buffer was added to the DI water followed by 2.5 mL of the stock solutions. The pH was adjusted to 7.5±0.25 using 1 N HCl and 1 N NaOH.

Isotherm Preparation:

500 mL of influent was measured out gravimetrically into four 500 mL bottles. Three bottles were labeled as a samples and the last was labeled as a control. The previously prepared media was poured into each sample bottle. Bottles were capped and sealed with electrical tape. Each bottle was then placed within a rolling container that could hold up to 10 bottles. The containers were then sealed with duct tape and placed on the rolling apparatus. Samples and controls were rolled for 24 hours. After 24 hours, the rolling containers were removed from the apparatus and the bottles were retrieved from the containers. A 10-45 mL sample of each solution was taken and filtered with a 0.2 μm filter. Samples were analyzed by either by a third party laboratory or a HACH colorimeter.

Phosphorus Compound Analysis:

Total phosphorus was analyzed with a HACH DR/890 colorimeter according to the HACH Method 8190 for total phosphorus as phosphate. Briefly, the sample is pretreated with sulfuric acid and persulfate under heat to hydrolyze organic and inorganic phosphorus to orthophosphate, then reacted with molybdate in an acid medium to produce a phosphomolybdate complex. The sample is then reduced with ascorbic acid, resulting in a blue-colored compound which is measured spectroscopically.

Nitrogen Compound Analysis:

Total nitrogen was analyzed with a HACH DR/890 colorimeter according to the HACH Method 10071 for total nitrogen as N. Briefly, the all forms of nitrogen in the sample are converted to nitrate through an alkaline persulfate digestion, followed by the addition of sodium metabisulfite to eliminate halogen oxide interferences. The nitrate is then reacted with chromotropic acid under strongly acidic conditions to produce a yellow-colored compound which is measured spectroscopically.

Benzene Analysis:

Benzene concentration was analyzed by an ICP-MS method.

Table 12 shows the capacity of cerium to remove nine different physiologically-active compounds from aqueous media. The compounds successfully tested include Benzene, 1,7-Dimethylxanthine, Caffeine, Theobromide, Theophylline, DMPA (Dimethylphosphinic Acid), Glyphosate, Pform (Sodium Phosphonoformate tribasic hexahydrate), and TDMAP (Tris(dimethylamino)phosphine).

TABLE 12
Table 12. Removal of pharmacologically active compounds from aqueous media by cerium.

| | Reagent | | Volume | Reagent | | Test | Media | Initial | Final | | Removal |
|---|---|---|---|---|---|---|---|---|---|---|---|
| | Phase | Reagent | Water | Mass | Dilution | Volume | Mass | Reagent | Reagent | Percent | Capacity |
| Compound | (solid/liquid) | Concentration | (L) | (g) | Factor | (L) | (g) | (μg/L) | (μg/L) | Removal | (mg/g media) |
| Benzene | Liquid | 99% | 0.030 | 0.1497 | 1001 | 0.50 | 0.0197 | 465 | 444 | 4.6 | 0.53 |
| 1,7-Dimethylxanthine | Solid | 98% | 0.030 | 0.0519 | 1001 | 0.50 | 0.0210 | 1833 | 1340 | 26.9 | 12 |
| Caffeine | Solid | 100% | 0.030 | 0.0531 | 1035 | 0.50 | 0.0236 | 1629 | 1086 | 33.3 | 12 |
| Theobromide | Solid | 99% | 0.030 | 0.0471 | 1002 | 0.50 | 0.0223 | 2444 | 954 | 61.0 | 33 |
| Theophylline | Solid | 99% | 0.030 | 0.0490 | 1004 | 0.50 | 0.0219 | 1190 | 1018 | 14.4 | 3.9 |
| DMPA | Solid | 97% | 0.030 | 0.0167 | 1001 | 0.50 | 0.0221 | 604 | 538 | 10.9 | 1.5 |
| Glyphosate | Solid | 99% | 0.030 | 0.0250 | 1027 | 0.50 | 0.0185 | 1371 | 926 | 32.5 | 12.0 |
| Pform | Solid | 97% | 0.030 | 0.0369 | 1000 | 0.50 | 0.0207 | 1738 | 1506 | 13.3 | 5.6 |
| TDMAP | Liquid | 97% | 0.030 | 0.0790 | 1002 | 0.50 | 0.0176 | 2784 | 1730 | 37.9 | 29.9 |

### Example 16

This Example is determination of arsenic removal capacity for a micron range cerium dioxide agglomerates and nanometer range cerium dioxide agglomerates. The micron range cerium dioxide agglomerate contained 8 volume % of carbodiimide cross-linked polyvinylidene fluoride-acrylic binder. The nanometer range cerium dioxide agglomerate contained 10 volume % of carbodiimide cross-linked polyvinylidene fluoride-acrylic binder. Table 13 summarizes the characteristics of the media.

TABLE 13

| | Particle | Surface | Pore | Pore | Tap | |
|---|---|---|---|---|---|---|
| | Size | Area | Volume | Size | Density | wt % |
| Media | (μm) | (m²/g) | (cm³/g) | (nm) | (g/mL) | Polymer |
| Molycorp HSA | 31.17 | 124.4 | 0.06 | 2.86 | 1.16 | — |
| Ceria Powder | | | | | | |
| Agglomerated | 300-425 | 100.5 | 0.057 | 5.39 | 1.33 | 2.03 |
| Molycorp HSA | | | | | | |
| Ceria Powder | | | | | | |
| Nano- | <0.025 | 35.8 | 0.18 | 17.80 | 0.38 | — |
| Crystalline | | | | | | |
| Ceria Powder | | | | | | |
| Agglomerated | 300-425 | 32.2 | 0.191 | 18.17 | 1.67 | 2.03 |
| Nano- | | | | | | |
| Crystalline | | | | | | |
| Ceria Powder | | | | | | |

For each of the micron range cerium dioxide and the nanometer range cerium dioxide agglomerates, about 45 mL of the media was charged to a graduated cylinder. After charging the graduated cylinder, the media was packed by gently tapping the cylinder. The volume of the packed media was recorded. The media was transferred to a glass vacuum flask and 100 mL deionized water was charged to the vacuum flask to form an aqueous slurry of the media. The vacuum flask was sealed, the pressure within the flask was reduced using a vacuum pump, and the vacuum flask was swirled by hand to substantially submerge and wet the media. The media was soaked in the deionized water for about 30 minutes. After the 30-minute soaking period, the deionized water was decanted. The soaking and decanting of the media was repeated until the decanted water was substantially free of fine particles to form a fine-free media. Typically the decanted water was substantially free of fine particles after about four soak/decant cycles.

The fine-free media was mixed with deionized water to form a fine-free slurry. The fine-free media slurry was charged to a one-inch internal diameter column configured according to the column set-up, described above. The fine-free media was packed in the column in the form of an aqueous slurry prepared with deionized water. After the 5-minute settling period, deionized water was flowed through the column to further settling the media. After which, the deionized water in column above the media bed, within tank line, and, in in-put line was removed and replaced with an NSF-53 solution, see Table 14 for composition of the NSF-53 solution. The pH of the NSF-53 solution was adjusted to pH 7.5 with 1 N NaOH and/or 0.3 N HCl.

TABLE 14

| Regent | Concentration (mg/L) |
|---|---|
| Sodium Silicate | 93.00 |
| Sodium Bicarbonate | 250.00 |
| Magnesium Sulfate | 128.00 |
| Sodium Nitrate | 12.00 |
| Sodium Fluoride | 2.20 |
| Sodium Phosphate | 0.18 |
| Calcium Chloride | 111.00 |
| Arsenate (As V) | 0.30 |

About every hour of operation, the collector 304 collected a 10 mL sample of the effluent. The collected effluent sample was analyzed for arsenic using inductively coupled plasma-mass spectrometry. The column set-up was operated continuously until 50 μg/L or more of arsenic (V) was detected in the effluent.

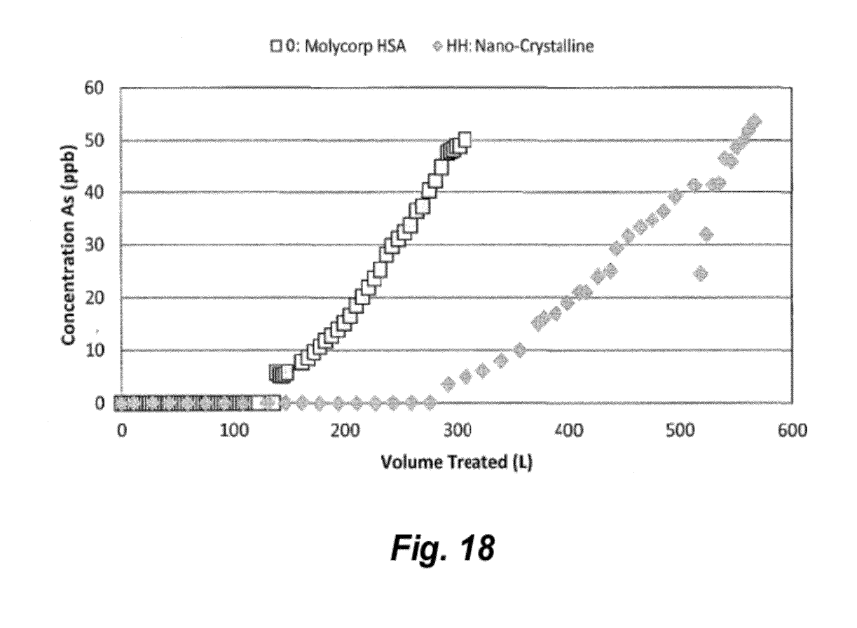

FIG. 18 and Table 15 summarize the capacity study results. The micron range cerium dioxide agglomerated media reached the 50 μg/L arsenic breakthrough value after treating about 307 L of the arsenic (V)-containing NSF-53 solution, while the nanometer range cerium dioxide Agglomerated media treated about 561 L before reaching the 50 μg/L arsenic breakthrough value. This correlates to arsenic capacity values of 1.53 mg As/g media for the micron range ceria agglomerate and 2.19 mg As/g media for the nanometer range ceria agglomerate. Moreover, the capacities for micron range and nanometer range ceria to remove arsenic are, respectively, 1.57 and 2.23 mg/ceria.

TABLE 15

| | Volume | | | |
|---|---|---|---|---|
| | 50 μg/L | Mass | Capacity | Capacity |
| | Break- | Media | by Mass | by Mass |
| Media | through | Used | Media | Ceria Only |
| Molycorp HSA | 307 L | 57.38 g | 1.53 mg As/g | 1.57 mg As/g |
| Agglomerated | | | Media | CeO₂ |
| Ceria | | | | |
| Nano-Crystalline | 561 L | 75.09 g | 2.19 mg As/g | 2.23 mg As/g |
| Agglomerated | | | Media | CeO₂ |
| Ceria | | | | |

### Example 17

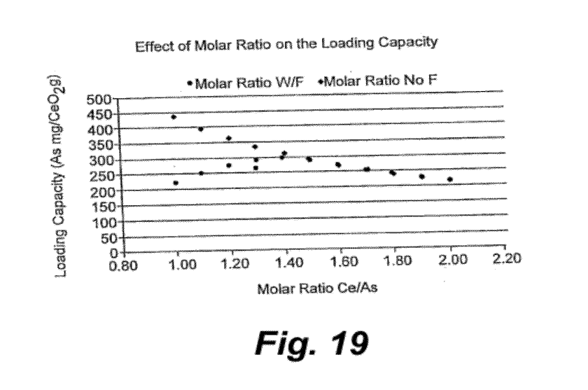

Four filters each containing 25 grams of ceria (cerium dioxide)-coated alumina were challenged with 30 liters of NSF P231 “general test water 2” at a pH of about 9, containing 20 mg/L tannic acid. The ceria-coated alumina pre-filters decreased the oxidant demand of the water from about 41 ppm (NaOCl) to an average of 12 ppm (NaOCl). The oxidant demand of the water treated with the ceria-coated pre-filters decreased by about 75%. This decreased demand translates to a decrease in the amount of halogenated resin necessary to produce a 4 Log₁₀ virus removal. FIG. 19 is a graphical representation of the retention of humic acid on 20 g on 20 g of ceria-coated alumina challenged by 6 mg/L and a 10 min contact time.

### Example 18

Ceria absorbent media was shown to be effective for removing large amounts of natural organic matter, such as humic and/or tannic acids. The organic material was removed at fast water flow rates and small contact times of less than about 30 seconds over a large range of pH values. The organic matter was removed from an aqueous solution with ceria oxide powders having surface areas of about 50 m²/g or greater, about 100 m²/g or greater, and about 130 m²/g or greater. Furthermore, the organic matter was removed from an aqueous stream with cerium oxide-coated alumina having a surface area of about 200 m²/g or greater. Moreover, cerium oxide coated onto other support media or agglomerated cerium oxide powder having a surface area of about 75 m²/g or greater removed humic and/or tannic acids from the aqueous stream. In each instance, the cerium containing material effectively removed the organic matter from the aqueous stream to produce a clear colorless solution. However, the organic matter substantially remained in the organic matter-containing water when the organic matter-containing water was treated with either a hollow fiber microfilter followed by activated carbon packed bed media or with a hollow fiber microfilter. In both of these instances, the treated water was one or both of hazy and colored, indicating the presence of organic matter within the water. The hollow fiber microfilter had a pore size of about 0.2 μm. This further depicts how the organic matter can, in the absence of upstream removal by ceria, foul the downstream hollow fiber microfilter or activated carbon packed bed media.

### Example 19

Four hundred ml of 140 mg/L solution of humic acid (over five times the NSF P248 requirement) was passed through a column containing a volume of about 12.3 cm³ of cerium oxide. The column effluent possessed no visible color and a spectrophotometer analysis of the effluent indicated a humic acid removal capacity of about 93%. A batch analysis experiment indicated a humic acid removal capacity of about 175 mg humic acid per cubic inch of cerium oxide bed depth.

### Example 20

A number of tests were undertaken to evaluate solution phase or soluble cerium ion precipitations.

Test 1:

Solutions containing 250 ppm of Se(IV) or Se(VI) were amended with either Ce(III) chloride or Ce(IV) nitrate at concentrations sufficient to produce a 2:1 mole ratio of Se:Ce. Solids formation was observed within seconds in the reactions between Ce and Se(IV) and also when Ce(IV) was reacted with Se(IV). However, no solids were observed when Ce(III) reacted with Se(VI).

Aliquots of these samples were filtered with 0.45 micron syringe filters and analyzed using ICP-AES. The remaining samples were adjusted to pH 3 when Ce(IV) was added, and to pH 5 when Ce(III) was added. The filtered solutions indicated that Ce(III) did not significantly decrease the concentration of Se(VI). However, Ce(IV) decreased the concentration of soluble Se(VI) from 250 ppm to 60 ppm. Although Ce(IV) did not initially decrease the concentration of Se(IV) at the initial system pH of 1.5, after increasing to pH 3>99% of the Se was precipitated with residual Ce (IV) after initial filtration may be more appropriate. Ce(III) decreased the concentration of Se(IV) from 250 ppm to 75 ppm upon addition and adjustment to pH 5.

Test 2:

Solutions containing 250 ppm of Cr(VI) were amended with a molar equivalent of cerium supplied as either Ce(III) chloride or Ce(IV) nitrate. The addition of Ce(III) to chromate had no immediate visible effect on the solution, however 24 hours later there appeared to be a fine precipitate of dark solids. In contrast, the addition of Ce(IV) led to the immediate formation of a large amount of solids.

As with the previous example, aliquots were filtered, and the pH adjusted to pH 3 for Ce(IV) and pH 5 for Ce(III). The addition of Ce(III) had a negligible impact on Cr solubility, however Ce(IV) removed nearly 90% of the Cr from solution at pH 3.

Test 3:

Solutions containing 250 ppm of fluoride were amended with cerium in 1:3 molar ratio of cerium:fluoride. Again the cerium was supplied as either Ce(III) chloride or Ce(IV) nitrate. While Ce(IV) immediately formed a solid precipitate with the fluoride, Ce (III) did not produce any visible fluoride solids in the pH range 3-4.5.

Test 4:

Solutions containing 50 ppm of molybdenum Spex ICP standard, presumably molybdate, were amended with a molar equivalent of Ce(III) chloride. As with previous samples, a solid was observed after the cerium addition and an aliquot was filtered through a 0.45 micron syringe filter for ICP analysis. At pH 3, nearly 30 ppm Mo remained in solution, but as pH was increased to 5, the Mo concentration dropped to 20 ppm, and near pH 7 the Mo concentration was shown to be only 10 ppm.

Test 5:

Solutions containing 50 ppm of phosphate were amended with a molar equivalent of Ce(III) chloride. The addition caused the immediate precipitation of a solid. The phosphate concentration, as measured by ion chromatography, dropped to 20-25 ppm in the pH range 3-6.

### Example 21

40.00 g of cerium was added to 1.00 liter of solution containing either 2.02 grams of As(III) or 1.89 grams of As(V). The suspension was shaken periodically, about 5 times over the course of 24 hours. The suspensions were filtered and the concentration of arsenic in the filtrate was measured. For As(III), the arsenic concentration had dropped to 11 ppm. For As(V), the arsenic concentration was still around 1 g/L, so the pH was adjusted by the addition of 3 mL of conc HCl.

Both suspensions were entirely filtered using a vacuum filter with a 0.45 micron track-etched polycarbonate membrane. The final or residual concentration of arsenic in solution was measured by ICP-AES. The solids were retained quantitatively, and resuspended in 250 mL of DI water for about 15 minutes. The rinse suspensions were filtered as before for arsenic analysis and the filtered solids were transferred to a weigh boat and left on the benchtop for 4 hours.

The filtered solids were weighed and divided into eight portions accounting for the calculated moisture such that each sample was expected to contain 5 g of solids and 3.5 g of moisture (and adsorbed salts). One sample of each arsenic laden solid (As(III) or As(V) was weighed out and transferred to a drying oven for 24 hours, then re-weighed to determine the moisture content.

Arsenic-laden ceria samples were weighed out and transferred to 50 mL centrifuge tubes containing extraction solution (Table 16). The solution (except for H2O2) had a 20-hour contact time, but with only occasional mixing via shaking. Hydrogen peroxide contacted the arsenic-laden solids for two hours and was microwaved to 50 degrees Celsius to accelerate the reaction.

A control sample was prepared wherein the 8.5 g arsenic-laden ceria samples were placed in 45 mL of distilled (DI) water for the same duration as other extraction tests.

The first extraction test used 45 mL of freshly prepared 1 N NaOH. To increase the chances of forcing off arsenic, a 20% NaOH solution was also examined. To investigate competition reactions, 10% oxalic acid, 0.25 M phosphate, and 1 g/L carbonate were used as extracting solutions. To test a reduction pathway 5 g of arsenic-laden ceria was added to 45 mL of 0.1 M ascorbic acid. Alternatively an oxidation pathway was considered using 2 mL 30% H₂O₂ added with 30 mL of DI water

After enough time elapsed for the selected desorption reactions to occur, the samples were each centrifuged and the supernatant solution was removed and filtered using 0.45 micron syringe filters. The filtered solutions were analyzed for arsenic content. Litmus paper was used to get an approximation of pH in the filtered solutions.

Because the reactions based upon redox changes did not show a great deal of arsenic release, the still arsenic-laden solids were rinsed with 15 mL of 1 N NaOH and 10 mL of DI water for 1 hour, then re-centrifuged, filtered, and analyzed.

The results of these desorption experiments can be seen in Table 16. In short, it appears that the desorption of As(III) occurs to a minimal extent. In contrast, As(V) adsorption exhibits an acute sensitivity to pH, meaning that As(V) can be desorbed by raising the pH above a value of 11 or 12. As(V) adsorption is also susceptible to competition for surface sites from other strongly adsorbing anions present at elevated concentrations.

Using hydrogen peroxide, or another oxidant, to convert As(III) to As(V) appeared to be relatively successful, in that a large amount of arsenic was recovered when the pH was raised using NaOH after the treatment with H₂O₂. However, until the NaOH was added, little arsenic desorbed. This indicates that a basic pH level, or basification, can act as an interferer to As (V) removal by ceria.

While ascorbate did cause a dramatic color change in the loaded media, it was unsuccessful in removing either As(III) or As(V) from the surface of ceria. In contrast, oxalate released a detectable amount of adsorbed As(III) and considerably greater amounts of As(V).

In Examples with Other Adsorbates:

These examples examined the adsorption and desorption of a series of non-arsenic anions using methods analogous to those established for the arsenic testing.

Permanganate:

Two examples were performed. In the first example, 40 g of ceria powder were added to 250 mL of 550 ppm KMnO₄ solution. In the second example, 20 g of ceria powder were added to 250 mL of 500 ppm KMnO₄ solution and pH was lowered with 1.5 mL of 4 N HCl. Lowering the slurry pH increased the Mn loading on ceria four fold.

In both examples the ceria was contacted with permanganate for 18 hours then filtered to retain solids. The filtrate solutions were analyzed for Mn using ICP-AES, and the solids were washed with 250 mL of DI water. The non-pH adjusted solids were washed a second time.

Filtered and washed Mn-contacted solids were weighed and divided into a series of three extraction tests and a control. These tests examined the extent to which manganese could be recovered from the ceria surface when contacted with 1 N NaOH, 10% oxalic acid, or 1 M phosphate, in comparison to the effect of DI water under the same conditions.

The sample of permanganate-loaded ceria powder contacted with water as a control exhibited the release of less than 5% of the Mn. As with arsenate, NaOH effectively promoted desorption of permanganate from the ceria surface. This indicates that the basic pH level, or basification, acts as an interferer to permanganate removal by ceria. In the case of the second example, where pH was lowered, the effect of NaOH was greater than in the first case where the permanganate adsorbed under higher pH conditions.

Phosphate was far more effective at inducing permanganate desorption than it was at inducing arsenate desorption. Phosphate was the most effective desorption promoter we examined with permanganate. In other words, the ability of the ceria powder to remove permanaganate in the presence of phosphate appears to be relatively low as the capacity of the ceria powder for phosphate is much higher than for permanganate.

Oxalic acid caused a significant color change in the permanganate solution, indicating that the Mn(VII) was reduced, possibly to Mn(II) or Mn(IV), wherein the formation of MnO or MnO₂ precipitates would prevent the detection of additional Mn that may or may not be removed from the ceria. A reductant appears therefore to be an interferer to ceria removal of Mn(VII). In the sample that received no pH adjustment, no desorbed Mn was detected. However, in the sample prepared from acidifying the slurry slightly a significant amount of Mn was recovered from the ceria surface.

Chromate

250 mL of solution was prepared using 0.6 g sodium dichromate, and the solution was contacted with 20 g of cerium powder for 18 hours without pH adjustment. The slurry was filtered and the solids were washed with DI water then divided into 50 mL centrifuge tubes to test the ability of three solutions to extract chromium from the ceria surface.

Ceria capacity for chromate was significant and a loading of >20 mg Cr/g ceria was achieved without any adjustments to pH or system optimization (pH of filtrate was approximately 8). Likewise, the extraction of adsorbed chromate was also readily accomplished. Raising the pH of the slurry containing chromate-laden ceria using 1 N NaOH was the most effective method of desorbing chromium that was tested. Considerably less chromate was desorbed using phosphate and even less was desorbed using oxalic acid. This indicates that phosphate and oxalic acid are not as strong interferers to chromate removal when compared to permanganate removal. In the control sample, only 5% of the chromate was recovered when the loaded solid was contacted with distilled water.

Selenite

A liter of selenite solution was prepared using 1 g of Na₂SeO₂. The pH was lowered using 2 mL of 4 M HCl. 40 g of ceria was added to create a slurry that was provided 18 hours to contact. The slurry was filtered and the Se-loaded ceria was retained, weighed, and divided into 50 mL centrifuge tubes for extraction.

Ceria was loaded with >6 mg/g of Se. While the solids from this reaction were not washed in the preparation stages, the control extraction using DI water exhibited less than 2% selenium release. The adsorption of selenium was diminished by adding 1 N NaOH to the loaded ceria, but the effect was not as dramatic as has been seen for other oxyanions. However, by using hydrogen peroxide to oxidize the Se(IV) to Se(VI) the adsorbed selenium was readily released from the ceria surface and recovered. Oxalic acid had no noticeable impact on the extent of selenium adsorption. The presence of an oxidant appears, therefore, to be an interferer to the removal of Se (IV) by ceria.

Antimony

The solubility of antimony is rather low and these reactions were limited by the amount of antimony that could be dissolved. In this case, 100 mg of antimony (III) oxide was placed into 1 L of distilled water with 10 mL concentrated HCl, allowed several days to equilibrate, and was filtered through a 0.8 micron polycarbonate membrane to remove undissolved antimony. The liter of antimony solution was contacted with 16 g of ceria powder, which was effective removing antimony from solution, but had too little Sb(III) available to generate a high loading on the surface. In part due to the low surface coverage and strong surface-anion interactions, the extraction tests revealed little Sb recovery. Even the use of hydrogen peroxide, which would be expected to convert Sb(III) to a less readily adsorbed species of Sb(V), did not result in significant amounts of Sb recovery.

Arsenic

Tables 16-19 show the test parameters and results.

TABLE 16
Table 16: Loading of cerium oxide surface with arsenate and arsenite
for the demonstration of arsenic desorbing technologies.

| | | C | | E | | | | | | K | | |
|---|---|---|---|---|---|---|---|---|---|---|---|---|
| | B | Mass | | Resid | F | G | H | I | J | Rinse | L | M |
| | [As] | CeO2 | D | [As] | As-loading | Wet | Wet | Dry | % | Vol | Rinse [As] | Final [As] |
| A | (g/L) | (g) | pH | (ppm) | (mg/g) | Mass | mass | (g) | Solids | (mL) | (ppm) | (mg/g) |
| As (III) | 2.02 | 40.0 | 9.5 | 0 | 50.5 | 68 | 7.48 | 4.63 | 61.9 | 250 | 0 | 50.5 |
| As (V) | 1.89 | 40.0 | 5 | 149 | 43.5 | 69 | 8.86 | 5.33 | 60.2 | 250 | 163 | 42.5 |

TABLE 17
Table 17: Loading of cerium oxide surface with arsenate and arsenite
for the demonstration of arsenic desorbing technologies.

| | | | Residual | | Rinse | Final |
|---|---|---|---|---|---|---|
| | [As] | | [As] | As-loading | [As] | [As] |
| | (g/L) | pH | (ppm) | (mg/g) | (ppm) | (mg/g) |
| As(III) | 2.02 | 9.5 | 0 | 50.5 | 0 | 50.5 |
| As(V) | 1.89 | 5 | 149 | 43.5 | 163 | 42.5 |

TABLE 18
Table 18: Arsenic extraction from the ceria
surface using redox and competition reactions

| | | % As(III) | % As(V) |
|---|---|---|---|
| Extractant | pH | recovered | recovered |
| Water | 7 | 0.0 | 1.7 |
| 1N NaOH | 13 | 0.2 | 60.5 |
| 20% NaOH | 14 | 2.1 | 51.8 |
| 0.25 PO₄³⁻ | 8 | 0.4 | 15.0 |
| 10 g/L CO₃²⁻ | 10 | 2.0 | 7.7 |
| 10% oxalate | 2.5 | 3.0 | 16.5 |
| 30% H₂O₂ | 6 | 2.0 | 1.5 |
| H2O2/NaOH | 13 | 25.2 | 31.0 |
| 0.1M ascorbate | 4 | 0.0 | 0.0 |

TABLE 19
Table 19: Loading and extraction of other adsorbed elements
from the ceria surface (extraction is shown for each
method as the ‘percent loaded that is recovered)

| | chro- | anti- | | Per- | Per- |
|---|---|---|---|---|---|
| | mate | mony | selenite | manganate | manganate |
| loading pH | 8 | 2 | 6 | 6 | 11 |
| loading (mg/g) | 20 | 1 | 6 | 4 | 0.7 |
| water (% rec) | 5.1 | <2 | 1.6 | 2.6 | 3.4 |
| 1N NaOH (% rec) | 83 | <2 | 40.8 | 49.9 | 17.8 |
| 10% oxalic (% rec) | 25.8 | 2.3 | 0.2 | 22.8 | <3 |
| 0.5M PO₄³⁻ (% rec) | 60.7 | | | 78.6 | 45.8 |
| 30% H₂O₂ (% rec) | | 2.3 | 71.9 | | |

### Example 22

Experiments were performed to determine whether cerium (IV) solutions can be used to remove arsenic from storage pond process waters, and accordingly determine the loading capacity of ceria used. In these trials the storage pond solutions will be diluted with DI water, since previous test work has confirmed that this yields a better arsenic removal capability. The soluble cerium (IV) species used are Ceric Sulfate (0.1 M) Ce(SO₄)₂ and Ceric Nitrate (Ce(NO₃)₄). The pond solution used has an arsenic split between 27% As (III) and 73% As (V), with a pH of ph 2. Additional components in the pond solution are presented in Table 20 below:

Additional Sol'n Components:

TABLE 20

| | As | B | Ce | Cl | Co | Cu | Fe | Na | Ni | Pb | S | Si |
|---|---|---|---|---|---|---|---|---|---|---|---|---|
| Analyte | (ppm) | (ppm) | (ppm) | (ppm) | (ppm) | (ppm) | (ppm) | (ppm) | (ppm) | (ppm) | (ppm) | (ppm) |
| Tailings | 2500 | 270 | 4 | 1100 | 140 | 2400 | 130 | 4800 | 19500 | 9 | 15000 | 870 |
| Pond | | | | | | | | | | | | |
| Solution | | | | | | | | | | | | |

Test 1:

50 mL of storage pond solution was diluted to 350 mL using DI water, a seven-fold dilution. The diluted pond solution was heated to a boil and 50 mL of 0.1M Ce(SO₄)₄ was added and mixed for 15 minutes while still at a boil. A yellow/white precipitate formed. This was filtered using a Buchner funnel and 40 Whatman paper. The precipitate was dried at 110° C. overnight, and was weighed at 0.5 g. The filtrate was sampled and filtered using a 0.2μ filter. A full assay was performed on the filtrate using ICP-AES.

Test 2:

200 mL storage pond solution was diluted to 300 mL using DDI water. The solution was heated to a boil and 8.95 mL of 2.22 Ce(NO₃)₄ was added. The solution boiled for 15 minutes, and a yellow/white precipitate formed. This was filtered using a Buchner funnel and 40 Whatman paper. The precipitate was dried at 110° C. overnight, and was weighed at 2.46 g. The filtrate was sampled and filtered using a 0.2μ filter. A full assay was performed on the filtrate using ICP-AES.

The results are presented in Tables 21-22 below:

TABLE 21

| | As | B | Ce | Cl | Co | Cu | Fe | Na | Ni | Pb | S | Si |
|---|---|---|---|---|---|---|---|---|---|---|---|---|
| Analyte | (ppm) | (ppm) | (ppm) | (ppm) | (ppm) | (ppm) | (ppm) | (ppm) | (ppm) | (ppm) | (ppm) | (ppm) |
| Storage | 2500 | 270 | 4 | 1100 | 140 | 2400 | 130 | 4800 | 19500 | 9 | 15000 | 870 |
| Pond | | | | | | | | | | | | |
| Solution | | | | | | | | | | | | |
| Test 1 | 364 | 273 | 850 | N/A | 133 | 2240 | 126 | 5250 | 14700 | 7 | N/A | 840 |
| 7 FD | | | | | | | | | | | | |
| Test 4 | 639 | 254 | 2900 | N/A | 99 | 2464 | 94 | 4620 | 18480 | 9 | N/A | 601 |
| 1.54 FD | | | | | | | | | | | | |

*Note:
FD denotes “fold dilution” and the dilution has been factored for the reported concentrations

TABLE 22
Calculated Capacities

| | | | | | Percent Ce |
|---|---|---|---|---|---|
| Test | As Removed | CeO₂ | Capacity (mg | Percent As | still in |
| # | (mg) | Used (g) | As/g CeO₂) | Removed | solution |
| 1 | 107 | 0.86 | 124 | 85 | 42 |
| 2 | 372 | 3.44 | 108 | 74 | 32 |

Tables 21 and 22 demonstrate that the cerium (IV) solutions have a preferential affinity for the arsenic. When examining the data closer, it appears that some of the other metals fluctuate in concentrations i.e., nickel. According to the dilution scheme used and the limitations of the instrument, there could be up to 15% error in the reported concentrations, explaining some of the fluctuations. Moving onto to table 20, it shows that tests 1 and 2 removed 85% and 74% of the arsenic respectively.

### Example 23

Struvite particles of comprising NH₄MgPO₄.6H₂O were mixed in CeCl₃ solutions having different molar ratios of CeCl₃ to NH₄MgPO₄.6H₂O of about 0.8, 1.0, 1.2 and 1.5 CeCl₃ to NH₄MgPO₄.6H₂O. In each instance, the mass of the struvite was about 0.2 g, and the concentration of CeCl₃ was about 0.5 mole/L. Furthermore, controls of about 0.2 grams of struvite in about 0.1 L de-ionized water were prepared. The pH value of each solution was adjusted to a pH of about pH 4.3±0.2. Magnetic stir-bars were used to stir each sample solution. After stirring for at least about 16 hours, the solids were filtered from the solution. The filtered solids were analyzed by x-ray diffraction and the solutions were analyzed by ICP-MS. Final solution pH values of the solutions ranged from about pH 4.6 to about pH 8.0. The results are summarized in Table 23.

TABLE 23

| Nominal Concentrations | | | | | | Residual Concentrations | | | | |
|---|---|---|---|---|---|---|---|---|---|---|
| Sample | Struvite | pH | Mg | P | Ce | pH | Mg | P | Ce | P |
| ID | (mg) | Initial | (ppm) | (ppm) | (ppm) | Final | (ppm) | (ppm) | (ppm) | Removal |
| A | 205 | 5.0 | 203 | 258 | 935 | 8.0 | 140 | 7.9 | <0.1 | 96.9% |
| B | 205 | 5.6 | 203 | 259 | 1171 | 7.9 | 170 | 8.8 | <0.1 | 96.6% |
| C | 199 | 5.6 | 197 | 251 | 1360 | 5.3 | 170 | <0.5 | 62 | >99.8% |
| D | 202 | 4.9 | 200 | 255 | 1732 | 4.7 | 190 | <0.5 | 270 | >99.8% |
| CONTROL | 198 | 5.6 | 196 | 250 | 0 | 9.3 | 19 | 21 | 0 | N/A |
| CONTROL | 204 | 5.0 | 202 | 257 | 0 | 5.1 | 190 | 260 | 0 | N/A |
| CONTROL | 200 | 7.0 | 198 | 253 | 0 | 7.5 | 70 | 100 | 0 | N/A |

### Example 24

Struvite, NH₄MgPO₄.6H₂O, particles were mixed in about 0.1 L solutions containing different rare earth chlorides. The rare earth chloride solutions were about 0.15 mol/L solutions of LaCl₃, CeCl₃, PrCl₃ and NdCl₃. The mass of struvite added to each rare earth chloride solution was about 0.2 g and the molar ratio of the rare earth chloride to struvite was about 1.0. The pH of rare earth chloride solution was adjusted to a pH of about pH 4.3±0.2. Magnetic stir-bars were used to stir each sample solution. After stirring for at least about 16 hours, the solids were filtered from the solution. The filtered solids were analyzed by x-ray diffraction and the solutions were analyzed by ICP-MS. Final solution pH values ranged from about pH 4.6 to about pH 8.0. The results are summarized in Table 24.

TABLE 24

| Nominal Concentrations | | | | | | | | | | |
|---|---|---|---|---|---|---|---|---|---|---|
| Rare | | | | | | Residual Concentrations | | | | |
| Earth | Struvite | pH | Mg | P | REE | pH | Mg | P | REE | P |
| Element | (mg) | Initial | (ppm) | (ppm) | (ppm) | Final | (ppm) | (ppm) | (ppm) | Removal |
| La | 202 | 2.3 | 200 | 255 | 1142 | 2.7 | 150 | <0.5 | 200 | >99.8% |
| Ce | 201 | 7.0 | 199 | 254 | 1148 | 5.4 | 110 | <0.5 | 220 | >99.8% |
| Pr | 201 | 3.41 | 199 | 254 | 1156 | 3.8 | 190 | <0.5 | 0.17 | >99.8% |
| Nd | 202 | 2.7 | 200 | 255 | 1188 | 3.3 | 180 | <0.5 | .012 | >99.8% |

### Example 25

Example 25 is a control having about 0.2 g of struvite, NH₄MgPO₄.6H₂O, particles mixed in about 0.1 L of a 0.15 mol/L acidic ferric chloride, FeCl₃, solution. The molar ratio of ferric chloride to struvite was about 1.0 and the initial pH of the solution was about pH 2.5. The initial pH of the control solution was low enough to dissolve the struvite without the presence of ferric chloride. A magnetic stir-bar was used to stir the control solution. After stirring for at least about 16 hours, the solids were filtered from the control solution. The filtered solids were analyzed by x-ray diffraction and the control solution was analyzed by ICP-MS. Final solution pH value was about pH 2.3. The results are summarized in Table 25.

TABLE 25

| Nominal Concentrations | | | | | | Residual Concentrations | | | | |
|---|---|---|---|---|---|---|---|---|---|---|
| Metal | Struvite | pH | Mg | P | REE | pH | Mg | P | Metal | P |
| Element | (mg) | Initial | (ppm) | (ppm) | (ppm) | Final | (ppm) | (ppm) | (ppm) | Removal |
| Fe | 200 | 2.5 | 198 | 252 | 454 | 2.3 | 190 | 22 | 2.2 | 91.3% |

The Examples 23-25 show that struvite can be more effectively removed with rare earth-containing compositions than with other removal materials such as ferric chloride.

### Example 26

Table 26 summarizes deposit material removal capacities from deionized and NSF waters for cerium dioxide.

TABLE 26

Removal Capacity (mg/g)

| Deposit Material | DI | NSF |
|---|---|---|
| Antimonate | 10.91 | — |
| Arsenite | 11.78 | 13.12 |
| Arsenate | 0.86 | 7.62 |
| Nitrate | — | 0.00 |
| Phosphate | — | 35.57 |
| Sulfate | — | 46.52 |

A number of variations and modifications of the disclosure can be used. One of more embodiments of the disclosure can used separately and in combination. That is, any embodiment alone can be used and all combinations and permutations thereof can be used. It would be possible to provide for some features of the disclosure without providing others.

The present disclosure, in various embodiments, configurations, or aspects, includes components, methods, processes, systems and/or apparatus substantially as depicted and described herein, including various embodiments, configurations, aspects, sub-combinations, and subsets thereof. Those of skill in the art will understand how to make and use the various embodiments, configurations, or aspects after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and\or reducing cost of implementation.

The foregoing discussion has been presented for purposes of illustration and description.

The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that any claim and/or combination of claims require more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment.

Moreover, though the description of the disclosure has included descriptions of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A composition, comprising:
an aqueous solution having a particulate comprising a rare earth having a +4 oxidation state; and
a reduced form of an oxidizing agent, wherein the reduced form of the oxidizing agent is present in amount no less than the molar amount of the rare earth having the +4 oxidation state.

2. The composition of claim 1, wherein the aqueous solution comprises one of a recreational water, municipal water, wastewater, well water, septic water, drinking water, naturally occurring water, or mixture thereof, and wherein the aqueous solution comprises a target material-containing fluid.

3. The composition of claim 1, wherein the particulate is a nano-particulate having one of a mean, median or P₉₀ size from about 0.1 to about 1,000 nanometers.

4. The composition of claim 1, wherein the rare earth having the +4 oxidation state comprises cerium.

5. The composition of claim 1, wherein the rare earth having the +4 oxidation state comprises one or more of cerium (IV) oxide, cerium (IV) hydroxide, cerium (IV) oxyhydroxy, cerium (IV) hydrous oxide, cerium (IV) hydrous oxyhydroxy, CeO₂, Ce(IV)(O)_{w}(OH)ₓ(H₂O)_{y}.zH₂O, where w, x, y and z can be zero or a positive, real number, or mixture thereof.

6. The composition of claim 1, wherein the composition is in the form of a colloid, suspension, or slurry.

7. The composition of claim 1, further comprising one or more earths other the rare earth having the +4 oxidation state, wherein the one or more rare earths comprise water-soluble rare earths having an oxidation state of +3.

8. The composition of claim 2, wherein the target material-containing fluid contains one or more target materials and wherein the one or more target materials comprise a deposit material, oxyanion, colorant, dye, dye carrier, ink, pigment, biological contaminant, chemical contaminant, physiological active contaminant or a mixture thereof.

9. A composition, comprising:
an aqueous solution having a particulate comprising a rare earth having a +4 oxidation state;
a reduced form of an oxidizing agent, wherein the reduced form of the oxidizing agent is present in at least about the molar amount of the rare earth having the +4 oxidation state; and
a target material sorbed on the particulate material comprising the rare earth having the +4 oxidation state and wherein the target material comprises a deposit material, oxyanion, colorant, dye, dye carrier, ink, pigment, biological contaminant, chemical contaminant, physiological active contaminant or a mixture thereof.

10. The composition of claim 9, wherein the rare earth having the +4 oxidation state comprises one or more of cerium (IV) oxide, cerium (IV) hydroxide, cerium (IV) oxyhydroxy, cerium (IV) hydrous oxide, cerium (IV) hydrous oxyhydroxy, CeO₂, Ce(IV)(O)_{w}(OH)ₓ(OH)_{y}.zH₂O, where w, x, y and z can be zero or a positive, real number, or mixture thereof.

11. The composition of claim 9, wherein the particulate comprising the rare earth having the +4 oxidation state is a nano-particulate having one of a mean, median or P₉₀ size from about 0.1 to about 1,000 nanometers.

12. The composition of claim 9, wherein the composition comprises a colloid, suspension, precipitate, or slurry of particulates in the aqueous solution.

13. The composition of claim 9, wherein the water forming the aqueous solution comprises one of a recreational water, municipal water, wastewater, well water, septic water, drinking water, naturally occurring water, or mixture thereof.

14. A method, comprising:
contacting, in a fluid, a rare earth-containing additive containing at least some water-soluble cerium (III) with an oxidizing agent to oxidize at least some of the cerium (III) to cerium (IV), wherein the cerium (IV) is in the form of a particulate, and wherein the cerium (IV) particulates are suspended and/or dispersed in the fluid.

15. The method of claim 14, further comprising:
contacting the cerium (IV) particulates with a target material contained within a target material-containing stream to remove at least some, if not most, of the target material from the target material-containing stream and to form a target material-laden rare earth composition and a barren stream having a target material content less than the target material-containing stream.

16. The method of claim 15, wherein the target material-laden rare earth composition comprises one of a deposit material, oxyanion, colorant, dye, dye carrier, ink, pigment, biological contaminant, chemical contaminant, physiological active contaminant or a mixture thereof sorbed on the cerium (IV) particulates.

17. The method of claim 15, wherein the target material-containing stream comprises one of a recreational water, municipal water, wastewater, well water, septic water, drinking water, naturally occurring water, or mixture thereof.

18. The method of claim 15, further comprising:
pre-treating the target material-containing stream before contacting the cerium (IV) particulates with a target material contained within a target material-containing stream.

19. The method of claim 18, wherein the pre-treating comprises one or more of clarifying, disinfecting, coagulating, aerating, filtering, heating, cooling, separating solids and liquids, digesting and polishing of the target material-containing stream.

20. The method of claim 16, further comprising:
separating the target material-laden rare earth composition from the barren stream to form a separated target material-laden rare earth composition and a separated barren stream.

21. The method of claim 20, further comprising:
treating the barren stream before separating the target material-laden rare earth composition from the barren stream, wherein the treating comprises one or more of clarifying, disinfecting, coagulating, aerating, filtering, heating, cooling, separating solids and liquids, digesting and polishing of the barren stream.

22. The method of claim 20, further comprising:
post-treating the separated barren stream to form a purified stream, wherein the post-treating comprises one or more of clarifying, disinfecting, coagulating, aerating, filtering, heating, cooling, separating solids and liquids, digesting and polishing of the separated barren stream.

23. The method of claim 14, wherein the cerium (IV) particulates are nano-particulates having one of a mean, median or P₉₀ size from about 0.1 to about 1,000 nanometers.

24. The method of claim 14, wherein the cerium (IV) particulates comprise one or more of cerium (IV) oxide, cerium (IV) hydroxide, cerium (IV) oxyhydroxy, cerium (IV) hydrous oxide, cerium (IV) hydrous oxyhydroxy, CeO₂, Ce(IV)(O)_{w}(OH)ₓ(OH)_{y}.zH₂O, where w, x, y and z can be zero or a positive, real number, or mixture thereof.

25. The method of claim 14, wherein the rare earth-containing additive comprises one or more rare earths other the water-soluble cerium (III), wherein the one or more other rare earths are selected from the group consisting essentially of yttrium, scandium, praseodymium, neodymium, samarium, europium, gadolinium, terbium, dysprosium, holmium, erbium, thulium, ytterbium, and lutetium.

26. The method of claim 14, wherein the oxidizing agent comprises one or more of chlorine, chloroamines, chlorine dioxide, hypochlorites, trihalomethane, haloacetic acid, ozone, hydrogen peroxide, peroxygen compounds, hypobromous acid, bromoamines, hypobromite, hypochlorous acid, isocyanurates, tricholoro-s-triazinetriones, hydantoins, bromochloro-dimethyldantoins, 1-bromo-3-chloro-5,5-dimethyldantoin, 1,3-dichloro-5,5-dimethyldantoin, sulfur dioxide, bisulfates, bromine, BrCl, permanganates, phenols, alcohols, oxyanions, arsenites, chromates, trichloroisocyanuric acid, surfactants electromagnetic energy, ultra violet light, thermal energy, ultrasonic energy, gamma rays and combinations thereof.
